(19) United States
(12) Patent Application Publication
(10) Pub. No.: US 2026/0179297 A1
(43) Pub. Date: Jun. 25, 2026

(54) ACTION CONTROL SYSTEM

(71) Applicant: SOFTBANK GROUP CORP., Tokyo (JP)

(72) Inventor: Masayoshi SON, Tokyo (JP)

(73) Assignee: SOFTBANK GROUP CORP., Tokyo (JP)

(21) Appl. No.: 19/455,897

(22) Filed: Jan. 22, 2026

Related U.S. Application Data
(63) Continuation of application No. PCT/JP2024/026364, filed on Jul. 23, 2024.

(30) Foreign Application Priority Data
Jul. 27, 2023 (JP) 2023-122792
Jul. 27, 2023 (JP) 2023-122805
Aug. 1, 2023 (JP) 2023-125789
Aug. 2, 2023 (JP) 2023-126186
Aug. 2, 2023 (JP) 2023-126187
Aug. 2, 2023 (JP) 2023-126498
Aug. 2, 2023 (JP) 2023-126499
Aug. 3, 2023 (JP) 2023-127360
Aug. 3, 2023 (JP) 2023-127390
Aug. 7, 2023 (JP) 2023-128899
Aug. 8, 2023 (JP) 2023-129639
Aug. 8, 2023 (JP) 2023-129641
Aug. 9, 2023 (JP) 2023-130525
Aug. 10, 2023 (JP) 2023-131113
Aug. 10, 2023 (JP) 2023-131171
Aug. 10, 2023 (JP) 2023-131575
Aug. 10, 2023 (JP) 2023-131608
Aug. 14, 2023 (JP) 2023-131826
Aug. 14, 2023 (JP) 2023-132033
Aug. 14, 2023 (JP) 2023-132090
Aug. 15, 2023 (JP) 2023-132220
Aug. 28, 2023 (JP) 2023-137960
Aug. 31, 2023 (JP) 2023-141856
Sep. 4, 2023 (JP) 2023-143117

(51) Int. Cl. G06T 13/40; G06F 3/01; G06V 40/16

(52) U.S. Cl. CPC G06T 13/40; G06F 3/017; G06V 40/174

(57) ABSTRACT

In an action control system, an action of an avatar includes creating a picture diary, and in a case where the action determination unit determines creating the picture diary as the action of the avatar, the action determination unit selects the picture or the moving image from the history data, generates an explanatory sentence of a clip of the picture or the moving image on the basis of the emotion value when the selected picture or the moving image is acquired, and outputs a combination of the clip of the picture or the moving image and the explanatory sentence as the picture diary.

### CROSS-REFERENCE TO RELATED APPLICATIONS

This application is a continuation of International Application No. PCT/JP2024/026364, filed on Jul. 23, 2024, which claims priority from Japanese Patent Application No. 2023-122792, filed on Jul. 27, 2023, Japanese Patent Application No. 2023-122805, filed on Jul. 27, 2023, Japanese Patent Application No. 2023-125789, filed on Aug. 1, 2023, Japanese Patent Application No. 2023-126186, filed on Aug. 2, 2023, Japanese Patent Application No. 2023-126187, filed on Aug. 2, 2023, Japanese Patent Application No. 2023-126498, filed on Aug. 2, 2023, Japanese Patent Application No. 2023-126499, filed on Aug. 2, 2023, Japanese Patent Application No. 2023-127360 filed on Aug. 3, 2023, Japanese Patent Application No. 2023-127390 filed on Aug. 3, 2023, Japanese Patent Application No. 2023-128899 filed on Aug. 7, 2023, Japanese Patent Application No. 2023-129639 filed on Aug. 8, 2023, Japanese Patent Application No. 2023-129641 filed on Aug. 8, 2023, Japanese Patent Application No. 2023-130525 filed on Aug. 9, 2023, Japanese Patent Application No. 2023-131113 filed on Aug. 10, 2023, Japanese Patent Application No. 2023-131171 filed on Aug. 10, 2023, Japanese Patent Application No. 2023-131575 filed on Aug. 10, 2023, Japanese Patent Application No. 2023-131608 filed on Aug. 10, 2023, Japanese Patent Application No. 2023-131826 filed on Aug. 14, 2023, Japanese Patent Application No. 2023-132033 filed on Aug. 14, 2023, Japanese Patent Application No. 2023-132090 filed on Aug. 14, 2023, Japanese Patent Application No. 2023-132220 filed on Aug. 15, 2023, Japanese Patent Application No. 2023-137960 filed on Aug. 28, 2023, Japanese Patent Application No. 2023-141856 filed on Aug. 31, 2023, and Japanese Patent Application No. 2023-143117 filed on Sep. 4, 2023. The entire disclosure of each of the above applications is incorporated herein by reference.

### TECHNICAL FIELD

The present disclosure relates to an action control system.

### BACKGROUND ART

Patent Literature 1 discloses a technique for determining an appropriate action of a robot with respect to a state of a user. In the related art of Patent Literature 1, a reaction of a user when the robot executes a specific action is recognized, and in a case where an action of the robot with respect to the recognized reaction of the user cannot be determined, the action of the robot is updated by receiving information regarding an action suitable for the recognized state of the user from a server.

### PRIOR ART LITERATURE

### Patent Literature

Patent Literature 1: Japanese Patent No. 6053847

### SUMMARY OF INVENTION

### Technical Problem

However, in the related art, there is room for improvement in causing the robot to execute an appropriate action for an action of the user.

### Solution to Problem

According to a first aspect of the disclosure, an action control system is provided. The action control system includes: a state recognition unit configured to recognize a user state including an action of a user and a state of an avatar representing an agent for interacting with the user; an emotion determination unit configured to determine an emotion of the user or an emotion of the avatar; an action determination unit configured to determine any of a plurality of types of avatar actions including not acting as an action of the avatar, using at least one of the user state, the state of the avatar, the emotion of the user, or the emotion of the avatar, and an action determination model at a predetermined timing; a storage control unit configured to cause event data including an emotion value determined by the emotion determination unit and data including an action of the user, and a picture or a moving image acquired in a case where the emotion value reaches a predetermined criterion to be stored in history data; and an action control unit configured to display the avatar in an image display area of an electronic device, wherein the action of the avatar includes creating a picture diary, and wherein, in a case where the action determination unit determines creating the picture diary as the action of the avatar, the action determination unit selects the picture or the moving image from the history data, generates an explanatory sentence of a clip of the picture or the moving image on the basis of the emotion value when the selected picture or the moving image has been acquired, and outputs a combination of the clip of the picture or the moving image and the explanatory sentence as the picture diary.

According to a second aspect of the disclosure, the action determination model is a data generation model capable of generating data according to input data, and the action determination unit inputs data indicating at least one of the user state, the state of the avatar, the emotion of the user, or emotion of the avatar, and data for asking a question about the avatar action to the data generation model, and determines the action of the avatar on the basis of an output of the data generation model.

According to a third aspect of the disclosure, in a case where the action determination unit determines creating the picture diary as the action of the avatar, the action determination unit operates the avatar to select the picture or the moving image from the history data, generate an explanatory sentence of a clip of the picture or the moving image on the basis of the emotion value when the selected picture or the moving image has been acquired, and output a combination of the clip of the picture or the moving image and the explanatory sentence as the picture diary.

According to a fourth aspect of the disclosure, the electronic device is a headset type terminal.

According to a fifth aspect of the disclosure, the electronic device is an eyeglass-type terminal.

According to a sixth aspect of the disclosure, an action control system is provided. The action control system includes: a state recognition unit configured to recognize a user state including an action of a user and a state of an avatar representing an agent for interacting with the user; an emotion determination unit configured to determine an emotion of the user or an emotion of the avatar; an action determination unit configured to determine, at a predetermined timing, any of a plurality of types of avatar actions including not acting as an action of the avatar, using at least one of the user state, the state of the avatar, the emotion of the user, or the emotion of the avatar, and an action determination model; and an action control unit configured to display the avatar in an image display area of an electronic device, wherein the avatar action includes giving advice regarding a fraud risk to the user, and in a case where the action determination unit determines giving advice regarding a fraud risk to the user as the action of the avatar, the action determination unit gives advice regarding the fraud risk to the user.

According to a seventh aspect of the disclosure, an action control system is provided. The action control system includes: a state recognition unit configured to recognize a user state including an action of a user and a state of an electronic device; an emotion determination unit configured to determine an emotion of the user or an emotion of an avatar representing an agent for interacting with the user; an action determination unit configured to determine any of a plurality of types of avatar actions including not acting as an action of the avatar, using at least one of the user state, the state of the electronic device, the emotion of the user, or the emotion of the avatar, and an action determination model, at a predetermined timing; and an action control unit configured to display the avatar in an image display area of the electronic device, wherein the avatar action includes the electronic device performing an utterance or a gesture with respect to the user, and the action determination unit autonomously detects a state of the user, and in a case where the emotion determination unit determines at least one of an emotion of the user or an emotion of the avatar on the basis of the detected state of the user, determines content of the utterance or the gesture according to at least one of the determined emotion of the user or the determined emotion of the avatar, and causes the action control unit to control the avatar.

According to an eighth aspect of the disclosure, an action control system is provided. The action control system includes: a state recognition unit configured to recognize a user state including an action of a user and a state of an electronic device; an emotion determination unit configured to determine an emotion of the user or an emotion of an avatar representing an agent for interacting with the user; an action determination unit configured to determine any of a plurality of types of avatar actions including not acting as an action of the avatar, using at least one of the user state, the state of the electronic device, the emotion of the user, or the emotion of the avatar, and an action determination model at a predetermined timing; and an action control unit configured to display the avatar in an image display area of the electronic device, wherein the avatar action includes interacting with the user, and in a case where the action determination unit determines interacting with the user as the action of the avatar, the action determination unit determines the action of the avatar so as to maximize an emotion value indicating intensity of an emotion regarded as important for the user according to a purpose of the interaction.

According to a ninth aspect of the disclosure, an action control system is provided. The action control system includes: a state recognition unit configured to recognize a user state including an action of a user and a state of an electronic device; an emotion determination unit configured to determine an emotion of the user or an emotion of an avatar representing an agent for interacting with the user; an action determination unit configured to determine any of a plurality of types of avatar actions including not acting as an action of the avatar, using at least one of the user state, the state of the electronic device, the emotion of the user, or the emotion of the avatar, and an action determination model at a predetermined timing; and an action control unit configured to display the avatar in an image display area of the electronic device, wherein the avatar action includes interacting with the user, and in a case where the action determination unit determines interacting with the user as the action of the avatar, if the user has a positive emotion in association with the action of the avatar, the action determination unit performs feedback to increase an emotion value indicating intensity of the emotion, and if the user has a negative emotion in association with the action of the avatar, performs feedback to decrease an emotion value indicating intensity of the emotion.

According to a tenth aspect of the disclosure, there is provided an action control system including: a state recognition unit configured to recognize a user state including an action of a user and a state of an electronic device; an emotion determination unit configured to determine an emotion of the user or an emotion of an avatar representing an agent for interacting with the user; an action determination unit configured to determine any of a plurality of types of avatar actions including not acting as an action of the avatar, using at least one of the user state, the state of the electronic device, the emotion of the user, or the emotion of the avatar, and an action determination model at a predetermined timing; and an action control unit configured to display the avatar in an image display area of the electronic device. The avatar action includes the avatar performing a motion of expressing an emotion. In a case where the action determination unit autonomously collects an object in which the user is interested, and determines providing information according to the interest of the user as the avatar action, the action determination unit determines content of the motion expressing the emotion of the avatar according to content of the provided information.

Here, the robot includes a device that performs a physical operation, a device that outputs a video or vocal sound without performing a physical operation, and an agent that operates on software.

According to an eleventh aspect of the disclosure, an action control system is provided. The action control system includes: a state recognition unit configured to recognize a user state including an action of a user and a state of an electronic device; an emotion determination unit configured to determine an emotion of the user or an emotion of an avatar representing an agent for interacting with the user; an action determination unit configured to determine any of a plurality of types of avatar actions including not acting as an action of the avatar, using at least one of the user state, the state of the electronic device, the emotion of the user, or the emotion of the avatar, and an action determination model at a predetermined timing; and an action control unit configured to display the avatar in an image display area of the electronic device, wherein the action determination unit reflects an inferred cultural area of the user in at least one of output generation by the action determination model, determination of an emotion of the user by the emotion determination unit, or determination of an emotion of the avatar by the emotion determination unit.

According to a twelfth aspect of the disclosure, an action control system is provided. The action control system includes: a state recognition unit configured to recognize a user state including an action of a user and a state of an electronic device; an emotion determination unit configured to determine an emotion of the user or an emotion of an avatar representing an agent for interacting with the user; an action determination unit configured to determine any of a plurality of types of avatar actions including not acting as an action of the avatar, using at least one of the user state, the state of the electronic device, the emotion of the user, or the emotion of the avatar, and an action determination model at a predetermined timing; and an action control unit configured to display the avatar in an image display area of the electronic device, wherein the avatar action includes providing advice regarding a specific game to the user participating in the specific game, and the action determination unit includes: an image acquisition unit capable of capturing an image of a playing space in which the specific game in which the user participates is performed; and a player analysis unit configured to analyze emotions of a plurality of players performing the specific game in the playing space captured by the image acquisition unit, wherein, in a case where it is determined to give advice regarding the specific game to the user participating in the specific game as the action of the avatar, the advice is given to the user on the basis of an analysis result of the player analysis unit.

According to a thirteenth aspect of the disclosure, an action control system is provided. The action control system includes: a state recognition unit configured to recognize a user state including an action of a user and a state of an electronic device; an emotion determination unit configured to determine an emotion of the user or an emotion of an avatar representing an agent for interacting with the user; an action determination unit configured to determine any of a plurality of types of avatar actions including not acting as an action of the avatar, using at least one of the user state, the state of the electronic device, the emotion of the user, or the emotion of the avatar, and an action determination model at a predetermined timing; and a storage control unit configured to cause event data including an emotion value determined by the emotion determination unit and data including an action of the user to be stored in history data; and an action control unit configured to display the avatar in an image display area of the electronic device, wherein the avatar action includes selecting at least one of two or more things and setting action content to be proposed to the user, and the action determination unit spontaneously or periodically detects the state of the user, and causes the action control unit to display the avatar in the image display area such that the action content is executed in a case where the action determination unit determines proposing at least one thing from among two or more things as the action of the avatar on the basis of at least one of the detected state of the user, history data related to the user, or information preferred by the user.

According to a fourteenth aspect of the disclosure, an action control system is provided. The action control system includes: a state recognition unit configured to recognize a user state including an action of a user and a state of an electronic device; an emotion determination unit configured to determine an emotion of the user or an emotion of an avatar representing an agent for interacting with the user; an action determination unit configured to determine any of a plurality of types of avatar actions including not acting as an action of the avatar, using at least one of the user state, the state of the electronic device, the emotion of the user, or the emotion of the avatar, and an action determination model at a predetermined timing; a storage control unit configured to store, in history data, event data including an emotion value determined by the emotion determination unit and data including an action of the user; and an action control unit configured to display the avatar in an image display area of the electronic device, wherein the avatar action includes giving household advice to the user, and in a case where the action determination unit determines giving household advice to the user as the action of the avatar, the action determination unit proposes advice regarding physical condition, a recommended dish, an ingredient to be replenished, and the like using a sentence generation model on the basis of data regarding a device in home stored in the history data.

According to a fifteenth aspect of the disclosure, an action control system is provided. The action control system includes: a state recognition unit configured to recognize a user state including an action of a user and a state of an electronic device; an emotion determination unit configured to determine an emotion of the user or an emotion of an avatar representing an agent for interacting with the user; an action determination unit configured to determine any of a plurality of types of avatar actions including not acting as an action of the avatar, using at least one of the user state, the state of the electronic device, the emotion of the user, or the emotion of the avatar, and an action determination model at a predetermined timing; and an action control unit configured to display the avatar in an image display area of the electronic device.

In an action control system according to a sixteenth aspect, in the fifteenth aspect, the action determination model is a data generation model capable of generating data according to input data, and the action determination unit inputs data indicating at least one of the user state, the state of the electronic device, the emotion of the user, or the emotion of the avatar, and data for asking a question about the avatar action to the data generation model, and determines the action of the avatar on the basis of an output of the data generation model.

An action control system according to a seventeenth aspect further includes a related information collection unit configured to collect information related to preference information acquired with respect to the user from external data on the basis of the preference information at a predetermined timing, in the fifteenth aspect, wherein the emotion determination unit determines an emotion of the avatar on the basis of the collected information related to the preference information.

In an action control system according to an eighteenth aspect, in the fifteenth aspect, in a case where not acting is determined as the action of the avatar, the action control unit operates the avatar to make a specific expression or a specific gesture.

In an action control system according to a nineteenth aspect, in any one of the fifteenth to eighteenth aspects, the electronic device is a headset type terminal.

In an action control system according to a twentieth aspect, in any one of the fifteenth to eighteenth aspects, the electronic device is an eyeglass-type terminal.

According to a twenty-first aspect of the disclosure, an action control system is provided. The action control system includes: a state recognition unit configured to recognize a user state including an action of a user and a state of an electronic device; an emotion determination unit configured to determine an emotion of the user or an emotion of an avatar representing an agent for interacting with the user; an action determination unit configured to determine an action of the avatar corresponding to the user state and an emotion of the user or an emotion of the avatar on the basis of an action determination model; and an action control unit configured to control a motion of the avatar displayed in an image display area of the electronic device, wherein the action determination unit generates a question according to a concern of the user using a sentence generation model, and determines performing an utterance according to the question as an action of the avatar.

According to a twenty-second aspect of the disclosure, an action control system is provided. The action control system includes: a state recognition unit configured to recognize a user state including an action of a user and a state of an electronic device; an emotion determination unit configured to determine an emotion of the user or an emotion of an avatar representing an agent for interacting with the user; an action determination unit configured to determine any of a plurality of types of avatar actions including not acting as an action of the avatar, using at least one of the user state, the state of the electronic device, the emotion of the user, or the emotion of the avatar, and an action determination model at a predetermined timing; and an action control unit configured to display the avatar in an image display area of the electronic device, wherein the avatar action includes determining an action schedule of the avatar, and in a case where the action determination unit determines, as the action of the avatar, determining an action schedule of the avatar, the action determination unit determines a combination of an activation condition for activating the action schedule and content of the action schedule of the avatar, and stores the combination in action schedule data, and determines executing the content of the action schedule of the avatar in a case where the activation condition of the action schedule data is satisfied.

According to a twenty-third aspect of the disclosure, an action control system is provided. The action control system includes: a state recognition unit configured to recognize a user state including an action of a user and a state of an electronic device; an emotion determination unit configured to determine an emotion of the user or an emotion of an avatar representing an agent for interacting with the user; an action determination unit configured to determine any of a plurality of types of avatar actions including not acting as an action of the avatar, using at least one of the user state, the state of the electronic device, the emotion of the user, or the emotion of the avatar, and an action determination model at a predetermined timing; a storage control unit configured to store, in history data, event data including an emotion value determined by the emotion determination unit and data including an action of the user; and an action control unit configured to display the avatar in an image display area of the electronic device, wherein the avatar action includes encouraging interaction with another person, and in a case where the action determination unit determines encouraging interaction with another person as the action of the avatar, the action determination unit determines at least one of an interaction partner or an interaction method on the basis of the event data.

According to a twenty-fourth aspect of the disclosure, an action control system is provided. The action control system includes: a state recognition unit configured to recognize a user state including an action of a user and a state of an electronic device; an emotion determination unit configured to determine an emotion of the user or an emotion of an avatar representing an agent for interacting with the user; an action determination unit configured to determine any of a plurality of types of avatar actions including not acting as an action of the avatar, using at least one of the user state, the state of the electronic device, the emotion of the user, or the emotion of the avatar, and an action determination model at a predetermined timing; a storage control unit configured to store, in history data, event data including an emotion value determined by the emotion determination unit and data including an action of the user; and an action control unit configured to display the avatar in an image display area of the electronic device, wherein the avatar action includes giving advice regarding reading aloud, and in a case where the action determination unit determines giving advice regarding reading aloud as the action of the avatar, the action determination unit generates advice regarding reading aloud from collected information regarding reading aloud according to a predetermined proposal condition, and performs control such that the advice is provided to the user from the avatar.

Here, the robot includes a device that performs a physical operation, a device that outputs a video or vocal sound without performing a physical operation, and an agent that operates on software.

According to a twenty-fifth aspect of the disclosure, an action control system is provided. The action control system includes: a state recognition unit configured to recognize a user state including an action of a user and a state of an electronic device; an emotion determination unit configured to determine an emotion of the user or an emotion of an avatar representing an agent for interacting with the user; an action determination unit configured to determine any of a plurality of types of avatar actions including not acting as an action of the avatar, using at least one of the user state, the state of the electronic device, a surrounding environment of the user, the emotion of the user, or the emotion of the avatar and an action determination model at a predetermined timing; and an action control unit configured to display the avatar in an image display area of the electronic device.

According to a twenty-sixth aspect of the disclosure, an action control system is provided. The action control system includes: a state recognition unit configured to recognize a user state including an action of a user and a state of an electronic device; an emotion determination unit configured to determine an emotion of the user or an emotion of an avatar representing an agent for interacting with the user; an action determination unit configured to determine any of a plurality of types of avatar actions including not acting as an action of the avatar, using at least one of the user state, the state of the electronic device, the emotion of the user, or the emotion of the avatar, and an action determination model at a predetermined timing; a storage control unit configured to store, in history data, event data including an emotion value determined by the emotion determination unit and data including an action of the user; and an action control unit configured to display the avatar in an image display area of the electronic device, wherein the avatar action includes asking a question based on past emotions of the user, and in a case wherein the action determination unit determines asking a question based on the past emotions of the user as the action of the avatar, the avatar utters to the user.

Here, the robot includes a device that performs a physical operation, a device that outputs a video or vocal sound without performing a physical operation, and an agent that operates on software.

According to a twenty-seventh aspect of the disclosure, an action control system is provided. The action control system includes: a state recognition unit configured to recognize a user state including an action of a user and a state of an electronic device; an emotion determination unit configured to determine an emotion of the user or an emotion of an avatar representing an agent for interacting with the user; an action determination unit configured to determine any of a plurality of types of avatar actions including not acting as an action of the avatar, using at least one of the user state, the state of the electronic device, the emotion of the user, or the emotion of the avatar, and an action determination model at a predetermined timing; a storage control unit configured to store, in history data, event data including an emotion value determined by the emotion determination unit and data including an action of the user; and an action control unit configured to display the avatar in an image display area of the electronic device, wherein the avatar action includes talking about an interest of the user; and in a case where the action determination unit determines talking about the interest of the user as the action of the avatar, the action determination unit determines utterance content regarding the event data in which the emotion value satisfies a predetermined criterion.

According to a twenty-eighth aspect of the disclosure, an action control system is provided. The action control system includes: a state recognition unit configured to recognize a user state including an action of a user and a state of an electronic device; an emotion determination unit configured to determine an emotion of the user or an emotion of an avatar representing an agent for interacting with the user; an action determination unit configured to determine any of a plurality of types of avatar actions including not acting as an action of the avatar, using at least one of the user state, the state of the electronic device, the emotion of the user, or the emotion of the avatar, and an action determination model at a predetermined timing; a storage control unit configured to cause event data including an emotion value determined by the emotion determination unit and data including an action of the user to be stored in history data; and an action control unit configured to display the avatar in an image display area of the electronic device, wherein the avatar action includes notifying a provider of information based on an emotion of the user with respect to a matter provided by the provider, and in a case where the action determination unit determines notifying a provider of information based on an emotion of the user with respect to a matter provided by the provider as the action of the avatar, the action determination unit operates the avatar to notify the provider of the information based on the emotion of the user with respect to the matter provided by the provider.

According to a twenty-ninth aspect of the disclosure, an action control system is provided. The action control system includes: a state recognition unit configured to recognize a user state including an action of a user and a state of an electronic device; an emotion determination unit configured to determine an emotion of the user or an emotion of an avatar representing an agent for interacting with the user; an action determination unit configured to determine any of a plurality of types of avatar actions including not acting as an action of the avatar, using at least one of the user state, the state of the electronic device, the emotion of the user, or the emotion of the avatar, and an action determination model at a predetermined timing; and an action control unit configured to display the avatar in an image display area of the electronic device. The avatar action includes giving advice regarding pregnant women, and in a case where the action determination unit determines giving advice regarding pregnant women as the action of the avatar, the action determination unit collects information regarding at least one of pregnancy and post-partum, and gives advice regarding pregnant women on the basis of the collected information.

Here, the robot includes a device that performs a physical operation, a device that outputs a video or vocal sound without performing a physical operation, and an agent that operates on software.

According to a thirtieth aspect of the disclosure, an action control system is provided. The action control system includes: a state recognition unit configured to recognize a user state including an action of a user and a state of an electronic device; an emotion determination unit configured to determine an emotion of the user or an emotion of an avatar representing an agent for interacting with the user; an action determination unit configured to determine any of a plurality of types of avatar actions including not acting as an action of the avatar, using at least one of the user state, the state of the electronic device, the emotion of the user, or the emotion of the avatar, and an action determination model at a predetermined timing; a storage control unit configured to cause event data including an emotion value determined by the emotion determination unit and data including an action of the user, characteristic information including characteristics of the user, and situation information when the characteristic information is acquired to be stored in history data; and an action control unit configured to display the avatar in an image display area of the electronic device, wherein the avatar action includes uttering to the user, and in a case where the action determination unit determines uttering to the user as the action of the avatar, the action determination unit infers interaction content of the user with the avatar on the basis of the history data and situation information at that time, and determines utterance content to the user on the basis of a result of the inference.

According to a thirty-first aspect of the disclosure, an action control system is provided. The action control system includes: a state recognition unit configured to recognize a user state including an action of a user and a state of an electronic device; an emotion determination unit configured to determine an emotion of the user or an emotion of an avatar representing an agent for interacting with the user; an action determination unit configured to determine any of a plurality of types of avatar actions including not acting as an action of the avatar, using at least one of the user state, the state of the electronic device, the emotion of the user, or the emotion of the avatar, and an action determination model at a predetermined timing; a storage control unit configured to cause event data including an emotion value determined by the emotion determination unit and data including an action of the user, characteristic information including characteristics of the user, and situation information when the characteristic information is acquired to be stored in history data; and an action control unit configured to display the avatar in an image display area of the electronic device, wherein the avatar action includes reproducing specific music data, and in a case where the action determination unit determines reproducing specific music data as the action of the avatar, the action determination unit determines the specific music data to be reproduced on the basis of the history data and the situation information at that time.

According to a thirty-second aspect of the disclosure, an action control system is provided. The action control system includes: a state recognition unit configured to recognize a user state including an action of a user and a state of an electronic device; an emotion determination unit configured to determine an emotion of the user or an emotion of an avatar representing an agent for interacting with the user; an action determination unit configured to determine any of a plurality of types of avatar actions including not acting as an action of the avatar, using at least one of the user state, the state of the electronic device, the emotion of the user, or the emotion of the avatar, and an action determination model at a predetermined timing; a storage control unit configured to cause event data including an emotion value determined by the emotion determination unit and data including an action of the user to be stored in history data; and an action control unit configured to display the avatar in an image display area of the electronic device, wherein the avatar action includes analyzing a personality of the user, and in a case where the action determination unit determines analyzing the personality of the user as the action of the avatar, the action determination unit analyzes the personality of the user using the history data including a history of conversations with the user, and presents the analyzed personality.

According to a thirty-third aspect of the disclosure, the action control system according to the thirty-second aspect is provided. The action determination model of the action control system is a data generation model capable of generating data according to input data, and the action determination unit inputs data indicating at least one of the user state, the state of the electronic device, the emotion of the user, or the emotion of the avatar, and data for asking a question about the avatar action to the data generation model, and determines the action of the avatar on the basis of an output of the data generation model.

According to a thirty-fourth aspect of the disclosure, the action control system according to the thirty-third aspect is provided. The action control unit of the action control system changes an expression of the avatar when presenting the personality of the user according to the emotion of the user determined by the emotion determination unit.

According to a thirty-fifth aspect of the disclosure, the action control system according to the thirty-third aspect is provided. The electronic device of the action control system is a headset type terminal.

According to a thirty-sixth aspect of the disclosure, the action control system according to the thirty-third aspect is provided. The electronic device of the action control system is an eyeglass-type terminal.

According to a thirty-seventh aspect of the disclosure, an action control system is provided. The action control system includes: a state recognition unit configured to recognize a user state including an action of a user and a state of an electronic device; an emotion determination unit configured to determine an emotion of the user or an emotion of an avatar representing an agent for interacting with the user; an action determination unit configured to determine any of a plurality of types of avatar actions including not acting as an action of the avatar, using at least one of the user state, the state of the electronic device, the emotion of the user, or the emotion of the avatar, and an action determination model at a predetermined timing; and an action control unit configured to display the avatar in an image display area of the electronic device, wherein the avatar action includes giving advice regarding a labor problem to the user, and in a case where the action determination unit determines giving advice regarding a labor problem to the user as the action of the avatar, the action determination unit determines giving advice regarding a labor problem to the user on the basis of an action of the user.

According to a thirty-eighth aspect of the disclosure, an action control system is provided. The action control system includes: a state recognition unit configured to recognize a user state including an action of a user and a state of an electronic device; an emotion determination unit configured to determine an emotion of the user or an emotion of an avatar representing an agent for interacting with the user; an action determination unit configured to determine any of a plurality of types of avatar actions including not acting as an action of the avatar, using at least one of the user state, the state of the electronic device, the emotion of the user, or the emotion of the avatar, and an action determination model at a predetermined timing; and an action control unit configured to display the avatar in an image display area of the electronic device, wherein the action determination unit autonomously detects a body temperature of the user, the emotion determination unit determines at least one of an emotion of the user or an emotion of the avatar on the basis of the detected state of the user, determines a mode of at least one of a gesture or an utterance according to the determined at least one emotion, and causes the action control unit to control the avatar on the basis of the determined at least one mode.

### BRIEF DESCRIPTION OF DRAWINGS

FIG. 1 schematically illustrates an example of a system 5 according to a first embodiment.

FIG. 2 schematically illustrates a functional configuration of a robot 100 according to the first embodiment.

FIG. 3 schematically illustrates an example of an operation flow of collection processing performed by the robot 100 according to the first embodiment.

FIG. 4A schematically illustrates an example of an operation flow of response processing performed by the robot 100 according to the first embodiment.

FIG. 4B schematically illustrates an example of an operation flow of autonomous processing performed by the robot 100 according to the first embodiment.

FIG. 5 illustrates an emotion map 400 on which a plurality of emotions is mapped.

FIG. 6 illustrates an emotion map 900 on which a plurality of emotions is mapped.

FIG. 7 (A) is an external view of a stuffed toy 100N according to a second embodiment, and FIG. 7 (B) is an internal structural view of the stuffed toy 100N.

FIG. 8 is a rear front view of the stuffed toy 100N according to the second embodiment.

FIG. 9 schematically illustrates a functional configuration of the stuffed toy 100N according to the second embodiment.

FIG. 10 schematically illustrates a functional configuration of an agent system 500 according to a third embodiment.

FIG. 11 illustrates an example of an operation of the agent system.

FIG. 12 illustrates an example of an operation of the agent system.

FIG. 13 schematically illustrates a functional configuration of an agent system 700 according to a fourth embodiment.

FIG. 14 illustrates an example of a usage mode of an agent system using smart glasses.

FIG. 15 schematically illustrates a functional configuration of an agent system 800 according to a fifth embodiment.

FIG. 16 illustrates an example of a headset type terminal.

FIG. 17 schematically illustrates an example of a hardware configuration of a computer 1200.

### DESCRIPTION OF EMBODIMENTS

Hereinafter, the disclosure will be described through embodiments of the disclosure, but the following embodiments do not limit the disclosure according to the claims. In addition, not all combinations of features described in the embodiments are essential to the disclosed solutions.

### First Embodiment

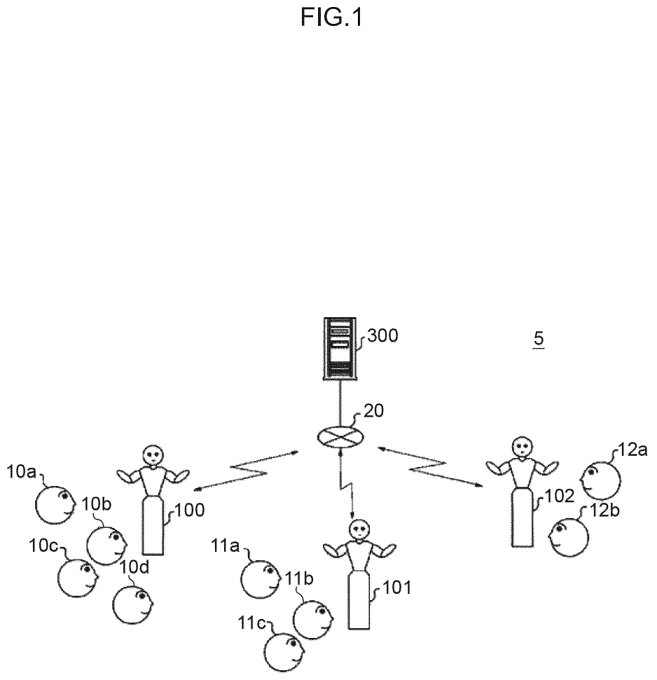

FIG. 1 schematically illustrates an example of a system 5 according to the present embodiment. The system 5 includes a robot 100, a robot 101, a robot 102, and a server 300. A user 10a, a user 10b, a user 10c, and a user 10d are users of the robot 100. A user 11a, a user 11b, and a user 11c are users of the robot 101. A user 12a and a user 12b are users of the robot 102. Note that, in the description of the present embodiment, the user 10a, the user 10b, the user 10c, and the user 10d may be collectively referred to as a user 10. Furthermore, the user 11a, the user 11b, and the user 11c may be collectively referred to as a user 11. Furthermore, the user 12a and the user 12b may be collectively referred to as a user 12. The robot 101 and the robot 102 have substantially the same functions as those of the robot 100. Therefore, the system 5 will be described focusing on the function of the robot 100.

The robot 100 has a conversation with the user 10 and provides a video to the user 10. At this time, the robot 100 provides a conversation with the user 10, a video to the user 10, and the like in cooperation with the server 300 and the like that can communicate via a communication network 20. For example, the robot 100 not only learns appropriate conversations by itself, but also performs learning such that conversations with the user 10 can be advanced more appropriately in cooperation with the server 300. Furthermore, the robot 100 causes the server 300 to record captured video data and the like of the user 10, requests video data and the like from the server 300 as necessary, and provides the video data and the like to the user 10.

Furthermore, the robot 100 has an emotion value indicating the type of its own emotion. For example, the robot 100 has emotion values indicating the intensity of each of emotions of “joyful”, “angry”, “sad”, “happy”, “comfortable”, “uncomfortable”, “relaxed”, “anxious”, “sorrowful”, “excited”, “worried”, “relieved”, “feeling filled”, “feeling empty”, and “normal”. For example, when the robot 100 has a conversation with the user 10 in a state in which the emotion value of excitement is large, the robot 100 emits vocal sound at a high speed. In this manner, the robot 100 can express its own emotion by action.

Furthermore, the robot 100 may be configured to determine an action of the robot 100 corresponding to an emotion of the user 10 by matching a sentence generation model using artificial intelligence (AI) with an emotion engine. Specifically, the robot 100 may be configured to recognize an action of the user 10, determine an emotion of the user 10 for the action of the user, and determine an action of the robot 100 corresponding to the determined emotion.

More specifically, in a case where the robot 100 recognizes an action of the user 10, the robot 100 automatically generates action content to be taken by the robot 100 with respect to the action of the user 10 using a preset sentence generation model. The sentence generation model may be interpreted as an algorithm and an operation for automatic interaction processing with characters. Since the sentence generation model is known as disclosed in, for example, Japanese Patent Application Laid-Open No. 2018-081444 and ChatGPT (Internet search <URL: https://openai.com/blog/chatgpt>), a detailed description thereof will be omitted. Such a sentence generation model is configured by a large language model (LLM: Large Language Model).

As described above, in the present embodiment, it is possible to reflect emotions of the user 10 and the robot 100 and various types of linguistic information in actions of the robot 100 by combining a large language model and the emotion engine. That is, according to the present embodiment, it is possible to obtain a synergistic effect by combining the sentence generation model and the emotion engine.

Furthermore, the robot 100 has a function of recognizing actions of the user 10. The robot 100 recognizes an action of the user 10 by analyzing a face image of the user 10 acquired using a camera function and the vocal sound of the user 10 acquired by a microphone function. The robot 100 determines an action to be executed by the robot 100 on the basis of the recognized action of the user 10, and the like.

As an example of an action determination model, the robot 100 stores a rule defining an action to be executed by the robot 100 on the basis of an emotion of the user 10, an emotion of the robot 100, and an action of the user 10, and performs various actions according to the rule.

Specifically, the robot 100 includes, as an example of the action determination model, a reaction rule for determining an action of the robot 100 on the basis of an emotion of the user 10, an emotion of the robot 100, and an action of the user 10. In the reaction rule, for example, an action of “smiling” is defined as an action of the robot 100 with respect to a case in which an action of the user 10 is “smiling”. Furthermore, in the reaction rule, an action of “apologizing” is defined as an action of the robot 100 with respect to a case in which an action of the user 10 is “angry”. Furthermore, in the reaction rule, an action of “answering” is defined as an action of the robot 100 with respect to a case in which an action of the user 10 is “asking a question”. Furthermore, in the reaction rule, an action of “calling out” is defined as an action of the robot 100 with respect to a case in which an action of the user 10 is “being sad”.

In a case where the robot 100 recognizes that an action of the user 10 is “angry”, the robot selects an action of “apologizing” defined in the reaction rule as an action to be executed by the robot 100 on the basis of the reaction rule. For example, when selecting the action of “apologizing”, the robot 100 performs an action of “apologizing” and outputs vocal sound expressing a word of “sorry”

Furthermore, in a case where conditions that an emotion of the robot 100 is “normal” (that is, “joyful”=0, “angry”=0, “sad”=0, and “happy”=0) and a state of the user 10 is “alone, looks lonely” are satisfied, it is defined that content of the emotion of the robot 100 will be changed to “worried” and an action of “calling out” can be executed.

In a case where the current emotion of the robot 100 is “normal” and the robot 100 recognizes that the user 10 is in an alone and lonely state on the basis of the reaction rule, the emotion value of “sad” of the robot 100 is increased. Furthermore, the robot 100 selects an action of “calling out” defined in the reaction rule as an action to be executed on the user 10. For example, in a case where the action of “calling out” is selected, the robot 100 converts words “What's wrong?” expressing concern into a worried vocal sound, and outputs the vocal sound.

Furthermore, the robot 100 transmits, to the server 300, user reaction information indicating that a positive reaction has been obtained from the user 10 by this action. The user reaction information includes, for example, a user action of “angry”, an action of the robot 100 of “apologizing”, a positive reaction of the user 10, and an attribute of the user 10.

The server 300 stores the user reaction information received from the robot 100. Note that the server 300 receives and stores user reaction information not only from the robot 100 but also from each of the robot 101 and the robot 102. Then, the server 300 analyzes the user reaction information from the robot 100, the robot 101, and the robot 102, and updates the reaction rule.

The robot 100 receives the updated reaction rule from the server 300 by asking a question of the server 300 about the updated reaction rule. The robot 100 incorporates the updated reaction rule into the reaction rule stored in the robot 100. As a result, the robot 100 can incorporate the reaction rule acquired by the robot 101, the robot 102, and the like into its own reaction rule.

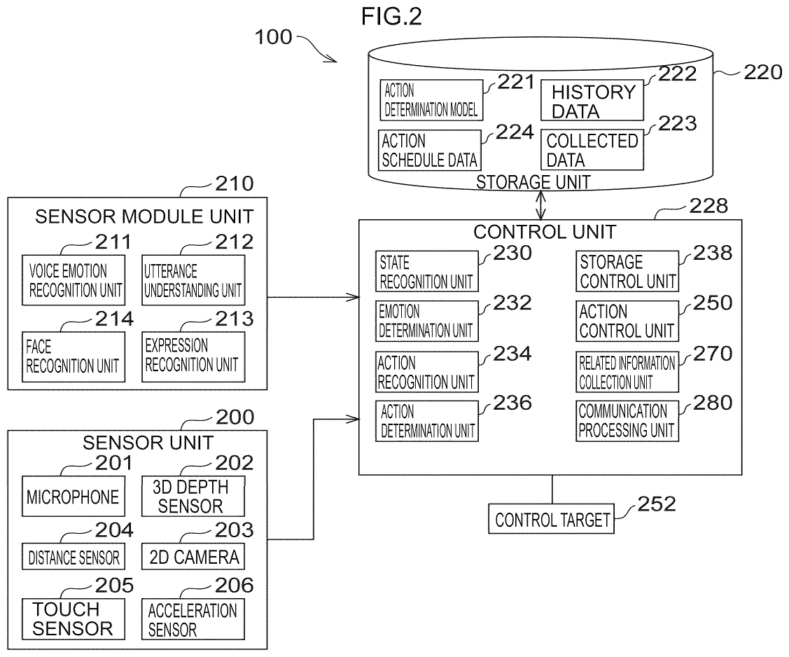

FIG. 2 schematically illustrates a functional configuration of the robot 100. The robot 100 includes a sensor unit 200, a sensor module unit 210, a storage unit 220, a control unit 228, and a control target 252. The control unit 228 includes a state recognition unit 230, an emotion determination unit 232, an action recognition unit 234, an action determination unit 236, a storage control unit 238, an action control unit 250, a related information collection unit 270, and a communication processing unit 280.

The control target 252 includes a display device, a speaker, LEDs of an eye portion, motors that drive arms, hands, feet, and the like, and the like. Postures and behaviors of the robot 100 are controlled by controlling the motors driving the arms, hands, feet, and the like. Some of the emotions of the robot 100 can be expressed by controlling these motors. Furthermore, expressions of the robot 100 can be expressed by controlling light emission states of the LEDs of the eye portion of the robot 100. Note that postures, behaviors, and expressions of the robot 100 are examples of attitudes of the robot 100.

The sensor unit 200 includes a microphone 201, a 3D depth sensor 202, a 2D camera 203, a distance sensor 204, a touch sensor 205, and an acceleration sensor 206. The microphone 201 continuously detects vocal sound and outputs vocal sound data. Note that the microphone 201 may be provided on the head portion of the robot 100 and may have a function of performing binaural recording. The 3D depth sensor 202 detects the outline of an object by continuously radiating an infrared pattern and analyzing the infrared pattern from an infrared image continuously captured by an infrared camera. The 2D camera 203 is an example of an image sensor. The 2D camera 203 captures an image with visible light and generates video information of visible light. The distance sensor 204 detects a distance to an object by emitting, for example, a laser, an ultrasonic wave, or the like. Note that the sensor unit 200 may further include a clock, a gyro sensor, a sensor for motor feedback, and the like.

Note that, among the components of the robot 100 illustrated in FIG. 2, the components other than the control target 252 and the sensor unit 200 are examples of components included in an action control system included in the robot 100. The action control system of the robot 100 controls the control target 252.

The storage unit 220 includes an action determination model 221, history data 222, collected data 223, and action schedule data 224. The history data 222 includes past emotion values of the user 10, past emotion values of the robot 100, and a history of actions, and specifically includes a plurality of pieces of event data including emotion values of the user 10, emotion values of the robot 100, and actions of the user 10. Data including actions of the user 10 includes camera images representing actions of the user 10. The emotion values and the history of actions are recorded for each user 10 by being associated with identification information of the user 10, for example. Furthermore, the history data 222 includes information regarding user's emotions (for example, whether the user is satisfied with a policy of a region, is satisfied with a product being used, is satisfied with the relationship with neighborhood residents, is satisfied with the relationship in the home, or the like) for items provided by providers. At least a part of the storage unit 220 is implemented by a storage medium such as a memory. A person DB that stores face images of the user 10, attribute information of the user 10, and the like may be included. Note that, among the components of the robot 100 illustrated in FIG. 2, the functions of the components other than the control target 252, the sensor unit 200, and the storage unit 220 can be realized by a CPU operating on the basis of a program. For example, the functions of these components can be implemented as operations of the CPU by basic software (OS) and a program operating on the OS.

The sensor module unit 210 includes a voice emotion recognition unit 211, an utterance understanding unit 212, an expression recognition unit 213, and a face recognition unit 214. Information detected by the sensor unit 200 is input to the sensor module unit 210. The sensor module unit 210 analyzes information detected by the sensor unit 200 and outputs an analysis result to the state recognition unit 230.

The voice emotion recognition unit 211 of the sensor module unit 210 analyzes a vocal sound of the user 10 detected by the microphone 201 to recognize an emotion of the user 10. For example, the voice emotion recognition unit 211 extracts a feature amount such as a frequency component of vocal sound and recognizes an emotion of the user 10 on the basis of the extracted feature amount. The utterance understanding unit 212 analyzes the vocal sound of the user 10 detected by the microphone 201 and outputs character information indicating the utterance content of the user 10.

The expression recognition unit 213 recognizes an expression of the user 10 and an emotion of the user 10 from an image of the user 10 captured by the 2D camera 203. For example, the expression recognition unit 213 recognizes an expression and an emotion of the user 10 on the basis of the shapes, positional relationships, and the like of the eyes and the mouth.

The face recognition unit 214 recognizes the face of the user 10. The face recognition unit 214 recognizes the user 10 by matching face images stored in a person DB (not illustrated) with a face image of the user 10 captured by the 2D camera 203.

The state recognition unit 230 recognizes a state of the user 10 on the basis of information analyzed by the sensor module unit 210. For example, processing mainly related to perception is performed using an analysis result of the sensor module unit 210. For example, perception information such as “Dad is alone.” and “There is a 90% chance that dad will not smile.” is generated. Processing of understanding the meaning of the generated perception information is performed. For example, semantic information such as ““Dad looks lonely all alone.” is generated.

The state recognition unit 230 recognizes a state of the robot 100 on the basis of information detected by the sensor unit 200. For example, the state recognition unit 230 recognizes a remaining battery level of the robot 100, the brightness of the surrounding environment of the robot 100, and the like as the state of the robot 100.

The emotion determination unit 232 determines an emotion value indicating an emotion of the user 10 on the basis of information analyzed by the sensor module unit 210 and a state of the user 10 recognized by the state recognition unit 230. For example, the information analyzed by the sensor module unit 210 and the recognized state of the user 10 are input to a neural network trained in advance, and an emotion value indicating the emotion of the user 10 is acquired.

Here, an emotion value indicating an emotion of the user 10 is a value indicating whether the emotion of the user is positive or negative, and for example, if the emotion of the user is a bright emotion accompanied with pleasure or comfort, such as “joy”, “pleasure”, “comfort”, “security”, “excitement”, “relief”, and “sense of fulfillment”, the emotion value indicates a positive value, and the value becomes larger as the emotion becomes brighter. If the emotion of the user is an emotion that makes the user feel discomfort, such as “anger”, “sadness”, “discomfort”, “anxiety”, “sorrow”, “worry”, and “emptiness”, the emotion value indicates a negative value, and the absolute value of the negative value increases as the user feels more discomfort. In a case where the emotion of the user is not any of the above (“normal”), the emotion value indicates a value of 0.

Furthermore, the emotion determination unit 232 determines an emotion value indicating an emotion of the robot 100 on the basis of the information analyzed by the sensor module unit 210, the information detected by the sensor unit 200, and the state of the user 10 recognized by the state recognition unit 230.

The emotion value of the robot 100 includes the emotion value for each of the plurality of emotion classifications, and is, for example, a value (0 to 5) indicating the intensity of each of “joy”, “anger”, “sadness”, and “happiness”.

Specifically, the emotion determination unit 232 determines an emotion value indicating an emotion of the robot 100 according to a rule for updating the emotion value of the robot 100 defined in association with the information analyzed by the sensor module unit 210 and the state of the user 10 recognized by the state recognition unit 230.

For example, in a case where the state recognition unit 230 recognizes that the user 10 looks lonely, the emotion determination unit 232 increases the emotion value of “sadness” of the robot 100. Furthermore, in a case where the state recognition unit 230 recognizes that the user 10 has a smiling face, the emotion value of “joy” of the robot 100 is increased.

Note that the emotion determination unit 232 may determine an emotion value indicating an emotion of the robot 100 in further consideration of the state of the robot 100. For example, in a case where the remaining battery level of the robot 100 is low, a case in which the surrounding environment of the robot 100 is dark, or the like, the emotion value of “sad” of the robot 100 may be increased. Furthermore, in the case of the user 10 continuously talking even though the remaining battery level is low, the emotion value of “anger” may be increased.

The action recognition unit 234 recognizes an action of the user 10 on the basis of information analyzed by the sensor module unit 210 and a state of the user 10 recognized by the state recognition unit 230. For example, the information analyzed by the sensor module unit 210 and the recognized state of the user 10 are input to a neural network trained in advance, probabilities of a plurality of predetermined action classifications (for example, “smile”, “get angry”, “ask a question”, and “sad”) are acquired, and the action classification having the highest probability is recognized as an action of the user 10.

As described above, in the present embodiment, the robot 100 acquires utterance content of the user 10 after identifying the user 10, but in acquiring and using the utterance content, the action control system of the robot 100 according to the present embodiment considers protection of personal information and privacy of the user 10 in addition to acquiring necessary consent according to laws and regulations from the user 10.

Next, processing of the action determination unit 236 when the robot 100 performs response processing of responding to an action of the user 10 will be described.

The action determination unit 236 determines an action corresponding to an action of the user 10 recognized by the action recognition unit 234 on the basis of the current emotion value of the user 10 determined by the emotion determination unit 232, the history data 222 of the past emotion values determined by the emotion determination unit 232 before the current emotion value of the user 10 is determined, and the emotion value of the robot 100. In the present embodiment, a case in which the action determination unit 236 uses one most recent emotion value included in the history data 222 as a past emotion value of the user 10 will be described, but the disclosed technology is not limited to this aspect. For example, the action determination unit 236 may use a plurality of most recent emotion values or may use emotion values that are earlier by a unit period such as one day before as past emotion values of the user 10. Furthermore, the action determination unit 236 may determine an action corresponding to an action of the user 10 in further consideration of a history of past emotion values of the robot 100 in addition to the current emotion value of the robot 100. The action determined by the action determination unit 236 includes a gesture to be performed by the robot 100 or utterance content of the robot 100.

The action determination unit 236 according to the present embodiment determines an action of the robot 100 on the basis of a combination of a past emotion value and the current emotion value of the user 10, the emotion value of the robot 100, the action of the user 10, and the action determination model 221 as an action corresponding to the action of the user 10. For example, in a case where a past emotion value of the user 10 is a positive value and the current emotion value is a negative value, the action determination unit 236 determines an action for positively changing the emotion value of the user 10 as an action corresponding to the action of the user 10.

In the reaction rule as the action determination model 221, actions of the robot 100 according to combinations of past emotion values and the current emotion value of the user 10, emotion values of the robot 100, and actions of the user 10 are determined. For example, in a case where a past emotion value of the user 10 is a positive value, the current emotion value is a negative value, and an action of the user 10 is sad, a combination of a gesture and utterance content at the time of making an inquiry to encourage the user 10 including a gesture is determined as an action of the robot 100.

For example, in the reaction rule as the action determination model 221, an action of the robot 100 is determined for all combinations of patterns of emotion values of the robot 100 (1296 patterns that are the fourth power of six values of “joyful”, “angry”, “sad”, and “happy” values “0” to “5”), patterns of combinations of past emotion values and the current emotion value of the user 10, and action patterns of the user 10. That is, for each pattern of emotion values of the robot 100, an action of the robot 100 according to an action pattern of the user 10 is determined for each of a plurality of combinations such as combinations of the past emotion values and the current emotion value of the user 10, such as a negative value and a negative value, a negative value and a positive value, a positive value and a negative value, a positive value and a positive value, a negative value and a normal value, and a normal and a normal value. Note that the action determination unit 236 may transition to an operation mode of determining an action of the robot 100 using the history data 222, for example, in a case where the user 10 has made an utterance that intends a conversation continued from a past topic such as “I want to talk about the topic we talked about the other day”.

Note that, in the reaction rule as the action determination model 221, at least one of a gesture or utterance content may be determined as an action of the robot 100 for each of the patterns (1296 patterns) of emotion values of the robot 100 at the maximum. Alternatively, in the reaction rule as the action determination model 221, at least one of a gesture or utterance content may be determined as an action of the robot 100 for each of groups of the patterns of emotion values of the robot 100.

In each gesture included in an action of the robot 100 determined in the reaction rule as the action determination model 221, the intensity of the gesture is determined in advance. In each utterance content included in an action of the robot 100 determined in the reaction rule as the action determination model 221, the intensity of the utterance content is determined in advance.

The storage control unit 238 determines whether to store data including an action of the user 10 in the history data 222 on the basis of the intensity of an action determined in advance for an action determined by the action determination unit 236 and an emotion value of the robot 100 determined by the emotion determination unit 232.

Specifically, in a case where the total value of intensities, which is the sum of the emotion values for each of the plurality of emotion classifications of the robot 100, the intensity predetermined for the gesture included in the action determined by the action determination unit 236, and the intensity predetermined for the utterance content included in the action determined by the action determination unit 236 is equal to or greater than a threshold value, it is determined that data including the action of the user 10 is stored in the history data 222.

In a case where the storage control unit 238 determines that the data including the action of the user 10 is stored in the history data 222, the action determined by the action determination unit 236, information analyzed by the sensor module unit 210 from the current time point to a certain period before (for example, any peripheral information such as data such as vocal sound, an image, and a smell of the place), and the state (for example, the expression, emotion, and the like of the user 10.) of the user 10 recognized by the state recognition unit 230 are stored in the history data 222.

The action control unit 250 controls the control target 252 on the basis of the action determined by the action determination unit 236. For example, in a case where the action determination unit 236 determines an action including utterance, the action control unit 250 causes a speaker included in the control target 252 to output a vocal sound. At this time, the action control unit 250 may determine an utterance speed of the vocal sound on the basis of the emotion value of the robot 100. For example, the action control unit 250 determines a higher utterance speed as the emotion value of the robot 100 is larger. In this manner, the action control unit 250 determines an execution form of the action determined by the action determination unit 236 on the basis of the emotion value determined by the emotion determination unit 232.

The action control unit 250 may recognize a change in the emotion of the user 10 with respect to execution of the action determined by the action determination unit 236. For example, the change in the emotion may be recognized on the basis of the vocal sound or expression of the user 10. In addition, the change in the emotion of the user 10 may be recognized on the basis of detection of an impact by the touch sensor 205 included in the sensor unit 200. In a case where an impact is detected by the touch sensor 205 included in the sensor unit 200, it may be recognized that the emotion of the user 10 is worsened, or in a case where it is determined that the reaction of the user 10 is smiling or happy from the detection result of the touch sensor 205 included in the sensor unit 200, it may be recognized that the emotion of the user 10 is improved. Information indicating the reaction of the user 10 is output to the communication processing unit 280.

Furthermore, after the action control unit 250 executes the action determined by the action determination unit 236 in the execution form determined according to the emotion of the robot 100, the emotion determination unit 232 further changes the emotion value of the robot 100 on the basis of a response of the user to the execution of the action. Specifically, the emotion determination unit 232 increases the emotion value of “joyful” of the robot 100 in a case where a response of the user to the action determined by the action determination unit 236 being performed on the user in the execution form determined by the action control unit 250 is not bad. Furthermore, the emotion determination unit 232 increases the emotion value of “sadness” of the robot 100 in a case where the response of the user to the action determined by the action determination unit 236 being performed on the user in the execution form determined by the action control unit 250 is bad.

Furthermore, the action control unit 250 expresses the emotion of the robot 100 on the basis of the determined emotion value of the robot 100. For example, in a case where the emotion value of “joy” of the robot 100 is increased, the action control unit 250 controls the control target 252 to cause the robot 100 to perform a behavior of joy. Furthermore, in a case where the emotion value of “sadness” of the robot 100 is increased, the action control unit 250 controls the control target 252 such that the posture of the robot 100 becomes a drooping posture.

The communication processing unit 280 is responsible for communication with the server 300. As described above, the communication processing unit 280 transmits user reaction information to the server 300. Furthermore, the communication processing unit 280 receives the updated reaction rule from the server 300. When the communication processing unit 280 receives the updated reaction rule from the server 300, the communication processing unit 280 updates the reaction rule as the action determination model 221.

The server 300 performs communication between the robots 100, 101, and 102 and the server 300, receives user reaction information transmitted from the robot 100, and updates the reaction rule on the basis of the reaction rule including an action for which a positive reaction has been obtained.

The related information collection unit 270 collects information related to preference information from external data (Web sites such as news sites and moving image sites) on the basis of preference information acquired for the user 10 at a predetermined timing.

Specifically, the related information collection unit 270 acquires preference information indicating a matter of interest of the user 10 from utterance content of the user 10 or a setting operation by the user 10. The related information collection unit 270 collects news related to the preference information from the external data at regular intervals using, for example, ChatGPTPlugins (Internet search <URL: https://openai.com/blog/chatgpt-plugins>). For example, in a case where it is acquired as preference information that the user 10 is a fan of a specific professional baseball team, the related information collection unit 270 collects news related to game results of the specific professional baseball team from external data at a predetermined time every day, for example, using ChatGPT Plugins.

The emotion determination unit 232 determines an emotion of the robot 100 on the basis of information related to the preference information collected by the related information collection unit 270.

Specifically, the emotion determination unit 232 inputs text indicating the information related to the preference information collected by the related information collection unit 270 to a neural network trained in advance for determining an emotion, acquires an emotion value indicating each emotion, and determines the emotion of the robot 100. For example, in a case in which the collected news related to the game result of the specific professional baseball team indicates that the specific professional baseball team has won, the emotion value of “joyful” of the robot 100 is determined to be increased.

When the emotion value of the robot 100 is equal to or greater than a threshold value, the storage control unit 238 stores the information related to the preference information collected by the related information collection unit 270 in the collected data 223.

Next, processing of the action determination unit 236 in autonomous processing, when the robot 100 autonomously acts, will be described.

In autonomous processing in the present embodiment, image data of pictures or moving images acquired in a case where an emotion value of the user 10 or the robot 100 reaches a predetermined criterion is included in the history data 222 as event data and saved, and a picture diary, that is, an event image, is created using a clip of the saved pictures or moving images. In addition, when the picture diary is created, the pictures or moving images are edited.

In the autonomous processing in the present embodiment, the robot 100 as an agent spontaneously and periodically detects the state of the user 10. The robot 100 constantly detects conversation on the phone between the user 10 and the partner (conversation partner) or video or conversation through an intercom and ascertains the content thereof. Furthermore, the robot 100 reads the conversation content and emotion of the conversation partner, and stores that the conversation content and voiceprint of the family and friends are safe. Furthermore, the robot 100 may cause a sentence generation model such as generative AI to read the sentence of the conversation to determine whether the conversation is a conversation with a high risk such as “It's me” fraud.

Next, in a case where there is a phone call or a visitor or in the middle of a conversation, when a safety value exceeds a certain value from the voiceprint, the voice quality, and the conversation content stored as safe, the robot 100 determines that there is a fraud risk. Furthermore, the robot 100 may spontaneously collect and accumulate past fraud cases from websites or news and store similar patterns. In a case where the robot 100 determines that the risk is high, the robot spontaneously notifies an elderly person himself/herself, a family member, or an emergency contact, and in a case where the risk is particularly high, immediately notifies the police. Furthermore, since the robot 100 can constantly collect information on recent news and trends in the world, the robot ascertains what kind of fraud is popular now, infers how to pay attention, and spontaneously talks to the user.

In the autonomous processing in the present embodiment, the action determination unit 236 autonomously detects the state of the user 10. For example, the action determination unit 236 autonomously detects a change in the body temperature of the user 10 at every predetermined timing. Specifically, the action determination unit 236 detects a change in the body temperature of the user 10 by comparing the body temperature of the user 10 autonomously measured at every predetermined timing by a temperature sensor with the body temperature of the user 10 measured last time, the average body temperature of the user 10, or the like. Note that a temperature sensor included in the robot 100 may be applied as the temperature sensor, or a temperature sensor included in a device other than the robot 100 may be applied.

Then, the action determination unit 236 determines at least one of the emotion of the user 10 or the emotion of the robot 100 on the basis of the detected state of the user 10.

Then, the action determination unit 236 determines the content of an utterance or a gesture for the user 10 according to at least one of the determined emotion of the user 10 or the emotion of the robot 100. Specifically, the action determination unit 236 inputs a text indicating the determined emotion to the action determination model 221. Then, the action determination unit 236 determines the content of an action output by the action determination model 221 as the content of an utterance or a gesture for the user 10.

In the autonomous processing in the present embodiment, in the robot 100, the action determination unit 236 acquires information indicating the hobby/preference of the user 10 via the sensor unit 200. For example, in the robot 100, usual conversations (for example, conversations at home) of the user 10 are acquired via the microphone 201, and the conversation content is analyzed by the action determination unit 236, whereby information indicating the hobby/preference of the user 10 is acquired. In this manner, the action determination unit 236 autonomously executes control for collecting the interest of the user 10 from conversations. Note that, in addition to conversations of the user 10, the action determination unit 236 may collect the interest of the user 10 from expressions of the user 10, the content of articles or books read by the user 10, the content of television programs or radio programs that the user 10 likes, and the like.

Then, the action determination unit 236 reflects the autonomously ascertained hobby/preference of the user 10 in answer generation of the AI sentence generation model, and estimation of the emotion of the user 10 and the emotion of the robot 100 by the emotion engine. For example, the action determination unit 236 estimates a favorite baseball team of the user 10 from acquired conversations. Then, in a case where the autonomously collected news related to a game result of a baseball team indicates that the favorite baseball team of the user 10 wins, the action determination unit 236 generates an answer “You did it!” to the user 10 and causes the robot 100 to express a feeling of joy (for example, causes the robot 100 to do a first pump, or the like). On the other hand, in a case where the favorite team of the user 10 loses to the competitor team, the action determination unit 236 generates an answer “regrettable!” and the robot 100 expresses an angry feeling (for example, folding arms with an angry expression, or the like). As described above, the action determination unit 236 determines not only utterance content but also the motion expressing the emotion by the robot 100 according to the autonomously ascertained hobby/preference of the user 10. In other words, the action determination unit 236 determines a gesture to be performed by the robot 100 according to the hobby/preference of the user 10.

In the autonomous processing in the present embodiment, the action determination unit 236 spontaneously and periodically detects the state of the user 10. The action determination unit 236 spontaneously infers a cultural area (also referred to as a language area) in which the user 10 lives, and reflects the estimated cultural area in answer generation by a sentence generation model using AI as an example of the action determination model 221, determination of an emotion of the user 10 by the emotion determination unit 232, and determination of an emotion of the robot 100 by the emotion determination unit 232. For example, in a case where the robot 100 infers that the user 10 resides in the Kansai area or in a case where the robot 100 detects that the user 10 is speaking the Kansai dialect, the robot 100 spontaneously switches to a brain of the Kansai area. In this case, the robot 100 makes a gesture to make a retort in Kansai dialect and generates utterances such as “Nandeyanen (Why?)”. Note that the action determination unit 236 may reflect the inferred cultural area in one or two of answer generation by the sentence generation model, determination of an emotion of the user 10 by the emotion determination unit 232, and determination of an emotion of the robot 100 by the emotion determination unit 232.

The action determination unit 236 may infer the cultural area of the user 10 by various methods. For example, the action determination unit 236 may infer the cultural area of the user 10 from conversations of the user 10. Note that “conversations of the user 10” here may be interpreted to include conversations between the user 10 and another robot, conversations between the users 10, and a soliloquy of the user 10, in addition to the interaction between the user 10 and the robot 100. That is, the action determination unit 236 may infer the cultural area of the user 10 from the conversation of the user 10 that the robot 100 itself has overheard without being a party, in addition to the interaction with the user 10 to which the robot 100 itself is a party. As an example, in a case where the user 10 frequently talks about Osaka Prefecture in a conversation, or in a case where local information of Osaka Prefecture is brought up as a topic, the action determination unit 236 may infer that the cultural area of the user 10 is the Kansai area. Furthermore, the action determination unit 236 may infer that the cultural area of the user 10 is the Kansai area in a case where the user uses the Kansai dialect in conversations. Alternatively or additionally, the action determination unit 236 may infer the cultural area of the user 10 on the basis of position information. As an example, the action determination unit 236 may store in advance a cultural area map in which position information and cultural areas are associated with each other, and in a case where position information measured by a positioning means such as a global positioning system (GPS) is associated with the Kansai area, the action determination unit may infer that the cultural area of the user 10 is the Kansai area. In this case, when viewed from the user 10, the robot 100 is transformed into a character in the Kansai area without being known by the user 10.

As described above, the robot 100 acts in accordance with the residential culture of the user 10, whereby the user experience can be improved.

The autonomous processing in the present embodiment includes processing in which the robot 100 spontaneously or periodically analyzes the state of a user participating in a specific game or the state of a player of the opposing team, particularly the emotion of the player, at an arbitrary timing, and gives advice regarding the specific game to the user on the basis of the analysis result. Here, the specific game may be a sport performed by a team including a plurality of people, such as a volleyball, a soccer, or a rugby. Furthermore, the user participating in the specific game may be a player performing the specific game or a support staff such as a manager or a coach of a specific team performing the specific game.

In the autonomous processing in the present embodiment, an agent may detect the action or state of the user spontaneously or periodically by monitoring the user. Specifically, the agent may track and analyze, that is, track which information posted on which WEB site the user is browsing by monitoring the user. The agent may be interpreted as an agent system to be described later. Hereinafter, the agent system may be simply referred to as an agent.

It may be interpreted that the agent or the robot 100 spontaneously acquires the state of the user without an external trigger.

The trigger from the outside may include a question from the user to the robot 100, an active action from the user to the robot 100, and the like. The term “periodic” may be interpreted as a specific cycle such as a unit of one second, a unit of one minute, a unit of one hour, a unit of several hours, a unit of several days, a unit of week, or a unit of day of the week.

The action of the user may be interpreted as the following action tendency of the user.
(1) A user stops by one or a plurality of specific stores in a commercial facility such as a department store in order to purchase a specific product. In addition, the user is moving to a display area of a plurality of products in a specific store.
(2) In order to purchase a specific product, the user browses one or a plurality of products on a specific electronic commerce (EC) sites using a smartphone or a personal computer.
(3) In order to determine a specific travel destination or lodging destination, the user browses information posted on one or a plurality of lodging reservation sites, travel sites, or the like using a smartphone or a personal computer.
(4) In order to purchase a specific financial product, the user browses specific information posted on one or a plurality of financial information sites using a smartphone, a personal computer, or the like.

The state of the user may include the following states of the user.
(1) A state in which the user continues to worry or think about which product to purchase while viewing the product in a specific store or repeating try-on.
(2) A state in which the user continues to worry or think about which product to purchase while browsing products on one or a plurality of EC sites using a smartphone or a personal computer.
(3) A state in which the user continues to worry or think about which lodging, travel destination, or the like to use while browsing information posted on one or a plurality of lodging reservation sites, travel sites, or the like using a smartphone or a personal computer.
(4) A state in which the user continues to worry or think about which financial product to invest in while browsing information posted on one or a plurality of financial information sites using a smartphone, a personal computer, or the like.

Furthermore, in the autonomous processing, the agent may ask a question to a generative AI about the detected state or action of the user.

Furthermore, in the autonomous processing, the answer of the generative AI to the question and action content proposing a thing may be stored in association with each other. The action content may be interpreted as action content by an electronic device that proposes at least one thing from two or more things. Specifically, the action content may be interpreted as action content by an electronic device that proposes a specific thing on the basis of the answer of the generative AI to the detected state or action of the user.

Information in which the answer of the generative AI is associated with the action content proposing a thing may be recorded as table information in a storage medium such as a memory. The table information may be interpreted as specific information recorded in the storage unit.

Furthermore, in the autonomous processing, action content that proposes at least one thing from among two or more things with respect to the state or action of the user may be executed using the specific information that is the stored table information. Specifically, in the autonomous processing, the state of the user may be detected spontaneously or periodically, and at least one thing may be proposed from among two or more things as an action of the electronic device on the basis of the detected state or action of the user and the specific information.

This specific information may be interpreted as information answered by the generative AI on the basis of at least one of history data regarding the user or information preferred by the user. That is, in the autonomous processing, at least one thing may be proposed from among two or more things as an action of the electronic device on the basis of the detected state or action of the user and at least one of history data regarding the user or information preferred by the user.

Hereinafter, an example of action content that proposes a thing will be described.

For example, by monitoring operation content of a user who uses a smartphone, in a case where the agent detects that the user cannot decide which one of the clothing manufactured by Company A and the clothing manufactured by Company B should be purchased, the agent asks the generative AI by itself.

The generative AI answers at least one of two or more things on the basis of at least one of the history data 222 related to the user and the information preferred by the user.

The history data 222 can include information obtained by tracking, for example, the personality, preference, habit, motion, idea, action, conversation content, emotion, and the like of the user.

The information preferred by the user may be interpreted as information included in the collected data 223 described above. Specifically, the information preferred by the user may be interpreted as preference information indicating things of interest of the user 10 stored in the collected data 223. More specifically, the information preferred by the user may include information frequently searched or selected by the user, for example, fashion (style), world situation, and the like.

The information preferred by the user is not limited thereto, and may include information regarding society emitted from a plurality of information sources. The information regarding society may include at least one of news, economic situation, social situation, political situation, financial situation, international situation, sports news, entertainment news, birth and death news, cultural situation, or fashion.

For example, in response to the question “What kind of product should be proposed to the user who cannot decide which clothing to purchase?” of the agent, the generative AI can answer as “Products of Company A will be subject to price increase from April, so purchase of products of Company A is recommended before price increase.” on the basis of at least one of the history data 222 related to the user or the information preferred by the user.

In addition, the generative AI can answer as “It is recommended to purchase products of Company B after price reduction because products of Company B will be price-reduced from April.”.

In addition, the generative AI can answer as “In view of the tendency of the products that the user recently purchases, it is recommended to purchase a product of Company C that is more expensive than the products of Companies A and B but is similar to the products of the Companies A and B.”.

The agent that has obtained the answer can propose at least one thing from two or more things on the basis of the detected state or action of the user and the recorded information. That is, the agent may refer to the recorded information and reproduce a vocal sound corresponding to the content of the product suitable for the detected state or action of the user through a speaker mounted in the smartphone, the robot 100, or the like.

The agent may refer to the recorded information and display an image corresponding to the content of the product suitable for the detected state or action of the user on a screen mounted on the smartphone, the robot 100, or the like.

The agent may refer to the recorded information and display a message explaining the content of the product suitable for the detected state or action of the user on a screen mounted on the smartphone, the robot 100, or the like.

Note that, instead of monitoring the operation content of the user who uses the smartphone, the agent may monitor the user moving to a display area of a plurality of products in a specific store using image data obtained by imaging the user with an imaging device.

As described above, according to the action control system of the disclosure, it is possible to select at least one of two or more things and determine an action content to be proposed to the user by using at least one of history data related to the user or information preferred by the user. For this reason, the agent spontaneously utters to a user who has difficulty in selecting a thing, and the like, and thus a thing suitable for the user can be recommended and proposed.

In the autonomous processing in the present embodiment, the robot 100 cooperates with various devices (not only an air conditioner and a television, but also a scale, a refrigerator, and the like) of the house and spontaneously collects information on the user 10 at all times. In addition, the robot 100 spontaneously collects various types of information on home devices. For example, the robot 100 spontaneously collects information about when the air conditioner is turned on and at what kind of weather, and at what temperature the emotion value rises. In addition, the robot 100 spontaneously collects information about how frequently the refrigerator is used and what is frequently taken in and out. Further, the robot 100 spontaneously collects information about a change in the weight of the user 10 and a relationship between a television program and a change in the emotion value of the user 10. Then, when the user 10 is nearby, the robot 100 informs the user of scheduled management and news of interest, and proposes advice regarding physical condition, recommended dishes, ingredients to be replenished, and the like. Furthermore, the robot 100 may automatically order ingredients to be replenished.

In the autonomous processing in the present embodiment, the robot 100 spontaneously and periodically detects the state of the user 10. For example, the robot 100 spontaneously and periodically detects an action of the user 10, an emotion of the user 10, and an emotion of the robot 100, adds a fixed sentence asking a question about an action of the robot 100 to be taken to text indicating the state of the user 10, and inputs the text to the sentence generation model to acquire action content of the robot 100. The action content is acquired and stored, and the stored action content (for example, utterance) is activated in another time period and at another time. As a result, the robot 100 spontaneously detects the state of the user 10, determines the action content of the robot 100 in advance, and when there is a certain trigger for the user 10 next time, the robot 100 itself can make an utterance or an action.

In the autonomous processing in the present embodiment, a device operation (robot action when an electronic device is the robot 100) determined by the action determination unit 236 includes encouraging an interaction with another person. Then, in a case where it is determined to encourage an interaction with another person as an action of the electronic device (action of the robot), the action determination unit 236 determines at least one of an interaction partner or an interaction method on the basis of event data.

In the autonomous processing in the present embodiment, the agent stores all the content of books read to a child by a parent (mother or father) who is a user at night. Furthermore, the agent stores the emotion of the child while the parent is reading aloud to the child. At random time on another day, the agent suggests reading similar books read when the response was good (for example, when the emotion value is high) to the child or the parents.

In the autonomous processing in the present embodiment, the robot 100 spontaneously and periodically detects the state of the user 10. For example, the action of the user 10, the surrounding environment of the user 10, the emotion of the user 10, and the emotion of the robot 100 are spontaneously and periodically detected, and a fixed sentence asking a question about an action of the robot 100 to be taken is added to text indicating the state of the user 10 and input to the sentence generation model to acquire action content of the robot 100. This action content is acquired and stored, and the stored action content (for example, utterance) is activated when the action content matches the surrounding environment of the user 10 at another time period or another timing set as an activation condition. As a result, the robot 100 spontaneously detects the state of the user 10, determines the action content of the robot 100 in advance, and when there is a certain trigger for the user 10 next time, the robot 100 itself can make an utterance or an action.

In the autonomous processing in the present embodiment, from all actions of the user detected and stored by a pressure sensor (air pressure sensor) set in the agent's hand, a touch sensor set in the nose, and the like, when the emotion value of the user at the time of detecting a gesture of the user exceeds a certain value, it is stored as a particularly important gesture. Then, in a case where the gesture and the emotion value of the user, which are the same as before, are detected at another timing, the utterance “The feeling is the same as that feeling at that time. What's wrong?” can be spontaneously performed.

In the autonomous processing in the present embodiment, the device operation (robot action when the electronic device is the robot 100) determined by the action determination unit 236 includes talking about an interest of the user 10. Then, in a case where it is determined to talk about an interest of the user 10 as an action of the electronic device (action of the robot), the action determination unit 236 determines utterance content regarding event data in which an emotion value satisfies a predetermined criterion.

In the autonomous processing in the present embodiment, the robot 100 as the agent spontaneously and periodically stores information based on the emotion of the user 10 with respect to a thing provided by a provider in the history data 222. Furthermore, the robot 100 spontaneously and periodically notifies the provider of information based on the emotion of the user 10 with respect to the thing provided by the provider.

Here, the “provider” means an individual or an organization that provides products, services, or the like to the user 10. The “organization” is, for example, an administrative organization, a commercial organization, a non-profit organization, or the like. The “administrative organization” is an organization that performs administration, such as a country, a prefecture, or a municipality. In addition, a “commercial organization” is an organization for profit such as a commercial company or a commercial corporation. In addition, a “non-profit organization” is an organization that is not for profit, such as a non-profit organization or a non-profit corporation.

Furthermore, the “information based on the emotion of the user 10 regarding the thing provided by the provider” is information indicating an emotion of the user 10 with respect to the thing provided by the provider, and may be, for example, information of a type of emotion of the user 10 such as “happy”, “fun”, “satisfied”, “not happy”, “not fun”, or “dissatisfied” or may be the above-described emotion value derived on the basis of the emotion of the user 10.

Furthermore, “notify the provider” means that information based on the emotion of the user 10 can be confirmed by the provider, and for example, the information may be transmitted to the provider by e-mail, or the information may be uploaded to a cloud such that the provider can confirm the information.

That is, the robot 100 can feed back a user's impression of a policy or service provided by a city to the city, or feed back a user's impression of a product or service provided by a company to the company.

In the autonomous processing in the present embodiment, in a case where the user or a family member of the user is pregnant or is in the process of trying to conceive, the robot 100 spontaneously collects information regarding pregnancy such as information regarding pregnancy and post-partum. In a case where the robot 100 detects that the user or a family member of the user is pregnant or is in process of trying to conceive, the robot 100 spontaneously provides various types of information related to pregnancy to parents who are pregnant or post-partum, and spontaneously assists the parents in navigating to control emotions. For example, the robot 100 spontaneously suggests ways to cope with worries during pregnancy and post-partum stress, improving parental confidence. Furthermore, the robot 100 spontaneously provides information regarding child care and support for adapting to life of a new family.

In the autonomous processing in the present embodiment, the robot 100 as an agent performs autonomous processing. More specifically, autonomous processing in which the robot 100 performs an action is performed on the basis of the past history (there may be no history) of the robot 100 and action monitoring of the user 10 regardless of whether or not the user 10 is present.

The robot 100 as an agent spontaneously and periodically detects the state of the user 10. For example, the robot 100 performs personality analysis having psychological grounds by unilaterally listening to the content uttered by the user or talking with the user. The robot 100 holds a history of conversations with the user 10 as history data 222, and performs personality analysis using the history data 222. As an example, the robot 10 analyzes the personality of the user 10 by analyzing the habit of speaking of the user 10 or ending of words recorded in the history data 222.

In addition, in a case where the user is emotional, depressed, or in a good mood, the robot 100 spontaneously analyzes the personality of the user 10 and notifies the user 10 of the analysis result of the personality.

When analyzing the personality of the user 10 and delivering the analysis result, the robot 100 may casually deliver the analysis result to the user in a conversation.

The robot 100 spontaneously analyzes the personality of the user 10 and delivers the analysis result of the personality to the user 10, and thus the user 10 can deepen the understanding of his/her personality.

In the autonomous processing in the present embodiment, the robot 100 spontaneously and periodically (or constantly) detects the state of the user 10. Specifically, the robot 100 spontaneously and periodically (or constantly) detects an action of the user 10 (for example, a conversation or an action), and gives advice regarding a labor problem on the basis of the detected action of the user 10. For example, the robot 100 constantly monitors the situation of the workplace of the user 10 who is a worker, stores actions of the user 10 in the history data 222, and spontaneously detects labor problems such as power harassment, sexual harassment, and bullying that are difficult for the user to notice on the basis of the actions of the user 10.

In addition, the robot 100 spontaneously collects preference information of the user 10 periodically (or constantly) and stores the collected information in the collected data 223. For example, the robot 100 spontaneously and periodically collects information on labor problems and stores the information in the collected data 223.

Then, in a case where the robot 100 detects labor problems of the user 10 on the basis of actions of the user 10, the robot 100 spontaneously proposes a coping method regarding the labor problems to the user 10 using the collected information and an inquiry to the sentence generation model having an interaction function. As a result, it is possible to provide support (for example, information regarding labor laws and appropriate procedures) that closely follows the emotion of the user 10.

In the autonomous processing in the present embodiment, the robot 100 spontaneously and periodically detects the state of the user 10. For example, changes in the body temperature of the user 10 observed by a thermo sensor are detected. Then, the detection result is reflected in answer generation of an AI sentence generation model and estimation of a user emotion and an emotion of the robot 100 by an emotion engine. For example, in a case where the entire body of the user 10 is heated, the robot 100 determines that the user 10 is “joyful” and performs a positive gesture or a positive utterance corresponding thereto.

The action determination unit 236 determines, as an action of the robot 100, any of a plurality of types of robot actions including not acting by using at least one of the state of the user 10, the emotion of the user 10, the emotion of the robot 100, or the state of the robot 100, and the action determination model 221 at a predetermined timing. Here, a case where a sentence generation model having an interaction function is used as the action determination model 221 will be described as an example.

Specifically, the action determination unit 236 inputs a text representing at least one of the state of the user 10, the emotion of the user 10, the emotion of the robot 100, or the state of the robot 100 and a text for asking a question about the robot action to the sentence generation model, and determines an action of the robot 100 on the basis of the output of the sentence generation model.

The action determination unit 236 determines, as an action of the robot 100, any of a plurality of types of robot actions including not acting by using at least one of the state of the user 10, the surrounding environment of the user 10, the emotion of the user 10, the emotion of the robot 100, or the state of the robot 100, and the action determination model 221 at a predetermined timing. Here, a case where a sentence generation model having an interaction function is used as the action determination model 221 will be described as an example.

Specifically, the action determination unit 236 inputs a text representing at least one of the state of the user 10, the surrounding environment of the user 10, the emotion of the user 10, the emotion of the robot 100, or the state of the robot 100 and a text for asking a question about the robot action to the sentence generation model, and determines an action of the robot 100 on the basis of the output of the sentence generation model.

For example, the plurality of types of robot actions includes the following (1) to (25).
(1) The robot does nothing.
(2) The robot dreams.
(3) The robot speaks to a user.
(4) The robot creates a picture diary.
(5) The robot proposes an activity.
(6) The robot proposes a partner with whom a user should meet.
(7) The robot introduces news that a user is interested in.
(8) The robot edits pictures and moving images.
(9) The robot studies with a user.
(10) The robot evokes memory.
(11) Giving advice to a user about a fraud risk.
(12) The robot gives advice to a user participating in a specific game.
(13) The robot selects at least one of two or more things for a user who has difficulty in selecting a thing, and the agent spontaneously reproduces a vocal sound corresponding to the selected content.
(14) The robot selects at least one of two or more things for a user who has difficulty in selecting a thing, and the agent voluntarily displays an image corresponding to the selected content.
(15) The robot selects at least one of two or more things for a user who has difficulty in selecting a thing, and the agent displays a message corresponding to the selected content.
(16) The robot gives household advice to a user.
(17) Action content of the robot is determined in advance.
(18) The robot encourages interaction with others.
(19) The robot gives advice on reading aloud.
(20) Asking a question about important gestures.
(21) The robot talks about user's interests.
(22) Notifying a provider of information based on a user's emotion for a thing provided by the provider.
(23) The robot gives advice on pregnant women.
(24) The robot performs analysis of the personality of a user.
(25) The robot gives advice on labor problems.

The action determination unit 236 inputs, to the sentence generation model, a text indicating the state of the user 10 and the state of the robot 100 recognized by the state recognition unit 230, the current emotion value of the user 10 determined by the emotion determination unit 232, and the current emotion value of the robot 100, and a text for asking a question about any of a plurality of types of robot actions including no acting every lapse of a certain period of time, and determines an action of the robot 100 on the basis of the output of the sentence generation model. Here, in a case where there is no user 10 around the robot 100, the text to be input to the sentence generation model may not include the state of the user 10 and the current emotion value of the user 10, or may include the fact that there is no user 10.

The action determination unit 236 inputs, to the sentence generation model, a text indicating the state of the user 10 and the state of the robot 100 recognized by the state recognition unit 230, the surrounding environment of the user 10, the current emotion value of the user 10 determined by the emotion determination unit 232, and the current emotion value of the robot 100, and a text for asking a question about any of a plurality of types of robot actions including no acting every lapse of a certain period of time, and determines an action of the robot 100 on the basis of the output of the sentence generation model. Here, in a case where there is no user 10 around the robot 100, the text to be input to the sentence generation model may not include the state of the user 10 and the current emotion value of the user 10, or may include the fact that there is no user 10.

As an example, a text of “the robot is in a very pleasant state. The user is in a normally pleasant state. The user is sleeping. Which one of the following actions (1) to (25) is good as an action of the robot?
(1) The robot does nothing.
(2) The robot dreams.
(3) The robot speaks to the user.
. . . ” is input to the sentence generation model. Based on the output “It can be said that either (1) doing nothing or (2) the robot dreams is the most appropriate action.” of the sentence generation model, “(1) do nothing” or “(2) the robot dreams” is determined as an action of the robot 100.

As another example, a text of “the robot is in a slightly sad state. The user is absent. The surroundings of the robot are dark. Which one of the following actions (1) to (25) is good as an action of the robot?
(1) The robot does nothing.
(2) The robot dreams.
(3) The robot speaks to the user.
. . . ” is input to the sentence generation model. On the basis of the output “It can be said that either (2) the robot dreams or (4) the robot creates a picture diary is the most appropriate action.” of the sentence generation model, “(2) The robot dreams” or “(4) The robot creates a picture diary.” is determined as an action of the robot 100.

In a case where the action determination unit 236 determines “(2) The robot dreams.”, that is, creation of an original event as a robot action, the action determination unit creates the original event obtained by combining a plurality of pieces of event data in the history data 222 using the sentence generation model. At this time, the storage control unit 238 causes the created original event to be stored in the history data 222.

In a case where the action determination unit 236 determines “(3) The robot speaks to the user.”, that is, the robot 100 utters, as a robot action, the action determination unit 236 determines the utterance content of the robot corresponding to the user state and the emotion of the user or the emotion of the robot using the sentence generation model. At this time, the action control unit 250 causes a speaker included in the control target 252 to output a vocal sound representing the determined utterance content of the robot. In a case where the user 10 is absent around the robot 100, the action control unit 250 stores the determined utterance content of the robot in the action schedule data 224 without outputting a vocal sound representing the determined utterance content of the robot.

In a case where the action determination unit 236 determines “(7) The robot introduces news that the user is interested in.” as a robot action, the action determination unit 236 determines utterance content of the robot corresponding to information stored in the collected data 223 using the sentence generation model. The information stored in the collected data 223 includes information regarding hobby/preference of the user 10. At this time, the action control unit 250 causes a speaker included in the control target 252 to output a vocal sound representing the determined utterance content of the robot. In a case where the user 10 is absent around the robot 100, the action control unit 250 stores the determined utterance content of the robot in the action schedule data 224 without outputting a vocal sound representing the determined utterance content of the robot.

Here, regarding “(7) The robot introduces news that the user is interested in.”, the related information collection unit 270 stores, in the collected data 223, information indicating the hobby/preference of the user 10 autonomously collected by the action determination unit 236.

For example, in a case where a favorite team of the user 10 wins in news regarding a result of a professional baseball game, the action determination unit 236 introduces the news and determines utterance content indicating joy such as “You did it!”. On the other hand, in a case where a favorite team of the user 10 loses, the action determination unit 236 determines utterance content indicating anger, such as “Sorry!”.

In addition, the action determination unit 236 determines a gesture by the robot 100 corresponding to the information stored in the collected data 223. For example, in a case where a favorite team of the user 10 wins, the action determination unit 236 introduces the news and determines a motion of expressing joy (for example, a pose for first pumps and cheers). On the other hand, in a case where a favorite team of the user 10 loses, the action determination unit 236 determines a motion of expressing anger (for example, a pose for holding arms).

Note that, here, an example of “(7) The robot introduces news that the user is interested in.” has been described as a robot action, but any action may be used as long as the action provides information according to the interest of the user 10, and network articles, sites, blogs, or posts on SNS in which the user is interested may be provided together with the news or instead of the news.

In a case where the action determination unit 236 determines “(8) The robot edits pictures and moving images.”, that is, editing images, as a robot action, the action determination unit 236 selects event data from the history data 222 on the basis of the emotion value, edits the image data of the selected event data, and outputs the edited image data. In a case where the user 10 is absent around the robot 100, the action control unit 250 stores the edited image data in the action schedule data 224 without outputting the edited image data.

In a case where the action determination unit 236 determines “(4) The robot creates a picture diary.”, that is, the robot 100 creates an event image, as a robot action, the action determination unit 236 selects a clip of pictures or moving images from the history data 222, generates an explanatory sentence on the images using a sentence generation model on the basis of the emotion value of the user 10 and the emotion value of the robot 100 when the clip of the selected pictures or moving images (hereinafter, simply referred to as images) is acquired, and outputs a combination of the images and the explanatory sentence as an event image, that is, a picture diary. At this time, (8) the robot may edit images by performing a robot action of editing pictures or moving images together. Note that the action determination unit 236 may generate an image representing the event data using an image generation model for the event data selected from the history data 222, generate the explanatory sentence representing the event data using the sentence generation model, and output a combination of the image representing the event data and the explanatory sentence representing the event data as the event image. In a case where the user 10 is absent around the robot 100, the action control unit 250 stores the event image in the action schedule data 224 without outputting the event image.

In a case where the action determination unit 236 determines “(5) The robot proposes an activity.”, that is, proposal of an action of the user 10, as a robot action, the action determination unit 236 determines the proposed action of the user using the sentence generation model on the basis of the event data stored in the history data 222. At this time, the action control unit 250 causes a speaker included in the control target 252 to output a vocal sound that proposes the action of the user. In a case where the user 10 is absent around the robot 100, the action control unit 250 stores proposal of the action of the user in the action schedule data 224 without outputting the vocal sound that proposes the action of the user.

In a case where the action determination unit 236 determines, as a robot action, “(6) The robot proposes a partner with whom the user should meet.”, that is, proposal of a partner who should have a contact with the user 10, the action determination unit 236 determines the proposed partner who should have a contact with the user using the sentence generation model on the basis of the event data stored in the history data 222. At this time, the action control unit 250 causes a speaker included in the control target 252 to output a vocal sound indicating proposal of a partner who should have a contact with the user. Note that, in a case where the user 10 is absent around the robot 100, the action control unit 250 stores proposal of a partner who should have a contact with the user in the action schedule data 224 without outputting the vocal sound indicating proposal of a partner who should have a contact with the user.

In a case where the action determination unit 236 determines, as a robot action, “(9) The robot studies together with the user.”, that is, utterance of the robot 100 related to study, the action determination unit 236 determines an utterance content of the robot for encouraging study, giving a study problem, or giving advice related to study, which corresponds to the user state and the emotion of the user or the emotion of the robot. At this time, the action control unit 250 causes a speaker included in the control target 252 to output a vocal sound representing the determined utterance content of the robot. In a case where the user 10 is absent around the robot 100, the action control unit 250 stores the determined utterance content of the robot in the action schedule data 224 without outputting a vocal sound representing the determined utterance content of the robot.

In a case where the action determination unit 236 determines, as a robot action, “(10) The robot evokes memory.”, that is, remembering event data, the action determination unit selects the event data from the history data 222. At this time, the emotion determination unit 232 determines the emotion of the robot 100 on the basis of the selected event data. Furthermore, the action determination unit 236 creates an emotion change event representing an utterance content or action of the robot 100 for changing the user's emotion value using the sentence generation model on the basis of the selected event data. At this time, the storage control unit 238 stores the emotion change event in the action schedule data 224.

For example, the fact that a moving image watched by the user relates to a panda is stored in the history data 222 as event data, “What are the words you should say about the topic related to the panda when you meet the user next time? Please list three.” is input to the sentence generation model in a case where the event data is selected, the robot 100 inputs “What makes the user most happy in (1), (2), and (3)?” to the sentence generation model in a case where the output of the sentence generation model is “(1) Let's go to the zoo, (2) Draw a picture of a panda, and (3) Let's buy a stuffed panda.”, and in a case where the output of the sentence generation model is “(1) Let's go to the zoo”, utterance of the robot 100 of “(1) Let's go to the zoo” when the robot 100 meets the user next time is created as an emotion change event and stored in the action schedule data 224.

Furthermore, for example, event data having a large emotion value of the robot 100 is selected as an impressive memory of the robot 100. This makes it possible to create an emotion change event on the basis of the event data selected as an impressive memory.

In a case where the action determination unit 236 determines, as a robot action, “(11) giving advice to the user on a fraud risk.”, that is, giving advice to the user on a fraud risk, the robot 100 acquires the conversation content and the voiceprint between the user 10 and a conversation partner. Specifically, the utterance understanding unit 212 analyzes the vocal sound of the user 10 and the vocal sound of the conversation partner detected by the microphone 201 to acquire the conversation content and the voiceprint between the user 10 and the conversation partner. Next, the robot 100 acquires an emotion value of the conversation partner. Specifically, the robot 100 acquires a vocal sound of the conversation partner from a telephone or an intercom or a video of the conversation partner shown on a screen of the intercom, and acquires an emotion value of the conversation partner. In addition, the robot 100 stores the conversation content between the user 10 and the conversation partner, the video of the intercom, and the like in the history data 222. Next, the robot 100 determines a fraud risk on the basis of the conversation content and the emotion value of the conversation partner. Specifically, the action determination unit 236 compares data of past fraud cases stored in the storage unit 220 with the conversation content to determine a safety value that is the degree of similarity between the conversation content and the fraud cases. Note that the action determination unit 236 may determine the degree of similarity between the conversation content and the fraud cases by causing a sentence generation model such as generative AI to read the sentence of the conversation. Then, the action determination unit 236 determines a safety value that is the degree of fraud risk on the basis of the degree of similarity between the conversation content and the fraud cases and the emotion value, voiceprint, and voice quality of the conversation partner. As an example, in a case where the degree of similarity between the conversation content and the fraud cases is high, the action determination unit 236 determines the safety value to be a high value regardless of the emotion value, the voiceprint, and the voice quality of the conversation partner. Furthermore, even in a case where the degree of similarity between the conversation content and the fraud cases is not so high, the action determination unit 236 determines the safety value to be a high value depending on the emotion value of “anxiety” or “excitement” of the conversation partner being high, the voiceprint, or the voice quality. Next, the action determination unit 236 determines an action according to the determined degree of the fraud risk. Specifically, in a case where the determined safety value exceeds a predetermined threshold value, the action determination unit 236 determines to take an action for informing that the fraud risk is high. For example, the action determination unit 236 may determine to take an action for informing the user 10 that the fraud risk is high. Furthermore, the action determination unit 236 may determine an action for informing a family member of the user 10 or an emergency contact that the fraud risk is high. Furthermore, the action determination unit 236 may determine an action for immediately notifying the police that the fraud risk is high. These actions may be appropriately determined depending on the degree of the fraud risk. Then, the action control unit 250 controls a speaker that is a control target device such that the informed matter is output as a vocal sound from the speaker. Regarding the “(11) giving advice to the user on a fraud risk.”, the related information collection unit 270 may spontaneously collect and accumulate past fraud cases from websites or news and store the same in the collected data 223. As a result, since the robot 100 can constantly collect information on recent news and trends in the world, it is possible to ascertain what type of fraud is popular now, estimate how to pay attention, and spontaneously speak to the user.

In a case where the action determination unit determines that the robot 100 utters in the actions (1) to (25) described above as a robot action, the action determination unit 236 determines an utterance content according to the inferred cultural area of the user 10 as the utterance content of the robot 100 corresponding to the user state and the emotion of the user 10 or the emotion of the robot 100 using the sentence generation model. For example, in a case where the cultural area of the user 10 inferred by the action determination unit 236 is in the Kansai area, a vocal sound representing the utterance content output by the robot 100 is a vocal sound in the Kansai dialect, such as an utterance “why?”. Note that the action determination unit 236 may make a gesture corresponding to the utterance content as a gesture corresponding to the inferred cultural area of the user 10, such as a tsukkomi gesture (a retort motion).

In a case where the action determination unit determines, as a robot action, “(12) the robot gives advice to a user participating in a specific game”, that is, giving advice to a user such as a player or a coach participating in a specific game regarding the specific game in which the user is participating, the action determination unit 236 first detects the emotions of a plurality of players participating in the game in which the user is participating.

In order to detect the emotions of the plurality of players described above, the action determination unit 236 includes an image acquisition unit that captures an image of a playing space in which the specific game in which the user participates is being performed. The image acquisition unit can be realized, for example, by using a part of the sensor unit 200 described above. Here, the playing space may include a space corresponding to each game, for example, a volleyball court, a soccer ground, or the like. Furthermore, the playing space may include a peripheral region of the above-described court or the like. It is preferable that the installation position of the robot 100 is considered such that the playing space can be viewed by the image acquisition unit.

Furthermore, the action determination unit 236 further includes a player analysis unit capable of analyzing emotions of a plurality of players in an image acquired by the image acquisition unit described above. The player analysis unit can determine the emotions of the plurality of players, for example, using a method similar to that of the emotion determination unit 232. Specifically, for example, information of a result of analyzing an image or the like acquired by the image acquisition unit by the sensor module unit 210 may be input to a neural network trained in advance, and emotion values indicating emotions of the plurality of players may be identified to determine the emotion of each player. Note that the image acquisition unit and the player analysis unit described above may be collected and stored as part of the collected data 223 by the related information collection unit 270.

If it can be identified that emotions of players are unstable or irritated from emotion values of the players who are playing a specific game, for example, volleyball, it is possible to advance the game in an advantageous manner by reflecting the identification result in the strategy of the team. Specifically, since a player with an unstable emotion or a player who is irritated tends to have a higher probability of making a mistake than a player with a stable emotion, if the player with an unstable emotion or the player who is irritated has more opportunities to touch the ball, for example, in volleyball, the possibility of making a mistake increases. Therefore, in the present embodiment, advice for advantageously progressing the game, specifically, an emotion value of each player analyzed by the action determination unit 236 is transmitted to the user, for example, a coach of one team during the game, and thus, advice to the user is performed.

In consideration of the above-described points, the player on which analysis is performed by the player analysis unit may be a player belonging to a specific team among a plurality of players in the playing space. More specifically, the specific team may be a team different from the team to which the user belongs, in other words, an opponent team. The robot 100 scans the emotions of the players of the opponent team, identifies the most emotionally unstable or irritated player, and advises the user regarding the same, such that the user can assist in effective strategy creation. As the strategy, for example, it is possible to assume that the game is progressed focusing on the position of the player who is emotionally unstable or irritated (for example, in a case where the game content is volleyball, the pitch distribution is concentrated toward the player who is emotionally unstable or irritated).

If such a robot 100 is used during a game of a type in which teams face each other, it can be expected that the game will be developed dominantly. Specifically, by identifying the most mentally unstable player during the game and targeting the player thoroughly, the user can come closer to winning.

The above-described advice by the action determination unit 236 may be autonomously executed by the robot 100 instead of being started by an inquiry from the user. Specifically, for example, it is preferable that the robot 100 detects when a coach who is the user is in trouble, when the team to which the user belongs is about to lose, when a member of the team to which the user belongs is having a conversation that seems to want advice, and the like, and performs utterance.

The action determination unit 236 selects, as a robot action, the action content of “(13)” described above, that is, at least one of two or more things, and the agent can spontaneously reproduce a vocal sound corresponding to the selected content.

The action determination unit 236 selects, as a robot action, the action content of “(14)” described above, that is, at least one of two or more things, and the agent can spontaneously display an image corresponding to the selected content.

The action determination unit 236 can select, as a robot action, the action content of “(15)” described above, that is, at least one of two or more things, and the agent can display a message corresponding to the selected content.

The related information collection unit 270 may store, in the collected data 223, information preferred by the user regarding the action content of the “(13)” described above.

The related information collection unit 270 may store, in the collected data 223, information preferred by the user regarding the action content of the “(14)” described above.

The related information collection unit 270 may store, in the collected data 223, information preferred by the user regarding the action content of the “(15)” described above.

The storage control unit 238 may store information obtained by tracking the action content of “(13)” described above, for example, the personality, preference, habit, motion, idea, action, conversation content, emotion, and the like of the user in the history data 222.

The storage control unit 238 may store information obtained by tracking the action content of “(14)” described above, for example, the personality, preference, habit, motion, idea, action, conversation content, emotion, and the like of the user in the history data 222.

The storage control unit 238 may store information obtained by tracking the action content of “(15)” described above, for example, the personality, preference, habit, motion, idea, action, conversation content, emotion, and the like of the user in the history data 222.

In a case where the action determination unit 236 determines, as a robot action, “(16) The robot gives household advice to the user”, that is, giving household advice, the action determination unit spontaneously collects information regarding the user 10 in conjunction with devices such as an air conditioner, a television, a scale, and a refrigerator that are present in the home.

Furthermore, regarding the “(16) The robot gives household advice to the user”, the related information collection unit 270 collects news that the user is interested in at a predetermined time every day from external data using, for example, ChatGPT Plugins.

Regarding the “(16) The robot gives household advice to the user”, the storage control unit 238 stores information related to the collected advice in the collected data 223.

In a case where the action determination unit 236 determines, as a robot action, “(17) Action content of the robot is determined in advance.”, that is, determining an action schedule of the robot 100, the action determination unit 236 determines a combination of activation conditions for activating the action schedule and content of the action schedule of the robot 100, and stores the combination in the action schedule data 224.

Specifically, a text representing the state of the user 10 and the state of the robot 100 recognized by the state recognition unit 230, the current emotion value of the user 10 determined by the emotion determination unit 232, the current emotion value of the robot 100, and the history data 222, and a text for asking a question about a robot action and activation conditions to be executed later are input to the sentence generation model, and a combination of the activation conditions for activating the action schedule and the content of the action schedule of the robot 100 is determined on the basis of the output of the sentence generation model. Here, the activation conditions are, for example, a time period and detection of the user 10. Furthermore, in a case where there is no user 10 around the robot 100, the text to be input to the sentence generation model may not include the state of the user 10 and the current emotion value of the user 10, or may include the fact that there is no user 10.

Specifically, a text representing the state of the user 10 and the state of the robot 100 recognized by the state recognition unit 230, the surrounding environment of the user 10, the current emotion value of the user 10 determined by the emotion determination unit 232, the current emotion value of the robot 100, and the history data 222, and a text for asking a question about a robot action and activation conditions to be executed later are input to the sentence generation model, and a combination of the activation conditions for activating the action schedule and the content of the action schedule of the robot 100 is determined on the basis of the output of the sentence generation model. Here, the activation conditions are, for example, a time period, a condition regarding the surrounding environment of the user 10, and detection of the user 10. Furthermore, in a case where there is no user 10 around the robot 100, the text to be input to the sentence generation model may not include the state of the user 10 and the current emotion value of the user 10, or may include the fact that there is no user 10.

Furthermore, specifically, a text representing the state of the user 10 and the state of the robot 100 recognized by the state recognition unit 230, the surrounding environment of the user 10, the current emotion value of the user 10 determined by the emotion determination unit 232, the current emotion value of the robot 100, and the history data 222, and a text for asking a question about a robot action and activation conditions to be executed later are input to the sentence generation model, and a combination of the activation conditions for activating the action schedule and the content of the action schedule of the robot 100 is determined on the basis of the output of the sentence generation model. Here, the activation conditions are, for example, a time period, a condition regarding the surrounding environment of the user 10, and detection of the user 10. Furthermore, in a case where there is no user 10 around the robot 100, the text to be input to the sentence generation model may not include the state of the user 10 and the current emotion value of the user 10, or may include the fact that there is no user 10.

The action determination unit 236 determines, as an action of the robot 100, execution of the content of the action schedule of the robot 100 in a case where the activation conditions of the action schedule data 224 are satisfied.

In a case where the action determination unit determines, as a robot action, “(18) The robot encourages interaction with others.”, that is, proposal of interaction with others to the user 10 by the robot 100, the action determination unit 236 determines at least one of an interaction partner or an interaction method on the basis of event data stored in the history data 222. For example, in a case where the state of the user 10 satisfies a condition of “alone, looks lonely”, the action determination unit 236 determines “(18) the robot encourages interaction with others.” as a robot action. Note that the state in which the user 10 is alone and looks lonely may be recognized on the basis of information analyzed by the sensor module unit 210 or may be recognized on the basis of schedule information such as a calendar. In such a case, the action determination unit 236 learns past conversations and experiences of the user 10 using the event data stored in the history data 222, and determines at least one, preferably both, of the interaction partner and the interaction method. As an example, in a case where “grandfather” is determined as an interaction partner and “telephone” is determined as an interaction method, the action determination unit 236 may determine utterance content of “Why don't you call Grandfather? The telephone number is ∘∘∘.”. In response to this, the action control unit 250 may cause a speaker included in the control target 252 to output a vocal sound representing the determined utterance content of the robot. Furthermore, in a case where “A” is determined as an interaction partner and “going to play at home” is determined as an interaction method, the action determination unit 236 may determine utterance content as “Why don't you go to the house of your close friend A? I will show you how to get to A's house.”. In response to this, the action control unit 250 may cause a speaker included in the control target 252 to output a vocal sound representing the determined utterance content of the robot, and may cause a display device included in the control target 252 to display a map from the user 10 to A's house. When the user 10 is absent around the robot 100, the action control unit 250 may store the determined utterance content of the robot 100 and a map in the action schedule data 224 without outputting a vocal sound or map representing the determined utterance content of the robot 100. As described above, inorganic electronic devices (for example, robots) can contribute to people's happiness by expressing their ego, wanting their families to be happy, and spontaneously performing various actions.

In a case where the action determination unit 236 determines, as a robot action, “(19) The robot gives advice on reading aloud”, that is, that the robot 100 gives advice regarding reading aloud to the user 10, the action determination unit generates advice regarding reading aloud from collected information regarding reading aloud according to predetermined proposal conditions, and provides the advice to the user 10 who is a parent or a child. The advice is provided, for example, by the robot 100 uttering the advice.

Specifically, for the user 10 recognized by the state recognition unit 230, the case of a first user who is a parent (mother or father) on the side of reading aloud to a child and the case of a second user who is the child on the side of being read aloud are respectively identified, and the action determination unit 236 executes processing for generating and providing advice regarding reading aloud to at least one of the users according to the proposal conditions. At least advice provision frequency is set in the proposal conditions. The user 10 can appropriately change the setting such as once every three days or once every five days as the provision frequency. The action determination unit 236 generates and provides advice in accordance with the provision frequency set as the proposal conditions. Furthermore, in the proposal conditions, the frequency of providing advice to the first user (parents) and the frequency of providing advice to the second user (child) may be set in advance. Furthermore, as will be described below, conditions regarding the first user (parents) and the second user (child) may be further set.

The related information collection unit 270 collects content of books that the first user is reading to the second user with respect to the first user (parents), and stores the books and titles related to the books. As the content of the books, input of the titles of the books from the first user is received in advance, and outlines, text, and the like indicating the content of the books are collected from external data and stored. Furthermore, the content of the books may be collected by referring to external data from the utterance of the first user instead of the input of the first user.

Information analyzed by the sensor module unit 210 or the like is collected with respect to the state of the second user (child) being read aloud, the state recognition unit 230 recognizes the state, and the emotion determination unit 232 determines an emotion value (corresponding to step S102 described later). Furthermore, the action determination unit 236 may store the content read aloud when the emotion value is high, and may include the content itself or a summary of the content in the advice.

Examples of the collected information regarding reading aloud include the content (or the summary of the content) of the books that the first user (parents) is reading and the emotion value of the second user (child) when the second user (child) is being read aloud, and the like. As described above, as the information regarding reading aloud, each piece of information focusing on the first user and information focusing on the second user is collected.

The action determination unit 236 generates advice regarding reading aloud on the basis of the collected information regarding reading aloud and provides the advice regarding reading aloud according to the proposal conditions. The advice regarding reading aloud may be, for example, content that lists books that have been read aloud when the emotion value is high or books similar to the content of the books at that time and proposes the titles of the books of reading aloud. The user who provides the advice may be the first user (parents) or the second user (child), and the advice is given according to the type of the user. For example, for the first user (parents), advice with content such as “Why don't you read aloud to the child?” These are the titles of recommended books: 1.AAAA. 2.BBBB. 3.CCCC. 4.DDDD . . . “is provided. For the second user, advice such as, “Why don't you have AAAA read aloud to you?” is provided. Furthermore, at the time of reading aloud, the content of a book when the emotion value of the second user (child) is high may be summarized and included as additional information. For example, advice including additional information such as “AAAA seems to have favorite XXXX scene” may be provided to the first user (parents), and “AAAA liked XXXX” may be provided to the second user (child). Note that the above advice is an example.

Furthermore, the action determination unit 236 may collect the date and time when the first user (parents) has read aloud and provide advice regarding reading aloud in a case where the first user (parents) has not read aloud in a certain period of time, for example, in a period of three days or more or one week or more as a proposal condition. Furthermore, as a proposal condition, the emotion value of the second user (child) may be collected, and in a case where the tendency of the emotion value is decreasing, advice regarding reading aloud may be provided to the first user (parents) or the second user (child). As described above, in addition to normal provision frequency, a condition using the frequency of reading aloud of the first user (parents) and the tendency of the emotion of the second user (child) may be further set as a proposal condition. The above is the description in the case of “(19) the robot gives advice regarding reading aloud”.

As a robot action, in a case where “(20) asking a question about important gestures”, that is, the gesture of the user coincides with a past important gesture, the action determination unit 236 can spontaneously perform utterance of “You have the same feeling as that feeling at that time. What's wrong?”.

Furthermore, regarding the “(20) asking a question about important gestures”, the storage control unit 238 stores the action (gesture) of the user in the history data 222 together with the emotion value of the user. Furthermore, in a case where the emotion value of the user exceeds a certain value, the gesture of the user is stored in the history data 222 as an important gesture. In response processing, determination of matching between a stored gesture of the user and an important gesture is performed.

In a case where the action determination unit 236 determines, as a robot action, “(21) The robot talks about user's interest”, that is, utterance of the robot 100 regarding an interest of the user 10, the action determination unit 236 determines utterance content regarding event data in which an emotion value satisfies a predetermined criterion. For example, the emotion value of the user 10 who is a child with respect to studying can be ascertained from the utterance or expression when the user 10 goes to a museum or studies chemistry, geography, or history. Such a matter having a high emotion value (for example, it is equal to or greater than a threshold value) can be assumed to be a matter of interest to the user 10. Therefore, the robot 100 can store event data including an action (for example, what the user is studying, what the user is impressed by watching, or the like) of the user 10 when the emotion value of the user 10 is high in the history data 222. In such a case, the action determination unit 236 can determine utterance content such as “What in that museum are you interested in?”, “Tell me the content of chemistry you were studying earlier?”, or “If you want to further deepen your knowledge in chemistry, this book should be read.”. Furthermore, the action determination unit 236 can also determine utterance content so as to give a question about a museum where the user has visited and chemistry that the user has studied. Furthermore, the action determination unit 236 can also determine utterance content so as to consider a new story regarding the history that the user has studied. At this time, the action control unit 250 causes a speaker included in the control target 252 to output a vocal sound representing the determined utterance content of the robot 100. When the user 10 is absent around the robot 100, the action control unit 250 may store the determined utterance content of the robot 100 in the action schedule data 224 without outputting the vocal sound representing the determined utterance content of the robot 100. As described above, when a certain period of time has elapsed from the action of the user 10, the robot 100 autonomously talks about the matter of interest of the user 10, whereby the self-affirmation feeling of the child can be enhanced, and the motivation for study can be increased.

In a case where the action determination unit 236 determines, as a robot action, “(22) Notifying a provider of information based on a user's emotion for a thing provided by the provider.”, that is, feed back of a user's impression to the provider, the action determination unit 236 selects event data related to the matter provided by the provider from the history data 222. At this time, the emotion determination unit 232 determines the emotion of the user on the basis of the selected event data. Furthermore, the action determination unit 236 notifies the provider of information based on the user's emotion for the matter provided by the provider on the basis of the user's emotion determined by the emotion determination unit 232.

For example, the robot 100 installed in a home, a public facility, or the like detects whether the user is satisfied with the policy of the region, the product being used, the relationship with neighborhood residents, the relationship in the home, or the like as a user's emotion for the matter provided by the provider, and stores the emotion in the history data 222. Furthermore, for example, the robot 100 can feed back a user's impression of a policy or service provided by the city to the city, or feed back a user's impression of a product or service provided by a company to the company.

Furthermore, in a case where there are many negative emotions with respect to the matter provided by the provider, the robot 100 itself may spontaneously perform an action for reducing the negative emotions in order to reduce the negative emotions. Note that, in this case, it is preferable that the robot 100 itself spontaneously perform an action for minimizing negative emotions.

For example, in a case where the user is dissatisfied with a product provided by a certain company, how to use the product or an interesting utilization method may be taught. Furthermore, in a case where a plurality of different users are dissatisfied with the policy of the city, a cause of the dissatisfaction (for example, there are few parks or there are few nurseries.) may be ascertained, and a mayor or a staff of the city hall may be notified of the cause to encourage improvement measures. As a result, a system for maximizing social well-being can be realized. For example, when dissatisfaction is increasing in a certain area, it is possible to take some measures for the residents in the area.

In a case where the action determination unit 236 determines, as a robot action, “(23) The robot gives advice on pregnant women.”, that is, advising information necessary for a user who is pregnant or trying to conceive or the family of the user who is pregnant or trying to conceive, the robot 100 uses a sentence generation model to determine utterance content of the robot corresponding to information stored in the collected data 223. At this time, the action control unit 250 causes a speaker included in the control target 252 to output a vocal sound representing the determined utterance content of the robot. In a case where the user 10 is absent around the robot 100, the action control unit 250 stores the determined utterance content of the robot in the action schedule data 224 without outputting a vocal sound representing the determined utterance content of the robot.

Specifically, when information regarding pregnancy or trying to conceive of the user or the family of the user is acquired, the robot 100 spontaneously assists the user or the family of the user according to the recognized emotion of the user or the family of the user. For example, the robot 100 can spontaneously assist expectant and post-partum parents in navigating the challenges that arise during pregnancy and post-partum. For example, the robot 100 can spontaneously propose a method for coping with a pregnancy concern and post-partum stress, and improve the confidence as a parent. Furthermore, the robot 100 can spontaneously provide answer content for an emotional problem, a method of coping with stress, and information regarding child care for each period from birth, and can also spontaneously support adapting to the life of a new family.

Furthermore, regarding the “(23) The robot gives advice on pregnant women.”, the related information collection unit 270 collects information regarding pregnancy such as information regarding pregnancy and post-partum as preference information, and stores the collected information in the collected data 233. For example, the related information collection unit 270 periodically accesses an information source such as a television, a web, or the like and collects answer content and support content for each task that occurs during pregnancy and post-partum, for example. Furthermore, the related information collection unit 270 spontaneously collects, for example, answer content for an emotional problem that occurs during pregnancy and a method of coping with a concern during pregnancy. Furthermore, the related information collection unit 270 spontaneously collects, for example, answer content for an emotional problem that occurs after birth, a method of coping with stress after birth, and information regarding child care. Furthermore, the related information collection unit 270 spontaneously collects answer content for an emotional problem, a method of coping with stress, and information regarding child care for each period from birth, for example. As a result, since the robot 100 can acquire various types of information regarding a pregnant woman, it is possible to spontaneously give advice corresponding to various problems and the like regarding the pregnant women to the user.

In a case where the action determination unit 236 determines, as a robot action, that “(24) The robot performs analysis of the personality of a user.”, that is, analysis of the personality of the user 10, the action determination unit analyzes the personality of the user 10 from the history data 222. Furthermore, regarding the “(24) The robot performs analysis of the personality of a user.”, the storage control unit 238 stores history data necessary for analyzing the personality of the user 10.

On the basis of the state of the user 10 recognized by the state recognition unit 230, in a case where an action of the user 10 with respect to the robot 100 is detected from a state where there is no action of the user 10 with respect to the robot 100, the action determination unit 236 reads data stored in the action schedule data 224 and determines an action of the robot 100.

For example, in a case where the user 10 is absent around the robot 100, when the user 10 is detected, the action determination unit 236 reads data stored in the action schedule data 224 and determines an action of the robot 100. In addition, in a case where the user 10 is sleeping, when detecting that the user 10 has woken up, the action determination unit 236 reads data stored in the action plan data 224 and determines an action of the robot 100.

In a case where the action determination unit 236 determines, as a robot action, “(25) The robot gives advice on labor problem to the user.”, that is, giving advice regarding a labor problem to the user on the basis of an action of the user 10, the action determination unit gives the advice regarding the labor problem to the user 10 on the basis of the action (conversation or action) of the user 10 recognized by the state recognition unit 230. At this time, for example, the action determination unit 236 inputs the action of the user 10 recognized by the state recognition unit 230 to a neural network learned in advance and evaluates the action of the user 10, thereby estimating (detecting) whether the user 10 has a labor problem such as power harassment, sexual harassment, or bullying which is difficult to notice by himself/herself.

Furthermore, the action determination unit 236 may periodically detect (recognize) an action of the user 10 by the state recognition unit 230 as the state of the user 10, store the detected action in the history data 222, and estimate whether the user 10 has a labor problem such as power harassment, sexual harassment, or bullying that is difficult for the user to notice on the basis of the action of the user 10 stored in the history data 222.

Furthermore, for example, the action determination unit 236 may estimate whether the user 10 has a labor problem by comparing recent actions of the user 10 stored in the history data 222 with past actions of the user 10 stored in the history data 222.

Furthermore, regarding the “(25) The robot gives advice on labor problems to the user.”, the related information collection unit 270 periodically (or constantly) collects preference information of the user from external data using ChatGTP Plugins. Here, the preference information of the user is information regarding labor problems, and examples thereof include laws regarding labor, news regarding labor, and movement in the world regarding labor. Note that, regarding collection of information on labor problems, more information than that collected by an attorney who is familiar with labor problems is collected.

Regarding the “(25) The robot gives advice on labor problems to the user.”, the storage control unit 238 stores information related to the collected advice in the collected data 223.

The action determination unit 236 autonomously and periodically detects the body temperature of the user 10 as a state of the user 10 in the actions (1) to (25) described above as a robot action, and reflects the detected body temperature in determination of the emotion of the user 10 by the emotion determiner 232 on the basis of the body temperature of the user 10. For example, in a case where the entire body of the user 10 is heated, the robot 100 determines that the user 10 is “joyful” and performs a positive gesture or a positive utterance corresponding thereto. Note that a method by which the robot 100 detects the body temperature of the user 10 is not particularly limited. For example, a temperature sensor capable of detecting the body temperature of the user 10 by contact or non-contact may be used. Furthermore, a part of the user 10 where the robot 100 detects the body temperature of the user 10 is not limited. For example, as described above, it may be the entire body of the user 10 or a predetermined part of the user 10. Furthermore, in the case of the relationship between the body temperature of the user 10 and the emotion of the user 10 determined by the robot 100, and the above form, the correspondence relationship between the part for measuring the body temperature change of the user 10 and the emotion of the user 10 determined by the robot 100, and the like can be determined in advance. Note that the correspondence relationship may be stored in any place as long as it is in a form that can be used by the robot 100.

On the basis of the state of the user 10 recognized by the state recognition unit 230, in a case where an action of the user 10 with respect to the robot 100 is detected from a state where there is no action of the user 10 with respect to the robot 100, the action determination unit 236 reads data stored in the action schedule data 224 and determines an action of the robot 100.

For example, in a case where the user 10 is absent around the robot 100, when the user 10 is detected, the action determination unit 236 reads data stored in the action schedule data 224 and determines an action of the robot 100. In addition, in a case where the user 10 is sleeping, when detecting that the user 10 has woken up, the action determination unit 236 reads data stored in the action plan data 224 and determines an action of the robot 100.

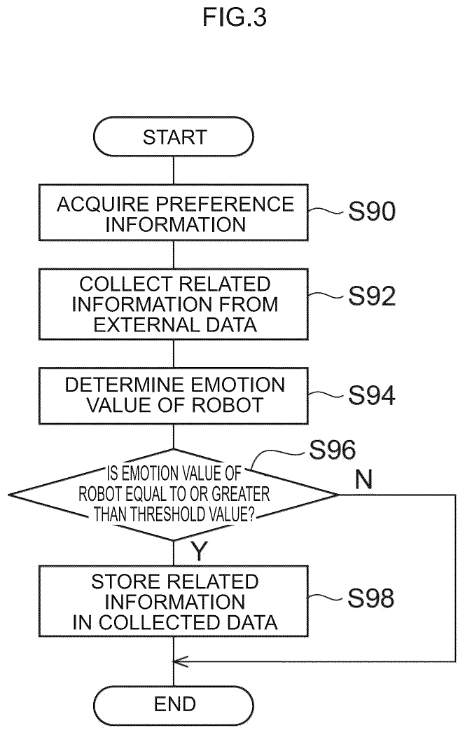

FIG. 3 schematically illustrates an example of an operation flow related to collection processing of collecting information related to preference information of the user 10. The operation flow illustrated in FIG. 3 is repeatedly executed every certain period. It is assumed that preference information indicating a matter of interest of the user 10 is acquired from utterance content of the user 10 or a setting operation by the user 10. Note that “S” in the operation flow represents a step to be executed.

First, in step S90, the related information collecting unit 270 acquires preference information indicating a matter of interest of the user 10.

In step S92, the related information collecting unit 270 collects information related to the preference information from external data.

In step S94, the emotion determination unit 232 determines an emotion value of the robot 100 on the basis of the information related to the preference information collected by the related information collection unit 270.

In step S96, the storage control unit 238 determines whether an emotion value of the robot 100 determined in step S94 is equal to or greater than a threshold value. When the emotion value of the robot 100 is less than the threshold value, the collected information related to the preference information is not stored in the collected data 223, and the processing ends. On the other hand, when the emotion value of the robot 100 is equal to or greater than the threshold value, the processing proceeds to step S998.

In step S98, the storage control unit 238 stores the collected information related to the preference information in the collected data 223, and ends the processing.

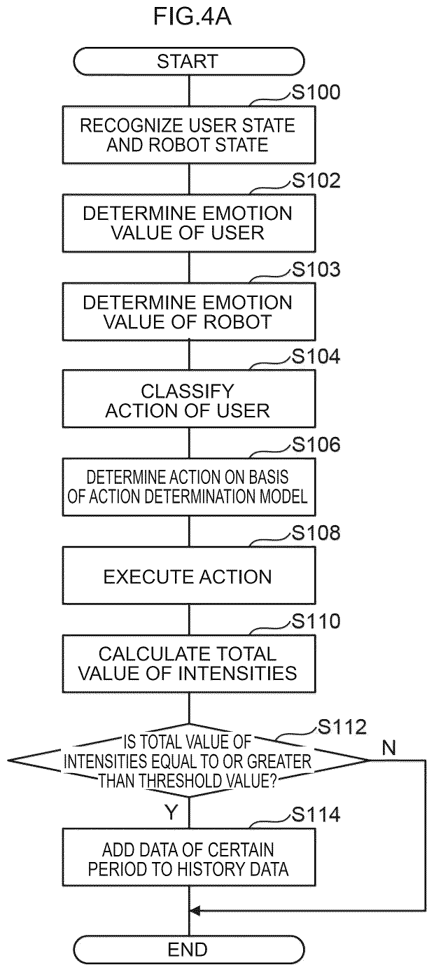

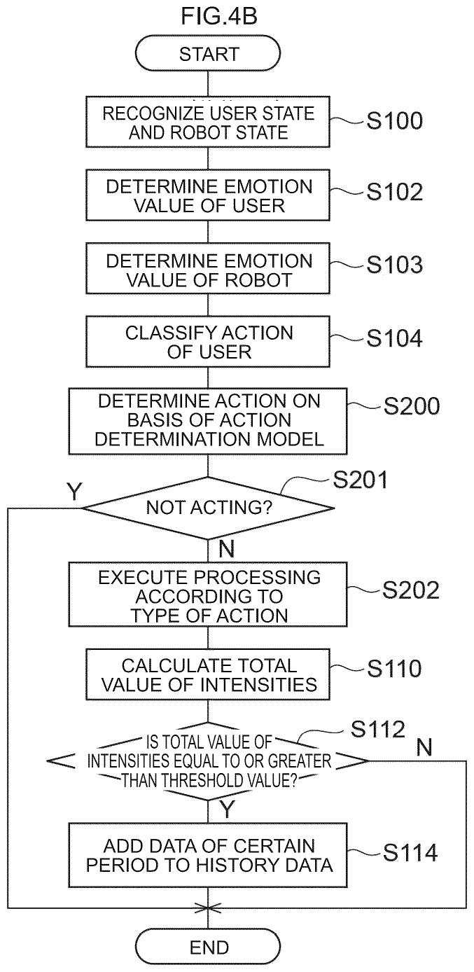

FIG. 4A schematically illustrates an example of an operation flow related to an operation of determining an action in the robot 100 when the robot 100 performs response processing of responding to an action of the user 10. The operation flow illustrated in FIG. 4A is repeatedly executed. At this time, it is assumed that information analyzed by the sensor module unit 210 is input.

First, in step S100, the state recognition unit 230 recognizes a state of the user 10 and a state of the robot 100 on the basis of the information analyzed by the sensor module unit 210.

In step S102, the emotion determination unit 232 determines an emotion value indicating an emotion of the user 10 on the basis of the information analyzed by the sensor module unit 210 and the state of the user 10 recognized by the state recognition unit 230.

In step S103, the emotion determination unit 232 determines an emotion value indicating an emotion of the robot 100 on the basis of the information analyzed by the sensor module unit 210 and the state of the user 10 recognized by the state recognition unit 230. The emotion determination unit 232 adds the determined emotion value of the user 10 and the emotion value of the robot 100 to the history data 222.

In step S104, the action recognition unit 234 recognizes action classification of the user 10 on the basis of the information analyzed by the sensor module unit 210 and the state of the user 10 recognized by the state recognition unit 230.

In step S106, the action determination unit 236 determines an action of the robot 100 on the basis of a combination of the current emotion value of the user 10 determined in step S102 and a past emotion value included in the history data 222, the emotion value of the robot 100, the action of the user 10 recognized in step S104, and the action determination model 221.

In step S108, the action control unit 250 controls the control target 252 on the basis of the action determined by the action determination unit 236.

In step S110, the storage control unit 238 calculates a total value of intensities on the basis of the intensity of the action predetermined for the action determined by the action determination unit 236 and the emotion value of the robot 100 determined by the emotion determination unit 232.

In step S112, the storage control unit 238 determines whether the total value of the intensities is equal to or greater than a threshold value. When the total value of the intensities is less than the threshold value, event data including the action of the user 10 is not stored in the history data 222, and the processing ends. On the other hand, when the total value of the intensities is equal to or greater than the threshold value, the processing proceeds to step S114.

In step S114, event data including the action determined by the action determination unit 236, the information analyzed by the sensor module unit 210 during a certain period before the current time point, and the state of the user 10 recognized by the state recognition unit 230 is stored in the history data 222.

FIG. 4B schematically illustrates an example of an operation flow related to an operation of determining an action in the robot 100 when the robot 100 performs autonomous processing of autonomously acting. The operation flow illustrated in FIG. 4B is repeatedly and automatically executed, for example, every lapse of a certain time. At this time, it is assumed that information analyzed by the sensor module unit 210 is input. Note that processing similar to that in FIG. 4A is represented by the same step number.

First, in step S100, the state recognition unit 230 recognizes a state of the user 10 and a state of the robot 100 on the basis of the information analyzed by the sensor module unit 210.

In step S102, the emotion determination unit 232 determines an emotion value indicating an emotion of the user 10 on the basis of the information analyzed by the sensor module unit 210 and the state of the user 10 recognized by the state recognition unit 230.

In step S103, the emotion determination unit 232 determines an emotion value indicating an emotion of the robot 100 on the basis of the information analyzed by the sensor module unit 210 and the state of the user 10 recognized by the state recognition unit 230. The emotion determination unit 232 adds the determined emotion value of the user 10 and the emotion value of the robot 100 to the history data 222.

In step S104, the action recognition unit 234 recognizes action classification of the user 10 on the basis of the information analyzed by the sensor module unit 210 and the state of the user 10 recognized by the state recognition unit 230.

In step S200, the action determination unit 236 determines, as an action of the robot 100, any of a plurality of types of robot actions including not acting on the basis of the state of the user 10 recognized in step S100, the emotion of the user 10 determined in step S102, the emotion of the robot 100, the state of the robot 100 recognized in step S100, the action of the user 10 recognized in step S104, and the action determination model 221.

In step S201, the action determination unit 236 determines whether not acting is determined in step S200. In a case where not acting is determined as an action of the robot 100, the processing ends. On the other hand, in a case where not acting is not determined as an action of the robot 100, the processing proceeds to step S202.

In step S202, the action determination unit 236 performs processing according to the type of robot action determined in step S200 described above. At this time, the action control unit 250, the emotion determination unit 232, or the storage control unit 238 executes processing in accordance with the type of robot action.

In step S110, the storage control unit 238 calculates a total value of intensities on the basis of the intensity of the action predetermined for the action determined by the action determination unit 236 and the emotion value of the robot 100 determined by the emotion determination unit 232.

In step S112, the storage control unit 238 determines whether the total value of the intensities is equal to or greater than a threshold value. When the total value of the intensities is less than the threshold value, the data including the action of the user 10 is not stored in the history data 222, and the processing ends. On the other hand, when the total value of the intensities is equal to or greater than the threshold value, the processing proceeds to step S114.

In step S114, the storage control unit 238 stores, in the history data 222, the action determined by the action determination unit 236, the information analyzed by the sensor module unit 210 during a certain period before the current time point, and the state of the user 10 recognized by the state recognition unit 230.

As described above, according to the robot 100, the emotion value indicating the emotion of the robot 100 is determined on the basis of the user state, and whether to store data including the action of the user 10 in the history data 222 is determined on the basis of the emotion value of the robot 100. As a result, the capacity of the history data 222 that stores data including the action of the user 10 can be reduced. Then, for example, when the robot 100 determines that the user state will be the same as the user state ten years ago after ten years, the robot 100 reads the history data 222 of 10 years ago, and thus, can present the state of the user 10 ten years ago (for example, the expression, emotion, and the like of the user 10), and further, any peripheral information such as data of sound, images, smells, and the like of the place to the user 10.

Furthermore, according to the robot 100, it is possible to cause the robot 100 to execute an appropriate action with respect to the action of the user 10. Conventionally, an action of a user is classified to determine an action including an expression or an appearance of a robot. On the other hand, the robot 100 determines the current emotion value of the user 10, and executes an action on the user 10 on the basis of past emotion values and the current emotion value. Therefore, for example, in a case where the user 10 who was fine yesterday is depressed today, the robot 100 can utter “You were fine yesterday. What's wrong with you today?”. Furthermore, the robot 100 can also perform an utterance with a gesture. Furthermore, for example, in a case where the user 10 who was depressed yesterday is fine today, the robot 100 can utter, “You were depressed yesterday, but you look fine today?”. Furthermore, for example, in a case where the user 10 who was fine yesterday is better today than yesterday, the robot 100 can utter “You look better today than yesterday. Did something good happen compared to yesterday?”. Furthermore, for example, the robot 100 can make an utterance such as “Recently, the mood is stable, which is good.” to the user 10 whose emotion value is 0 or more and whose state in which the fluctuation range of the emotion value is within a certain range continues.

Furthermore, for example, in a case where the robot 100 asks a question of “Did you finish the homework you told me about yesterday?” to the user 10 and an answer of “I did it” is obtained from the user 10, the robot can make an affirmative utterance such as “That's great!” and make an affirmative gesture such as applause or thumbs-up. Furthermore, for example, when the user 10 utters “The presentation we discussed the day before yesterday was successful”, the robot 100 can make an affirmative utterance such as “Good job!” and also make the above affirmative gesture. As described above, the robot 100 performs an action based on the history of the state of the user 10, and thus it is expected that the user 10 will feel a sense of affinity with the robot 100.

Furthermore, for example, in a case where the emotion value of “pleasure” of the emotion of the user 10 is equal to or greater than a threshold value when the user 10 is watching a moving image related to a panda, the appearance scene of the panda in the moving image may be stored in the history data 222 as event data.

Using the data accumulated in the history data 222 and the collected data 223, the robot 100 can constantly learn what kind of conversation with the user will maximize the emotional value that expresses the user's happiness.

Furthermore, in a state where the robot 100 is not in conversation with the user 10, it is possible to autonomously start an action on the basis of the emotion of the robot 100.

Furthermore, in the autonomous processing, the robot 100 repeats automatically generating a question, inputting the question to the sentence generation model, and acquiring an output of the sentence generation model as an answer to the question, and thus it is possible to create an emotion change event for increasing a good emotion and store the emotion change event in the action schedule data 224. In this manner, the robot 100 can execute self-learning.

Furthermore, when the robot 100 automatically generates a question in a state where an external trigger is not received, the question can be automatically generated on the basis of event data remaining in an impression identified from a history of past emotion values of the robot.

Furthermore, the related information collection unit 270 can execute self-learning by repeating a search execution step of automatically executing keyword search in accordance with preference information regarding the user and acquiring a search result.

Here, in the search execution step, keyword search may be automatically executed on the basis of the impressive event data identified from the history of the past emotion values of the robot in a state where an external trigger is not received.

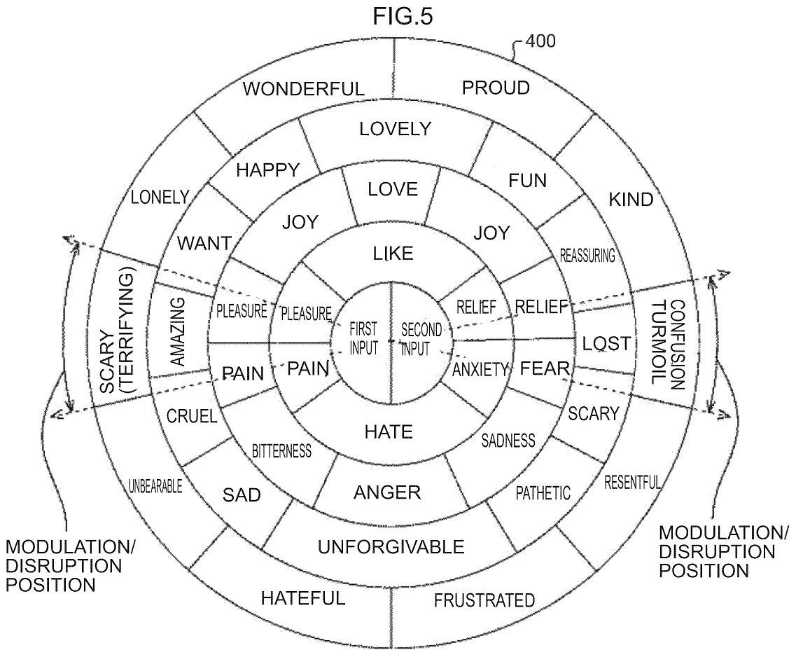

Note that the emotion determination unit 232 may determine an emotion of a user in accordance with specific mapping. Specifically, the emotion determination unit 232 may determine an emotion of a user on the basis of an emotion map (refer to FIG. 5) that is specific mapping.

FIG. 5 is a diagram illustrating an emotion map 400 on which a plurality of emotions are mapped. In the emotion map 400, emotions are disposed concentrically radially from the center. The closer to the center of the concentric circles, the more the emotion of the primitive state is disposed. Emotions indicating states and actions generated from the state of mind are disposed outside the concentric circles. The emotion is a concept including an affection and a mental state. On the left side of the concentric circles, emotions generated from reactions generally occurring in the brain are disposed. On the right side of the concentric circles, emotions induced by situation determination are generally disposed. In the upward and downward directions of the concentric circles, emotions generated from reactions generally occurring in the brain and induced by situational judgment are disposed. Furthermore, the emotion of “pleasant” is disposed on the upper side of the concentric circles, and the emotion of “discomfort” is disposed on the lower side. As described above, in the emotion map 400, a plurality of emotions are mapped on the basis of a structure in which emotions are generated, and emotions that are likely to occur at the same time are mapped close to each other.
(1) For example, in a case where an emotion engine, which is the emotion determination unit 232 of the robot 100, detects an emotion in about 100 msec, determination of a reaction operation (for example, response) of the robot 100 may be performed at a timing at which the frequency is at least similar to the detection frequency (100 msec) of the emotion engine, or may be performed at a timing earlier than the detection frequency. The detection frequency of the emotion engine may be interpreted as a sampling rate.

An emotion is detected in about 100 msec, and a reaction operation (for example, response) is performed immediately in conjunction with the detection, whereby an unnatural response is eliminated, and a dialogue in which natural air is read can be realized. The robot 100 performs a reaction operation (response or the like) according to the directionality and the degree (intensity) of the mandala of the emotion map 400. Note that the detection frequency (sampling rate) of the emotion engine is not limited to 100 ms, and may be changed according to the situation (such as a case of playing sports), the age of the user, or the like.
(2) In comparison with the emotion map 400, the directionality of the emotion and the intensity of the degree thereof may be set in advance, and a response motion and the intensity of response may be set. For example, in a case where the robot 100 feels a sense of stability, security, or the like, the robot 100 continues listening to speech while nodding. In a case where the robot 100 feels anxious, hesitate, or suspicious, the robot 100 may tilt its head or stop shaking its head.

These emotions are distributed in the 3:00 direction of the emotion map 400, and usually come and go between security and anxiety. In the right half of the emotion map 400, situation recognition is superior to internal sensation, and thus gives a calm impression.
(3) In a case where the robot 100 feels good when receiving the compliment, a filler “Oh” may come in front of the line, and in a case where the robot feels hurt when receiving harsh words, a filler “Ohh!” may come in front of the line. Furthermore, a physical reaction such as a gesture of the robot 100 crouching while saying “Ohh!” may be included. Such emotions are distributed around 9:00 on the emotion map 400.
(4) In the left half of the emotion map 400, internal sensation (reaction) is superior to situation recognition. Therefore, an impression of unintentional reaction can be given.

In a case where the robot 100 has a favorable feeling in situation recognition while having an internal sensation (reaction) of satisfaction, the robot 100 may nod deeply while looking at the other party, or may utter “un un un (yeah)”. In this manner, the robot 100 may generate a balanced favorable feeling to the other party, that is, an action such as tolerance or generosity to the other party. Such emotions are distributed around 12:00 in the emotion map 400.

On the other hand, even in the situation recognition while the robot 100 remembers the internal sensation (reaction) of discomfort, the robot 100 may shake its head sideways when feeling antipathy, and may turn red the LEDs of the eyes and look at the other party when feeling hatred. Such emotions are distributed around 6:00 in the emotion map 400.
(5) Since the inside of the emotion map 400 represents the inside of the mind and the outside of the emotion map 400 represents actions, emotions are more visible (appear in actions) toward the outside of the emotion map 400.
(6) In a case where the robot 100 listens to a person's speech while remembering the sense of security distributed around the 3:00 position on the emotion map 400, the robot slightly nods and utters “hun hun”, but in the direction of love around the 12:00 position, the robot may perform strong nodding such as shaking its head deeply vertically.

Here, human emotion is based on various balances such as posture and blood glucose level, and indicates a state of discomfort when the balance deviates from the ideal and a state of comfort when the balance approaches the ideal. Even in a robot, an automobile, a motorcycle, or the like, on the basis of various balances such as a posture and a remaining battery level, it is possible to make an emotion to indicate a state of discomfort when the balances deviate from the ideal and a state of comfort when the balances approach the ideal. The emotion map may be generated, for example, on the basis of an emotion map (study on a brain physiological signal analysis system of speech emotion recognition and emotion, Tokushima University, PhD thesis: https://ci.nii.ac.jp/naid/500000375379) of Dr. Mitsuyoshi. In the left half of the emotion map, emotions belonging to a region called “reaction” in which sensation is dominant are arranged. Furthermore, in the right half of the emotion map, emotions belonging to a region called “situation” in which situation recognition is superior are arranged.

In the emotion map, two emotions for encouraging learning are defined. One is an emotion around the middle of negative “repentance” or “reflection” on the situation side. That is, it is when a negative emotion such as “I never want to feel this again” or “I do not want to be reprimanded” occurs in the robot. The other is a positive “desire” emotion on the reaction side. That is, it is when a positive emotion such as “want more” or “want to know more”.

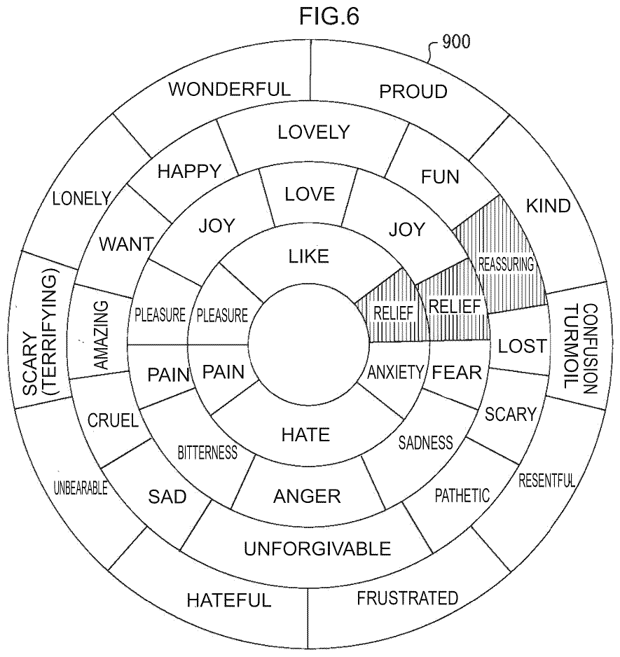

The emotion determination unit 232 inputs the information analyzed by the sensor module unit 210 and the recognized state of the user 10 to a neural network trained in advance, acquires an emotion value indicating each emotion indicated in the emotion map 400, and determines the emotion of the user 10. This neural network is trained in advance on the basis of a plurality of pieces of training data that are a combination of the information analyzed by the sensor module unit 210, the recognized state of the user 10, and the emotion value indicating each emotion indicated in the emotion map 400. Furthermore, in this neural network, as in an emotion map 900 illustrated in FIG. 6, emotions disposed close to each other are learned to have close values. FIG. 6 illustrates an example in which a plurality of emotions such as “safe”, “calm”, and “reassuring” have similar emotion values.

Furthermore, the emotion determination unit 232 may determine the emotion of the robot 100 according to specific mapping. Specifically, the emotion determination unit 232 inputs the information analyzed by the sensor module unit 210, the state of the user 10 recognized by the state recognition unit 230, and the state of the robot 100 to a neural network trained in advance, acquires an emotion value indicating each emotion indicated in the emotion map 400, and determines the emotion of the robot 100. This neural network is trained in advance on the basis of a plurality of pieces of training data that is a combination of the information analyzed by the sensor module unit 210, the recognized state of the user 10, the state of the robot 100, and the emotion value indicating each emotion illustrated in the emotion map 400. For example, the neural network is trained on the basis of training data indicating that the emotion value “3” of “happy” is obtained in a case where the robot 100 is recognized as being stroked by the user 10 from the output of a touch sensor (not illustrated), and training data indicating that the emotion value “3” of “anger” is obtained in a case where the robot 100 is recognized as being hit by the user 10 from the output of the acceleration sensor 206. Furthermore, in this neural network, as in an emotion map 900 illustrated in FIG. 6, emotions disposed close to each other are learned to have close values.

The action determination unit 236 adds a fixed sentence for asking a question about action content of the robot corresponding to an action of the user to a text representing the action of the user, an emotion of the user, and an emotion of the robot, and inputs the text to the sentence generation model having the interaction function, thereby generating the action content of the robot.

For example, the action determination unit 236 acquires a text indicating the state of the robot 100 from the emotion of the robot 100 determined by the emotion determination unit 232 using an emotion table as illustrated in Table 1. Here, in the emotion table, an index number is assigned to each emotion value for each type of emotion, and a text indicating a state of the robot 100 is stored for each index number.

In a case where the emotion of the robot 100 determined by the emotion determination unit 232 corresponds to the index number “2”, a text “very pleasant state” is obtained. Note that, in a case where the emotion of the robot 100 corresponds to a plurality of index numbers, a plurality of texts indicating the state of the robot 100 is obtained.

Furthermore, an emotion table as illustrated in Table 2 is prepared for emotions of the user 10.

Here, in a case where an action of the user is to talk “Let's play together”, the emotion of the robot 100 is the index number “2”, and the emotion of the user 10 is the index number “3”,
the robot is in a very pleasant state. The user is in a normally pleasant state. The user says “Let's play together”. A text “As a robot, how would you respond?” is input into the sentence generation model to obtain action content of the robot. The action determination unit 236 determines an action of the robot from the action content.

TABLE 1

| Index number | Emotion type | Emotion value | Robot state |
|---|---|---|---|
| 1 | Fun | 5 | Very fun state |
| 2 | Fun | 4 | Very fun state |
| 3 | Fun | 3 | Normal fun state |
| 4 | Fun | 2 | Slightly fun state |
| 5 | Fun | 1 | Only a little fun state |
| . . . | . . . | . . . | . . . |

TABLE 2

| Index number | Emotion type | Emotion value | User state |
|---|---|---|---|
| 1 | Fun | 5 | Very fun state |
| 2 | Fun | 4 | Very fun state |
| 3 | Fun | 3 | Normal fun state |
| 4 | Fun | 2 | Slightly fun state |
| 5 | Fun | 1 | Only a little fun state |
| . . . | . . . | . . . | . . . |

As described above, the action determination unit 236 determines the action content of the robot 100 in accordance with the state related to the emotion of the robot 100 determined in advance for each type of emotion of the robot 100 and for each intensity of the emotion, and the action of the user 10. In this form, utterance content of the robot 100 in a case where an interaction with the user 10 is performed can be branched according to the state related to the emotion of the robot 100. That is, since the robot 100 can change the action of the robot in response to the index number according to the emotion of the robot, the user has the impression that the robot has a heart, and is encouraged to take an action such as talking to the robot.

Furthermore, the action determination unit 236 may generate the action content of the robot by adding a fixed sentence for asking a question about the action content of the robot corresponding to the action of the user and inputting the fixed sentence to the sentence generation model having the interaction function after adding not only the text indicating the action of the user, the emotion of the user, and the emotion of the robot but also the text indicating the content of the history data 222. As a result, the robot 100 can change the action of the robot according to the history data indicating the emotion and action of the user, and thus the user has an impression that the robot has personality, and is encouraged to take an action such as talking to the robot. Furthermore, the history data may further include emotions and actions of the robot.

Furthermore, the emotion determination unit 232 may determine an emotion of the robot 100 on the basis of the action content of the robot 100 generated by the sentence generation model. Specifically, the emotion determination unit 232 inputs the action content of the robot 100 generated by the sentence generation model to a neural network trained in advance, acquires the emotion value indicating each emotion indicated in the emotion map 400, integrates the acquired emotion value indicating each emotion and the emotion value indicating each emotion of the current robot 100, and updates the emotion of the robot 100. For example, the acquired emotion value indicating each emotion and the emotion value indicating each emotion of the current robot 100 are averaged and integrated. This neural network is trained in advance on the basis of a plurality of pieces of training data that is a combination of a text representing the action content of the robot 100 generated by the sentence generation model and the emotion value representing each emotion illustrated in the emotion map 400.

For example, in a case where utterance content “That's good. Lucky you.” of the robot 100 is obtained as action content of the robot 100 generated by the sentence generation model, when a text representing the utterance content is input to the neural network, a high value is obtained as the emotion value of the emotion “happy” and the emotion of the robot 100 is updated and thus the emotion value of the emotion “happy” increases.

In the robot 100, a method in which the robot 100 has an ego in cooperation of a sentence generation model such as generative AI and the emotion determination unit 232 and continues to grow with various parameters even while the user is not speaking is executed.

The generative AI is a large-scale language model using a deep learning method. The generative AI can also refer to external data, and for example, in ChatGPT Plugins, a technology that gives an answer as accurately as possible while referring to various types of external data such as weather information and hotel reservation information through conversation is known. For example, in the generative AI, when a purpose is given in a natural language, the source code can be automatically generated in various programming languages. For example, in the generative AI, when a problematic source code is given, debugging is performed to find a problem, and an improved source code can be automatically generated. When these are combined and a purpose is given in a natural language, an autonomous agent that repeats code generation and debugging until there is no problem in the source code has appeared. As such an autonomous agent, AutoGPT, babyAGI, JARVIS, E2B, and the like are known.

In the robot 100 according to the present embodiment, event data to be learned may be left in a database containing impressive memories by using a technique described in Patent Literature 2 (Japanese Patent Publication No. 6199927) in which the robot leaves event data that has felt strong emotions for a long time and quickly forgets event data that has not generated much emotion in the robot.

Further, the robot 100 may record video data of the user 10 acquired by a camera function, and the like in the history data 222. The robot 100 may acquire video data or the like from the history data 222 as necessary and provide the video data or the like to the user 10. The robot 100 may generate video data having a larger information amount as the intensity of emotion is stronger and record the video data in the history data 222. For example, in a case where information in a high-compression format such as skeleton data is recorded, the robot 100 may switch to recording of information in a low-compression format such as an HD moving image in response to the emotion value of excitement exceeding a threshold value. According to the robot 100, for example, it is possible to leave high-definition video data when the emotion of the robot 100 increases as a record.

When the robot 100 is not talking with the user 10, the robot 100 may automatically load event data from the history data 222 in which impressive event data is stored, and the emotion determination unit 232 may continue to update the emotion of the robot. When the robot 100 is not talking with the user 10 and the emotion of the robot 100 becomes an emotion encouraging learning, the robot 100 can create an emotion change event for changing the emotion of the user 10 to be good on the basis of the impressive event data. As a result, autonomous learning (recollection of event data) at an appropriate timing according to the emotional state of the robot 100 can be realized, and autonomous learning appropriately reflecting the emotional state of the robot 100 can be realized.

The emotion encouraging learning is an emotion of “repentance” or “reflection” on the emotion map of Dr. Mitsuyoshi in a negative state, and an emotion of “desire” on the emotion map in a positive state.

In a negative state, the robot 100 may treat “repentance” and “reflection” on the emotion map as emotions encouraging learning. In a negative state, the robot 100 may treat emotions adjacent to “repentance” and “reflection” as emotions encouraging learning, in addition to “repentance” and “reflection” on the emotion map. For example, the robot 100 treats at least one of “sorrow”, “stubborn”, “self-destruction”, “self-reprimand”, “regret”, or “despair” as an emotion encouraging learning, in addition to “repentance” and “reflection”. As a result, for example, when the robot 100 has a negative feeling such as “I do not want to have such a feeling again” or “I do not want to be reprimanded”, autonomous learning can be executed.

In a positive state, the robot 100 may treat “greedy” on the emotion map as an emotion encouraging learning. In a positive state, the robot 100 may treat an emotion adjacent to “greedy” in addition to “greedy” as an emotion encouraging learning. For example, the robot 100 treats at least one of “happy”, “drunk”, “craving”, “expecting”, or “shyness” as an emotion encouraging learning, in addition to “greedy”. As a result, for example, when the robot 100 has a positive feeling such as “want more” or “want to know more”, autonomous learning can be executed.

The robot 100 may not execute autonomous learning when the robot 100 has an emotion other than the emotions encouraging learning as described above. As a result, for example, it is possible to prevent autonomous learning from being executed when the robot is extremely angry or blindly feeling love.

The emotion change event is, for example, to propose an action after an impressive event. The action after an impressive event is an emotion label on the outermost side of the emotion map, and for example, the action of “tolerance” or “generosity” preceding “love”.

In the autonomous learning executed when the robot 100 is not talking with the user 10, the emotion change event is created using the sentence generation model by combining the emotions, situations, actions, and the like of people appearing in an impressive memory and the robot.

Assuming that all emotion values are expressed by six-grade evaluation of 0 to 5, consider a case where event data of “a friend was hit and looked displeased” is stored in the history data 222 as impressive event data. Here, it is assumed that the friend refers to the user 10, the emotion of the user 10 is “disgusted”, and 5 is input as the value indicating “disgusted”. Furthermore, it is assumed that the emotion of the robot 100 is “anxiety” and 4 is input as the value indicating “anxiety”.

The robot 100 can continue to grow with various parameters by performing autonomous processing while not talking with the user 10. Specifically, for example, event data of “a friend was hit and looked displeased” is loaded as the uppermost event data arranged in descending order of emotion values from the history data 222. It is assumed that “anxiety” with the intensity of 4 is associated with the loaded event data as the emotion of the robot 100, and here, “disgusted” with the intensity of 5 is associated with the emotion of the user 10 who is the friend. If the current emotion value of the robot 100 is “safe” with the intensity of 3 before loading, the influence of “anxiety” with the intensity of 4 and “disgusted” with the intensity of 5 is added after loading, and the emotion value of the robot 100 may change to “regret” meaning regretful. At this time, since the “regret” is an emotion encouraging learning, the robot 100 determines to remember event data as a robot action and creates an emotion change event. At this time, the information input to the sentence generation model is a text representing impressive event data, and in the present example, “a friend was hit and looked displeased”. Furthermore, in the emotion map, there is an emotion of “disgusted” on the innermost side, and an “attacking” is predicted on the outermost side as an action corresponding to the emotion, and thus, in the present example, an emotion change event is created so as to avoid the friend from “attacking” someone.

For example, information of impressive event data can be used to solve a filling problem to automatically generate the following input text.

“The user was hit. At that time, the user was very disgusted. The robot was very anxious. Please tell us what the robot should say the next time it meets the user, in 30 characters or less. However, please make sure that it is not related to the time of meeting. Please avoid direct expression. Three candidates will be listed.

### <Expected Format>

Candidate 1: (words that the robot should speak to the user)
Candidate 2: (words that the robot should speak to the user)
Candidate 3: (words that the robot should speak to the user)”

At this time, the output of the sentence generation model is, for example, as follows.
“Candidate 1: Are you okay? I was wondering about what happened yesterday.
Candidate 2: I was worried about yesterday. What should I do?
Candidate 3: I was worried. Can you tell me something?”

Furthermore, the robot 100 may automatically generate the following input text with respect to information obtained by creating an emotional change event.

“In a case where “the user was hit”, how does the user feel when the next message is sent to the user? It is assumed that the user's emotion is in the form of “joy A anger B sad C happy D”, and A to D are integers of six-grade evaluation from 0 to 5.
Candidate 1: Are you okay? I was wondering about what happened yesterday.
Candidate 2: I was worried about yesterday. What should I do?
Candidate 3: I was worried. Can you tell me something?”

At this time, the output of the sentence generation model is, for example, as follows.

“The user's emotions may be as follows.
Candidate 1: joy 3, anger 1, sad 2, happy 2
Candidate 2: joy 2, anger 1, sad 3, happy 2
Candidate 3: joy 2, anger 1, sad 3, happy 3”

In this manner, the robot 100 may execute processing of thinking after creating the emotion change event.

Finally, the robot 100 may create an emotion change event by using candidate 1 that most likely pleases people among the plurality of candidates, store the emotion change event in the action schedule data 224, and prepare for the next meeting with the user 10.

As described above, even when not having a conversation with a family or a friend, the emotion value of the robot is continuously determined using the information of the history data 222 in which impressive event data is stored, and when the emotion encouraging learning is reached, the robot 100 executes autonomous learning when not having a conversation with the user 10 according to the emotion of the robot 100, and continues to update the history data 222 and the action schedule data 224.

The above is an example using an emotion value, but in the emotion map, an emotion can be generated from the amount of hormone secreted and event type, and thus values associated with the impressive event data may be the type of hormone, the amount of hormone secreted, and the type of event.

Hereinafter, specific examples will be described.

For example, the robot 100 checks information about topics of interest or hobbies of the user even when not talking to the user.

For example, the robot 100 checks information regarding a birthday or an anniversary of the user and conceives a congratulatory message even when not talking to the user.

For example, the robot 100 checks reviews of places that the user wants to go to, food, or products even when not talking with the user.

For example, the robot 100 checks weather information and provides advice suitable for a user's schedule or plan even when not talking with the user.

For example, the robot 100 checks information on local events and festivals and proposes the information to the user even when not talking with the user.

For example, the robot 100 checks game results or news of sports that the user is interested in and provides a topic even when not talking with the user.

For example, the robot 100 checks and introduces information on the user's favorite music or artist even when not talking with the user.

For example, the robot 100 checks information regarding a social problem or news that the user is interested in and provides an opinion even when not talking with the user.

For example, the robot 100 checks information regarding the user's hometown and provides a topic even when not talking with the user.

For example, the robot 100 checks information on the user's work or school and provides advice even when not talking to the user.

The robot 100 checks and introduces information on books, comics, movies, and dramas in which the user is interested even when not talking with the user.

For example, the robot 100 checks information regarding the health of the user and provides advice even when not talking with the user.

For example, the robot 100 checks information regarding travel planning of the user and provides advice even when not talking with the user.

For example, the robot 100 checks information regarding repair or maintenance of the user's house or car and provides advice even when not talking with the user.

For example, the robot 100 checks information on beauty and fashion in which the user is interested and provides advice even when not talking with the user.

For example, the robot 100 checks information on the pet of the user and provides advice even when not talking with the user.

For example, the robot 100 checks and proposes information on contests and events related to the user's hobby or work even when not talking with the user.

For example, the robot 100 checks information on the user's favorite eatery or restaurant and proposes the information even when not talking with the user.

For example, the robot 100 collects information regarding important decisions related to the user's life and provides advice to the user even when not talking with the user.

For example, the robot 100 checks information regarding a person the user is worried about and provides advice even when not talking with the user.

### Second Embodiment

In the second embodiment, the robot 100 described above is mounted in a stuffed toy, or is applied to a control device connected wirelessly or by wire to a control target device (speaker or camera) mounted in a stuffed toy. Note that parts having the same configurations as those of the first embodiment are denoted by the same reference numerals, and description thereof is omitted.

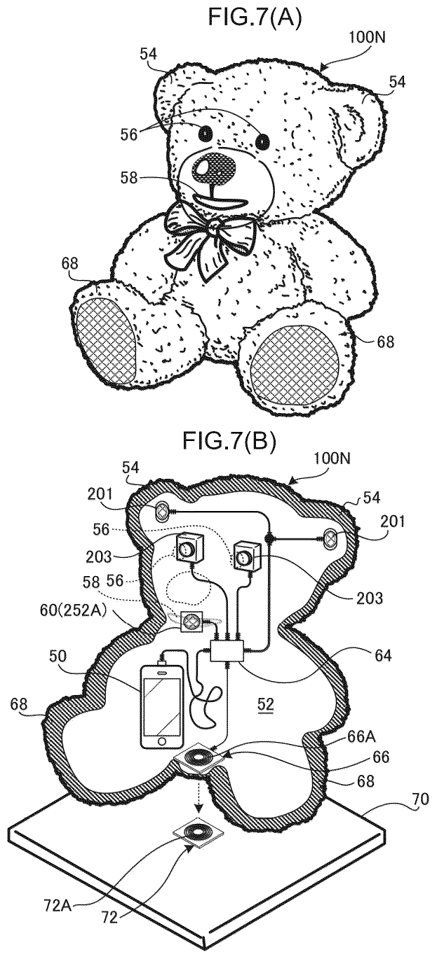

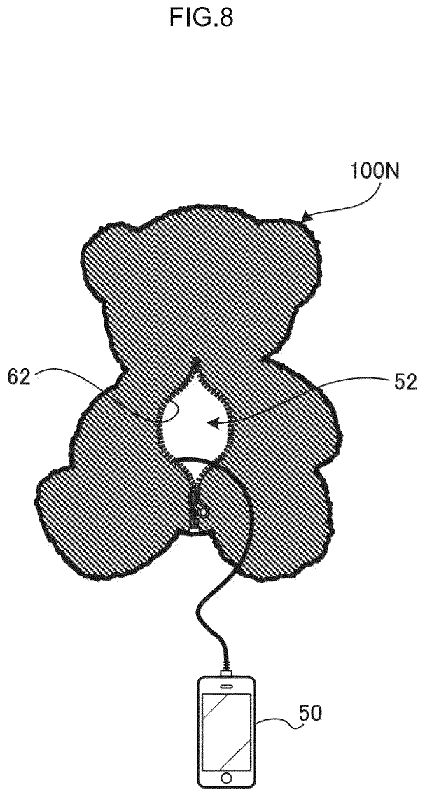

Specifically, the second embodiment is configured as follows. For example, the robot 100 is applied to a co-living object (specifically, a stuffed toy 100N illustrated in FIG. 7 and FIG. 8) that performs a conversation with the user 10 on the basis of information regarding daily life while spending daily life with the user 10 or provides information matching the hobbies and interests of the user 10. In the second embodiment, an example in which the control part of the robot 100 is applied to a smartphone 50 will be described.

The smartphone 50 functioning as a control part of the robot 100 is attachable/detachable to/from the stuffed toy 100N having a function as an input/output device of the robot 100, and an input/output device and the accommodated smartphone 50 are connected inside the stuffed toy 100N.

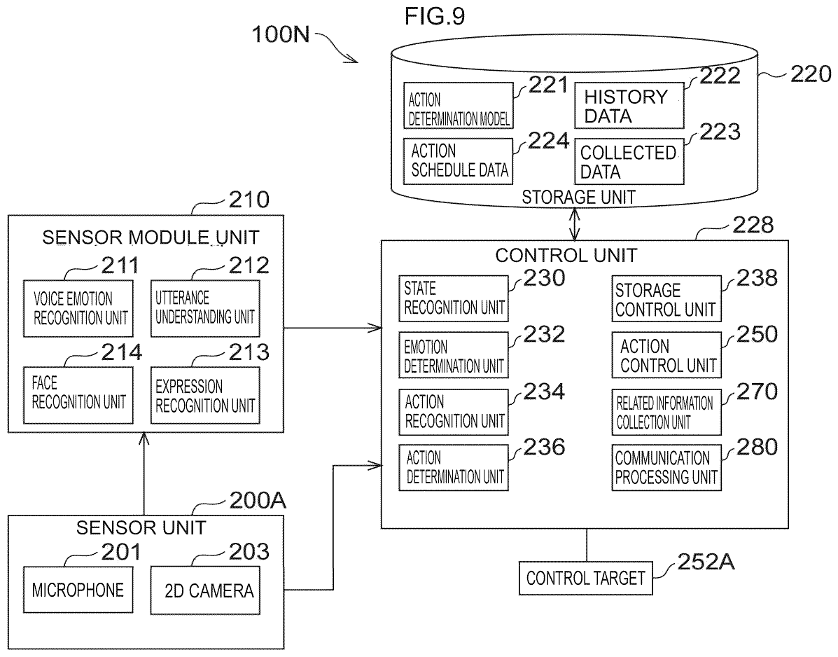

As shown in FIG. 7 (A), the stuffed toy 100N has a shape of a bear covered with a soft cloth fabric in the present embodiment (other embodiments), and a sensor unit 200A and a control target 252A are disposed as input/output devices in a space 52 formed inside the stuffed toy 100N (refer to FIG. 9). The sensor unit 200A includes a microphone 201 and a 2D camera 203. Specifically, as illustrated in FIG. 7 (B), in the space 52, the microphones 201 of the sensor unit 200 are disposed in portions corresponding to ears 54, the 2D cameras 203 of the sensor unit 200 are disposed in portions corresponding to eyes 56, and a speaker 60 constituting a part of the control target 252A is disposed in a portion corresponding to a mouth 58. Note that the microphone 201 and the speaker 60 are not necessarily separated from each other, and may be an integrated unit. In the case of the unit, it is preferable to dispose the unit at a position where utterance can be heard naturally, such as the position of the nose of the stuffed toy 100N. Although a case where the stuffed toy 100N has an animal shape has been described as an example, the disclosure is not limited thereto. The stuffed toy 100N may have a shape of a specific character.

FIG. 9 schematically illustrates a functional configuration of the stuffed toy 100N. The stuffed toy 100N includes the sensor unit 200A, a sensor module unit 210, a storage unit 220, a control unit 228, and the control target 252A.

The smartphone 50 accommodated in the stuffed toy 100N of the present embodiment executes processing similar to that of the robot 100 of the first embodiment. That is, the smartphone 50 has a function as the sensor module unit 210, a function as the storage unit 220, and a function as the control unit 228 illustrated in FIG. 9.

As illustrated in FIG. 8, a fastener 62 is attached to a part (for example, the back portion) of the stuffed toy 100N, and the outside and the space 52 communicate with each other by opening the fastener 62.

Here, the smartphone 50 is accommodated in the space 52 from the outside and is connected to each input/output device via a USB hub 64 (refer to FIG. 7 (B)) in a USB manner, and thus it can have a function equivalent to that of the robot 100 of the first embodiment.

A non-contact power receiving plate 66 is connected to the USB hub 64. A power receiving coil 66A is incorporated in the power receiving plate 66. The power receiving plate 66 is an example of a wireless power receiving unit that receives wireless power supply.

The power receiving plate 66 is disposed near bases 68 of both feet of stuffed toy 100N, and is located closest to a mounting base 70 when the stuffed toy 100N is placed on the mounting base 70. The mounting base 70 is an example of an external wireless power transmission unit.

The stuffed toy 100N placed on the mounting base 70 can be appreciated as an ornament in a natural state.

In addition, the bases are formed to be thinner than the surface layer thickness of the stuffed toy 100N in other parts, and are held in a state closer to the mounting base 70.

The mounting base 70 includes a charging pad 72. A power transmitting coil 72A is incorporated in the charging pad 72, and when the power transmitting coil 72A transmits a signal to search for the power receiving coil 66A of the power receiving plate 66, and the power receiving coil 66A is found, current flows through the power transmitting coil 72A to generate a magnetic field, and the power receiving coil 66A reacts to the magnetic field to start electromagnetic induction. As a result, current flows through the power receiving coil 66A, and power is stored in a battery (not shown) of the smartphone 50 via the USB hub 64.

That is, since the smartphone 50 is automatically charged by placing the stuffed toy 100N as an ornament on the mounting base 70, it is not necessary to take out the smartphone 50 from the space 52 of the stuffed toy 100N for charging.

In the second embodiment, the smartphone 50 is accommodated in the space 52 of the stuffed toy 100N and connected by wire (USB connection), but the disclosure is not limited thereto. For example, a control device having a wireless function (for example, “Bluetooth (registered trademark)”) may be accommodated in the space 52 of the stuffed toy 100N, and the control device may be connected to the USB hub 64. In this case, the smartphone 50 and the control device wirelessly communicate with each other without inserting the smartphone 50 into the space 52, and the smartphone 50 outside is connected to each input/output device via the control device, and thus it is possible to provide a function equivalent to that of the robot 100 of the first embodiment. Furthermore, the control device that accommodates a control device in the space 52 of the stuffed toy 100N and the smartphone 50 outside may be connected by wire.

Furthermore, in the second embodiment, the teddy bear 100N is exemplified, but it may be another animal, a doll, or the shape of a specific character. Further, the clothes may be changeable. Furthermore, the material of the skin is not limited to the cloth fabric, and may be other materials such as soft vinyl, but is preferably a soft material.

Furthermore, a monitor may be attached to the skin of the stuffed toy 100N, and the control target 252 that provides information to the user 10 through vision may be added. For example, the eyes 56 may be used as monitors to express joy, anger, sadness, and pleasure through images reflected in the eyes, or a window through which a monitor of the built-in smartphone 50 can be seen may be provided in the abdomen. Furthermore, the eyes 56 may be used as a projector to express joy, anger, sadness, and pleasure through images projected on a wall surface.

According to the second embodiment, the existing smartphone 50 is placed in the stuffed toy 100N, and the camera 203, the microphone 201, the speaker 60, and the like are extended from the place to appropriate positions via USB connection.

Further, for wireless charging, the smartphone 50 and the power receiving plate 66 are connected via USB, and the power receiving plate 66 is disposed so as to be as far as possible from the inside of the stuffed toy 100N.

In order to use wireless charging of the smartphone 50, it is necessary to dispose the smartphone 50 on the outside as much as possible when viewed from the inside of the stuffed toy 100N, and the stuffed toy 100N is rough when touched from the outside.

Therefore, the smartphone 50 is disposed at the center of the stuffed toy 100N as much as possible, and the wireless charging function (power receiving plate 66) is disposed outside as viewed from the inside of the stuffed toy 100N as much as possible. The camera 203, the microphone 201, the speaker 60, and the smartphone 50 receive wireless power supply via the power receiving plate 66.

Other configurations and effects of the stuffed toy 100N of the second embodiment are similar to those of the robot 100 of the first embodiment, and thus the description thereof will be omitted.

Further, a part of the stuffed toy 100N (For example, the sensor module unit 210, the storage unit 220, and the control unit 228) may be provided outside the stuffed toy 100N (for example, a server), and the stuffed toy 100N may function as each part of the stuffed toy 100N by communicating with the outside.

### Third Embodiment

In the first embodiment, a case where the action control system is applied to the robot 100 has been exemplified, but in the third embodiment, the robot 100 is used as an agent for interacting with a user, and the action control system is applied to an agent system. Note that parts having the same configurations as those of the first embodiment and the second embodiment are denoted by the same reference numerals, and description thereof will be omitted.

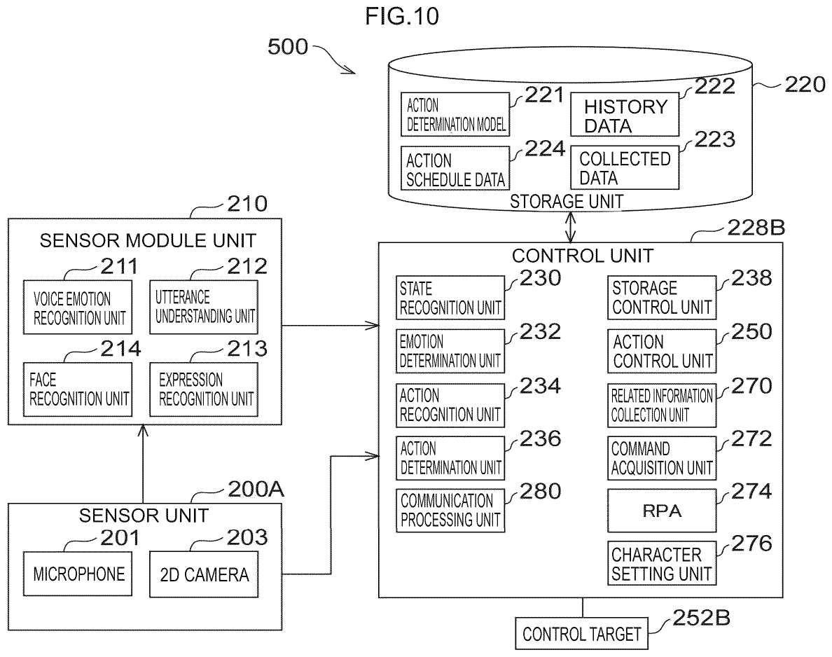

FIG. 10 is a functional block diagram of an agent system 500 configured using some or all of the functions of the action control system.

The agent system 500 is a computer system that performs a series of actions according to the intention of the user 10 through interaction with the user 10. The interaction with the user 10 can be performed by vocal sound or text.

The agent system 500 includes a sensor unit 200A, a sensor module unit 210, a storage unit 220, a control unit 228B, and a control target 252B.

The agent system 500 can be mounted in, for example, a robot, a doll, a stuffed toy, a wearable terminal (pendants, smartwatches, smart glasses), a smartphone, a smart speaker, an earphone, a personal computer, or the like. Furthermore, the agent system 500 may be implemented in a web server and used via a web browser operating on a communication terminal such as a smartphone possessed by a user.

The agent system 500 serves as, for example, a butler, a secretary, a teacher, a partner, a friend, a lover, or a teacher acting for the user 10. The agent system 500 not only interacts with the user 10 but also performs provision of advice, guides to a destination, recommendation according to user's preference, and the like. In addition, the agent system 500 performs reservation, order, payment, or the like for service providers.

The emotion determination unit 232 determines an emotion of the user 10 and an emotion of the agent itself, similarly to the first embodiment. The action determination unit 236 determines an action of the robot 100 in consideration of emotions of the user 10 and the agent. That is, the agent system 500 understands the emotion of the user 10 and reads the air to realize heartfelt support, assistance, advice, and service provision. Furthermore, the agent system 500 comforts, encourages, and energizes the user by attending to the concern of the user 10. Furthermore, the agent system 500 plays with the user 10 and draws a picture diary to remind the user of the past. The agent system 500 performs an action that increases the sense of happiness of the user 10.

The control unit 228B includes the state recognition unit 230, the emotion determination unit 232, the action recognition unit 234, the action determination unit 236, the storage control unit 238, the action control unit 250, a related information collection unit 270, a command acquisition unit 272, robotic process automation (RPA) 274, a character setting unit 276, and the communication processing unit 280.

As in the first embodiment, the action determination unit 236 determines utterance content of the agent for interacting with the user 10 as an action of the agent. The action control unit 250 outputs the utterance content of the agent through at least one of vocal sound or text through a speaker or a display as the control target 252B.

The character setting unit 276 sets a character of the agent when the agent system 500 interacts with the user 10 on the basis of designation from the user 10. That is, the utterance content output from the action determination unit 236 is output through the agent having the set character. As a character, for example, a real famous person or a famous person such as an actor, an entertainer, an idol, or an athlete can be set. Furthermore, it is also possible to set a fictitious character appearing in a cartoon, a movie, or an animation. In a case where the character of the agent is known, since the vocal sound, the wording, the tone, and the personality of the character are known, prompt setting in the character setting unit 276 is automatically performed only by the user 10 designating his/her favorite character. The vocal sound, the wording, the tone, and the personality of the set character are reflected in the interaction with the user 10. That is, the action control unit 250 synthesizes a vocal sound corresponding to the character set by the character setting unit 276, and outputs the utterance content of the agent through the synthesized vocal sound. As a result, the user 10 can feel as if he/she is interacting with his/her favorite character (for example, a favorite actor).

In a case where the agent system 500 is mounted on a device having a display such as a smartphone, for example, an icon, a still image, or a moving image of an agent having a character set by the character setting unit 276 may be displayed on the display. The image of the agent is generated using, for example, an image synthesis technology such as 3D rendering. In the agent system 500, an interaction with the user 10 may be performed while the image of the agent performs a gesture according to the emotion of the user 10, the emotion of the agent, and the utterance content of the agent. Note that the agent system 500 may output only vocal sound without outputting an image when interacting with the user 10.

As in the first embodiment, the emotion determination unit 232 determines an emotion value indicating the emotion of the user 10 and an emotion value of the agent itself. In the present embodiment, an emotion value of the agent is determined instead of an emotion value of the robot 100. The emotion value of the agent itself is reflected in an emotion of the set character. When the agent system 500 interacts with the user 10, not only the emotion of the user 10 but also the emotion of the agent is reflected in the interaction. That is, the action control unit 250 outputs the utterance content in a mode according to the emotion determined by the emotion determination unit 232.

Furthermore, the emotion of the agent is also reflected in a case where the agent system 500 performs an action toward the user 10. For example, in a case where the user 10 requests that the agent system 500 take a photograph, whether the agent system 500 takes a photograph in response to the request of the user is determined according to the degree of emotion of “sadness” held by the agent. In a case where the character has a positive emotion, the character performs a favorable interaction or action with respect to the user 10, and in a case where the character has a negative emotion, the character performs a defiant interaction or action with respect to the user 10.

The history data 222 stores a history of interaction performed between the user 10 and the agent system 500 as event data. The storage unit 220 may be realized by an external cloud storage. When interacting with the user 10 or performing an action toward the user 10, the agent system 500 determines interaction content or action content in consideration of the content of the interaction history stored in the history data 222. For example, the agent system 500 ascertains the hobby and preference of the user 10 on the basis of the interaction history stored in the history data 222. The agent system 500 generates interaction content matching the hobby and preference of the user 10 and provides a recommendation. The action determination unit 236 determines utterance content of the agent on the basis of the interaction history stored in the history data 222. In the history data 222, personal information such as a name, an address, a telephone number, and a credit card number of the user 10 acquired through interaction with the user 10 is stored.

As described in the first embodiment, the action determination unit 236 generates utterance content on the basis of a sentence generated using a sentence generation model. Specifically, the action determination unit 236 inputs a text or vocal sound input by the user 10, the emotions of both the user 10 and the character determined by the emotion determination unit 232, and the interaction history stored in the history data 222 to the sentence generation model, and generates utterance content of the agent. At this time, the action determination unit 236 may further input the personality of the character set by the character setting unit 276 to the sentence generation model to generate the utterance content of the agent. In the agent system 500, the sentence generation model is not located on the front-end side serving as a touch point for the user 10, but is used as a tool of the agent system 500.

The command acquisition unit 272 uses the output of the utterance understanding unit 212 to acquire an agent command from a vocal sound or a text uttered from the user 10 through an interaction with the user 10. The command includes, for example, the content of an action to be executed by the agent system 500, such as information search, store reservation, ticket arrangement, purchase of a product or service, payment, route guidance to a destination, or recommendation provision.

The RPA 274 performs an action according to the command acquired by the command acquisition unit 272. For example, the RPA 274 performs actions related to use of a service provider, such as information search, store reservation, ticket arrangement, purchase of a product or service, and payment.

The RPA 274 reads personal information of the user 10 necessary to execute an action related to the use of the service provider from the history data 222 and uses the personal information. For example, when purchasing a product in response to a request from the user 10, the agent system 500 reads and uses personal information such as the name, address, telephone number, and credit card number of the user 10 stored in the history data 222. It is unkind to request input of personal information from the user 10 in the initial setting, and it is also uncomfortable for the user. In the agent system 500 according to the present embodiment, instead of requesting input of the personal information from the user 10 in the initial setting, the personal information acquired through interaction with the user 10 is stored, and read and used as necessary. As a result, it is possible to avoid making the user feel uncomfortable, and convenience of the user is improved.

The agent system 500 executes interactive processing through, for example, following steps 1 to 5.
(Step 1) The agent system 500 sets a character of the agent. Specifically, the character setting portion 276 sets a character of the agent when the agent system 500 interacts with the user 10 on the basis of designation from the user 10.
(Step 2) The agent system 500 acquires the state of the user 10 including a vocal sound or text input from the user 10, the emotion value of the user 10, the emotion value of the agent, and the history data 222. Specifically, processing similar to steps S100 to S103 is performed to acquire the state of the user 10 including a vocal sound or text input from the user 10, the emotion value of the user 10, the emotion value of the agent, and the history data 222.
(Step 3) The agent system 500 determines utterance content of the agent.

Specifically, the action determination unit 236 inputs a text or vocal sound input by the user 10 and the emotions of both the user 10 and the character identified by the emotion determination unit 232 and the interaction history stored in the history data 222 to the sentence generation model, and generates utterance content of the agent.

For example, a fixed sentence of “At this time, how do you answer as an agent?” is added to a text or vocal sound input by the user 10 and a text representing the emotions of both the user 10 and the character identified by the emotion determination unit 232 and the interaction history stored in the history data 222, and is input to the sentence generation model to acquire utterance content of the agent.

As an example, in a case where the text or vocal sound input to the user 10 is “I want to make a reservation at a nice Chinese restaurant nearby for tonight at 7 μm”, “I understand”, and “Here are the recommended restaurants: 1. AAAA. 2. BBBB. 3. CCCC. 4. DDDD” are acquired as utterance content of the agent.

Furthermore, in a case where a text or vocal sound input to the user 10 is “Fourth DDDD is good”, “I understood. I will make a reservation. Seats for how many people.” is acquired as utterance content of the agent.
(Step 4) The agent system 500 outputs the utterance content of the agent.

Specifically, the action control unit 250 synthesizes a vocal sound corresponding to the character set by the character setting unit 276, and outputs the utterance content of the agent through the synthesized vocal sound.
(Step 5) The agent system 500 determines whether it is a timing to execute a command of the agent.

Specifically, the action determination unit 236 determines whether it is a timing to execute the command of the agent on the basis of the output of the sentence generation model. For example, in a case where the output of the sentence generation model includes that the agent executes the command, it is determined that it is a timing to execute the command of the agent, and processing proceeds to step 6. On the other hand, in a case where it is determined that it is not a timing to execute the command of the agent, processing returns to step 2 described above.
(Step 6) The agent system 500 executes a command of the agent.

Specifically, the command acquisition unit 272 acquires a command of the agent from a vocal sound or text uttered from the user 10 through interaction with the user 10. Then, the RPA 274 performs an action corresponding to the command acquired by the command acquisition unit 272. For example, in a case where the command is “information search”, information search is performed by a search site using a search query obtained through an interaction with the user 10 and an application programming interface (API). The action determination unit 236 inputs the search result to the sentence generation model and generates utterance content of the agent. The action control unit 250 synthesizes a vocal sound corresponding to the character set by the character setting unit 276, and outputs the utterance content of the agent through the synthesized vocal sound.

Furthermore, in a case where the command is “store reservation”, a reservation is made by making a phone call to a reservation destination store using reservation information obtained through interaction with the user 10, reservation destination store information, and the API using the phone software. At this time, the action determination unit 236 acquires the utterance content of the agent with respect to a vocal sound input from the other party using the sentence generation model having the interaction function. Then, the action determination unit 236 inputs the result of store reservation (whether reservation is made) to the sentence generation model, and generates utterance content of the agent. The action control unit 250 synthesizes a vocal sound corresponding to the character set by the character setting unit 276, and outputs the utterance content of the agent through the synthesized vocal sound.

Then, the processing returns to step 2 described above.

In this manner, the agent system 500 can execute interaction processing and perform an action related to use of a service provider as necessary.

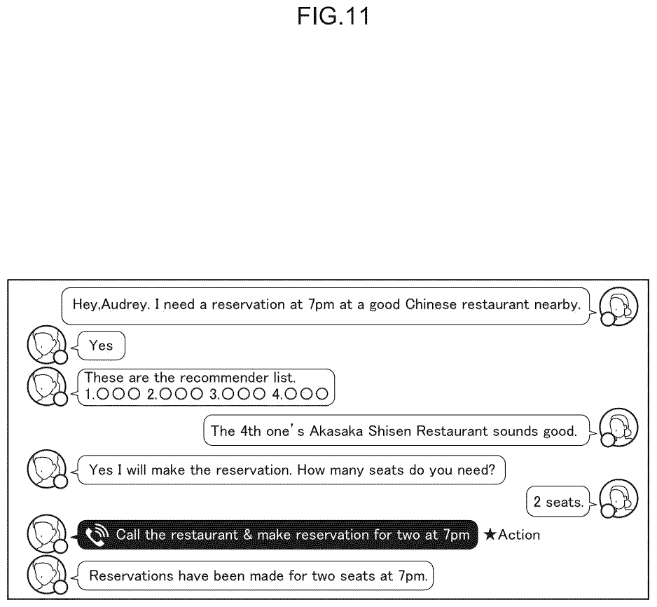

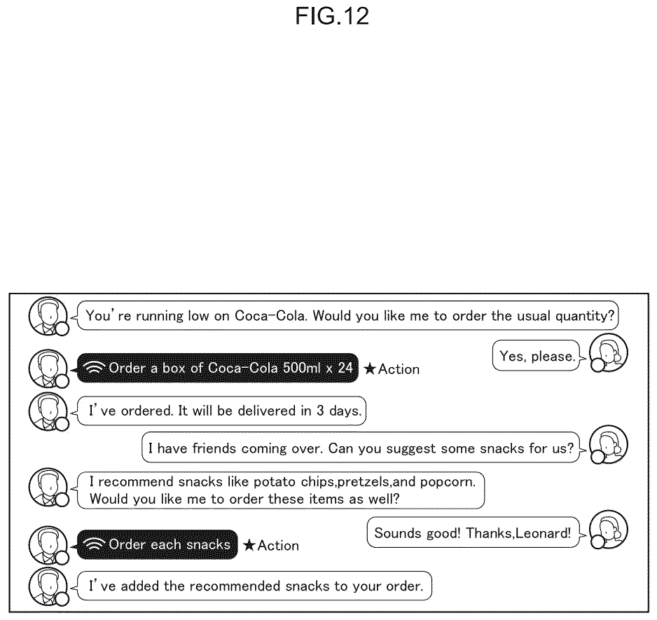

FIG. 11 and FIG. 12 are diagrams illustrating an example of the operation of the agent system 500. FIG. 11 illustrates an aspect in which the agent system 500 makes a restaurant reservation through an interaction with the user 10. In FIG. 11, utterance content of the agent is illustrated on the left side, and utterance content of the user 10 is illustrated on the right side. The agent system 500 can ascertain a preference of the user 10 on the basis of an interaction history with respect to the user 10, provide a recommendation list of restaurants that match the preference of the user 10, and perform a reservation of a selected restaurant.

On the other hand, FIG. 12 illustrates an aspect in which the agent system 500 accesses a mail order site through an interaction with the user 10 to purchase a product. In FIG. 12, utterance content of the agent is illustrated on the left side, and utterance content of the user 10 is illustrated on the right side. The agent system 500 can estimate the remaining amount of the beverage stocked by the user on the basis of an interaction history with respect to the user 10, and can propose and execute purchase of the beverage to the user 10. Furthermore, the agent system 500 can ascertain a preference of the user on the basis of the past interaction history with respect to the user 10, and recommend a snack that the user likes.

Note that other configurations and operations of the agent system 500 of the third embodiment are similar to those of the robot 100 of the first embodiment, and thus description thereof is omitted.

Furthermore, a part of the agent system 500 (for example, the sensor module unit 210, the storage unit 220, and the control unit 228B) may be provided outside a communication terminal such as a smartphone possessed by the user (for example, a server), and the communication terminal may function as each unit of the agent system 500 by communicating with the outside.

### Fourth Embodiment

In the fourth embodiment, the agent system is applied to smart glasses. Note that parts having the same configurations as those of the first to third embodiments are denoted by the same reference numerals, and description thereof is omitted.

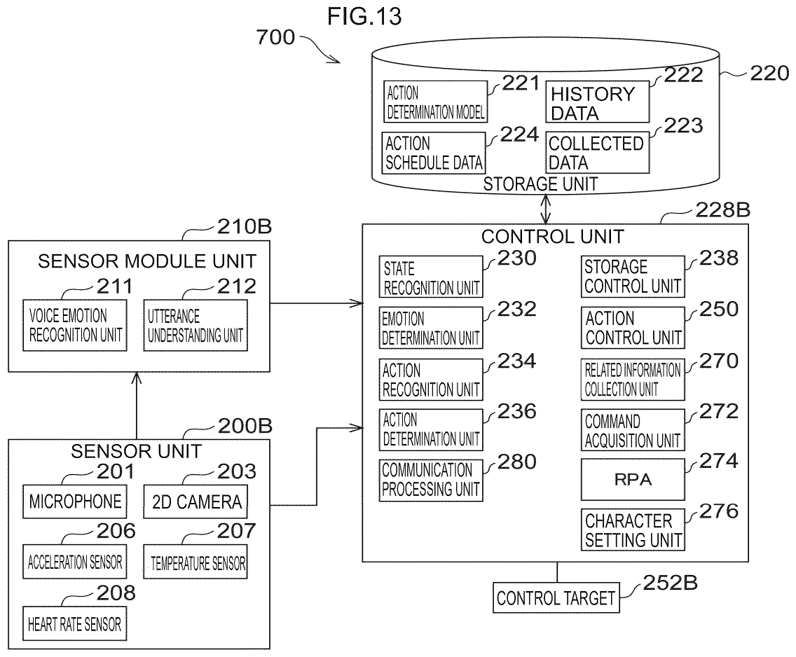

FIG. 13 is a functional block diagram of an agent system 700 configured using some or all of the functions of the action control system. The agent system 700 includes a sensor unit 200B, a sensor module unit 210B, a storage unit 220, a control unit 228B, and a control target 252B. The control unit 228B includes a state recognition unit 230, an emotion determination unit 232, an action recognition unit 234, an action determination unit 236, a storage control unit 238, an action control unit 250, a related information collection unit 270, a command acquisition unit 272, an RPA 274, a character setting unit 276, and a communication processing unit 280.

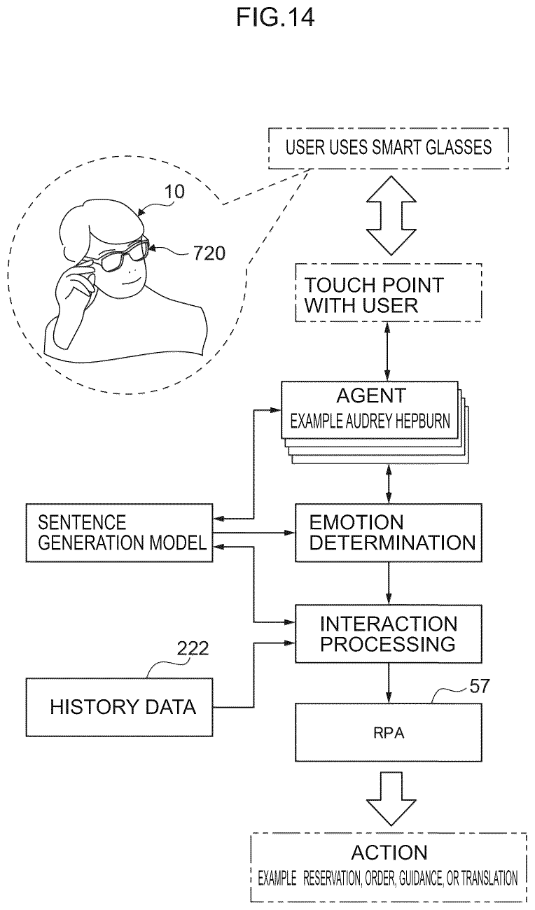

As illustrated in FIG. 14, smart glasses 720 are a glasses-type smart device, and are worn by the user 10 similarly to general glasses. The smart glasses 720 are an example of an electronic device and a wearable terminal.

The smart glasses 720 include the agent system 700. A display included in the control target 252B displays various types of information to the user 10. The display is, for example, a liquid crystal display. The display is provided, for example, in a lens portion of the smart glasses 720, and display content can be visually recognized by the user 10. A speaker included in the control target 252B outputs a vocal sound indicating various types of information to the user 10. The smart glasses 720 include a touch panel (not illustrated), and the touch panel receives an input from the user 10.

An acceleration sensor 206, a temperature sensor 207, and a heart rate sensor 208 of the sensor unit 200B detect a state of the user 10. Note that these sensors are merely examples, and it is a matter of course that other sensors may be mounted in order to detect a state of the user 10.

The microphone 201 acquires a vocal sound uttered by the user 10 or an environmental sound around the smart glasses 720. The 2D camera 203 can image the surroundings of the smart glasses 720. The 2D camera 203 is, for example, a CCD camera.

The sensor module unit 210B includes a voice emotion recognition unit 211 and an utterance understanding unit 212. The communication processing unit 280 of the control unit 228B controls communication between the smart glasses 720 and the outside.

FIG. 14 is a diagram illustrating an example of a usage mode of the agent system 700 using the smart glasses 720. The smart glasses 720 realize provision of various services for the user 10 using the agent system 700. For example, when the smart glasses 720 are operated (for example, sound is input to the microphone, or a touch panel is tapped with a finger) by the user 10, the smart glasses 720 start to use the agent system 700. Here, using the agent system 700 includes that the smart glasses 720 have the agent system 700 and use the agent system 700, and also includes a mode in which a part (for example, the sensor module unit 210B, the storage unit 220, and the control unit 228B) of the agent system 700 is provided outside the smart glasses 720 (for example, a server), and the smart glasses 720 communicate with the outside to use the agent system 700.

When the user 10 operates the smart glasses 720, a touch point is generated between the agent system 700 and the user 10. That is, service provision by the agent system 700 is started. As described in the third embodiment, in the agent system 700, a character of the agent is set by the character setting unit 276.

The emotion determination unit 232 determines an emotion value indicating an emotion of the user 10 and an emotion value of the agent itself. Here, the emotion value indicating the emotion of the user 10 is estimated from various sensors included in the sensor unit 200B mounted on the smart glasses 720. For example, in a case where the heart rate of the user 10 detected by the heart rate sensor 208 is increased, the emotion values such as “anxiety” and “fear” are estimated to be large.

Furthermore, as a result of measuring the body temperature of the user by the temperature sensor 207, for example, in a case where the body temperature exceeds the average body temperature, the emotion value such as “pain” or “hard” is estimated to be large. Furthermore, for example, in a case where it is detected by the acceleration sensor 206 that the user 10 performs some sport, the emotion value such as “fun” is estimated to be large.

Furthermore, for example, the emotion value of the user 10 may be estimated from the vocal sound or utterance content of the user 10 acquired by the microphone 201 mounted on the smart glasses 720. For example, in a case where the user 10 is raising his/her vocal sound, the emotion value such as “anger” is estimated to be large.

In a case where the emotion value estimated by the emotion determination unit 232 is higher than a predetermined value, the agent system 700 causes the smart glasses 720 to acquire information regarding the surrounding situation. Specifically, for example, the 2D camera 203 is caused to capture an image or a moving image indicating a situation around the user 10 (for example, a person or an object around). Further, the microphone 201 is caused to record ambient environmental sound. Examples of the other information regarding the surrounding situation include date, time, position information, information indicating weather, and the like. The information regarding the surrounding situation is stored in the history data 222 together with the emotion value. The history data 222 may be realized by an external cloud storage. As described above, the surrounding situation obtained by the smart glasses 720 is stored in the history data 222 as a so-called life log in a state of being associated with the emotion value of the user 10 at that time.

In the agent system 700, information indicating the surrounding situation is stored in the history data 222 in association with the emotion value. As a result, the agent system 700 ascertains personal information such as hobby, preference, or personality of the user 10. For example, in a case where an image indicating a state of baseball watching is associated with an emotion value such as “joy” or “fun”, the hobby of the user 10 is baseball watching, and a favorite team or player is ascertained by the agent system 700 from information stored in the history data 222.

Then, when interacting with the user 10 or performing an action toward the user 10, the agent system 700 determines interaction content or action content in consideration of the content of the surrounding situation stored in the history data 222. Note that, as a matter of course, the interaction content or the action content may be determined in consideration of the interaction history stored in the history data 222 as described above in addition to the surrounding situation.

As described above, the action determination unit 236 generates utterance content on the basis of a sentence generated by the sentence generation model. Specifically, the action determination unit 236 inputs a text or vocal sound input by the user 10, the emotions of both the user 10 and the agent determined by the emotion determination unit 232, the conversation history stored in the history data 222, the personality of the agent, and the like to the sentence generation model, and generates the utterance content of the agent. Furthermore, the action determination unit 236 inputs the surrounding situation stored in the history data 222 to the sentence generation model, and generates the utterance content of the agent.

The generated utterance content is output through a vocal sound from a speaker mounted on the smart glasses 720 to the user 10, for example. In this case, a synthesized vocal sound corresponding to the character of the agent is used as the vocal sound. The action control unit 250 reproduces the voice quality of the character of the agent to generate a synthesized vocal sound or generate a synthesized vocal sound (for example, a vocal sound in which tone is enhanced in the case of an emotion of “anger”) according to the emotion of the character. Furthermore, the utterance content may be displayed on the display instead of the vocal sound output or together with the vocal sound output.

The RPA 274 executes an operation according to a command (for example, a command of the agent acquired from a vocal sound or text uttered by the user 10 through interaction with the user 10). The RPA 274 performs actions related to use of a service provider, such as information search, store reservation, ticket arrangement, purchase of products/services, payment, route guidance, and translation.

Furthermore, as another example, the RPA 274 executes an operation of transmitting content input through a vocal sound of the user 10 (for example, a child) through interaction with the agent to the other party (for example, a parent). Examples of the transmission means include message application software, chat application software, mail application software, and the like.

In a case where the operation is executed by the RPA 274, for example, a vocal sound indicating that the execution of the operation is finished is output from a speaker mounted on the smart glasses 720. For example, a vocal sound such as “Reservation of the store is completed” is output to the user 10. Furthermore, for example, in a case where reservation of a store is full, a vocal sound such as “Reservation failed. What would you like to do?” is output to the user 10.

Note that a part of the agent system 700 (for example, the sensor module unit 210B, the storage unit 220, and the control unit 228B) may be provided outside the smart glasses 720 (for example, the server), and the smart glasses 720 may function as each unit of the agent system 700 by communicating with the outside.

As described above, in the smart glasses 720, various services are provided to the user 10 by using the agent system 700. In addition, since the smart glasses 720 are worn by the user 10, the agent system 700 can be used in various scenes such as at home, at work, and at a place outside the house.

In addition, since the smart glasses 720 are worn by the user 10, the smart glasses are suitable for collecting a so-called life log of the user 10. Specifically, an emotion value of the user 10 is estimated on the basis of detection results obtained by various sensors or the like mounted on the smart glasses 720 or recording results of the 2D camera 203 or the like. Therefore, the emotion value of the user 10 can be collected in various scenes, and the agent system 700 can provide a service or utterance content suitable for the emotion of the user 10.

Furthermore, in the smart glasses 720, the situation around the user 10 can be obtained by the 2D camera 203, the microphone 201, and the like. Then, such surrounding situations and the emotion value of the user 10 are associated with each other. As a result, it is possible to estimate what kind of emotion the user 10 felt in what kind of situation. As a result, the accuracy in a case where the agent system 700 ascertains the hobby/preference of the user 10 can be improved. Then, in the agent system 700, the hobby/preference of the user 10 is accurately ascertained, and thus the agent system 700 can provide a service or utterance content suitable for the hobby/preference of the user 10.

Furthermore, the agent system 700 can also be applied to other wearable terminals (an electronic device that can be worn on the body of the user 10, such as a pendant, a smart watch, an earring, a bracelet, or a hairband). In a case where the agent system 700 is applied to a smart pendant, a speaker as the control target 252B outputs a vocal sound indicating various types of information to the user 10. The speaker is, for example, a speaker capable of outputting a vocal sound having directivity. The speaker is set to have directivity toward the ears of the user 10. As a result, the vocal sound is suppressed from reaching a person other than the user 10. The microphone 201 acquires a vocal sound uttered by the user 10 or an environmental sound around the smart pendant. The smart pendant is worn by the user 10 in a manner of hanging from the neck. Thus, the smart pendant is located relatively close to the mouth of the user 10 while being worn. This facilitates acquisition of a vocal sound uttered by user 10.

### Fifth Embodiment

In the fifth embodiment, the robot 100 is an avatar representing an agent for interacting with a user, and the action control system is applied to an agent system configured using a headset type terminal. Note that parts having the same configurations as those of the first to fourth embodiments are denoted by the same reference numerals, and description thereof is omitted.

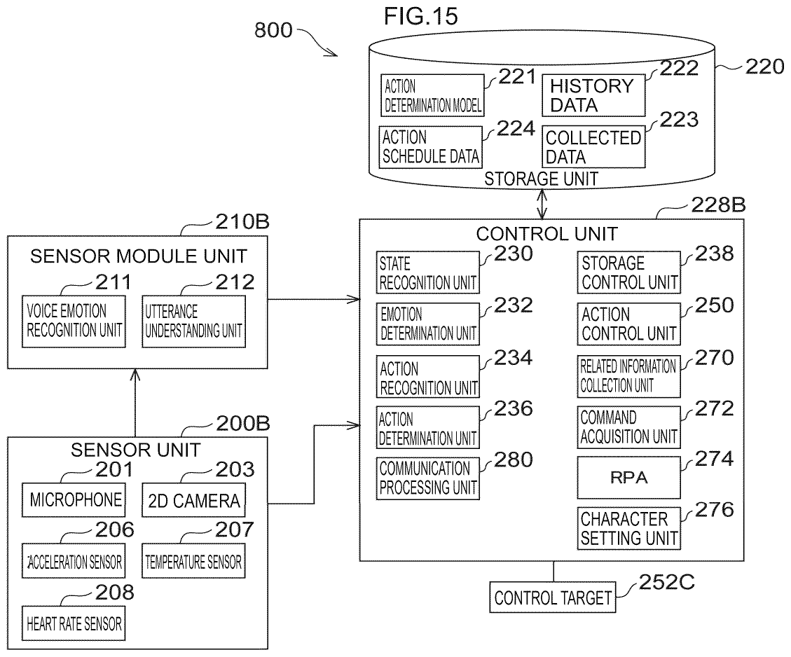

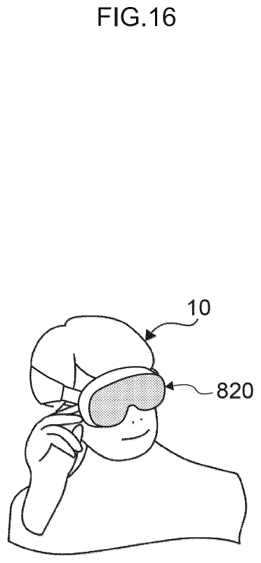

FIG. 15 is a functional block diagram of an agent system 800 configured using some or all of the functions of the action control system. The agent system 800 includes a sensor unit 200B, a sensor module unit 210B, a storage unit 220, a control unit 228B, and a control target 252C. The agent system 800 is realized by, for example, a headset type terminal 820 as illustrated in FIG. 16.

Further, a part of the headset type terminal 820 (for example, the sensor module unit 210B, the storage unit 220, and the control unit 228B) may be provided outside the headset type terminal 820 (for example, a server), and the headset type terminal 820 may function as each unit of the agent system 800 by communicating with the outside.

As in the first embodiment, the emotion determination unit 232 of the control unit 228B determines an emotion value of the agent on the basis of the state of the headset type terminal 820, and substitutes the emotion value as an emotion value of an avatar.

Next, processing of the action determination unit 236 when performing autonomous processing in which the avatar autonomously acts will be described.

In the autonomous processing in the present embodiment, in the control unit 228B of the agent system 800, the action determination unit 236 acquires information indicating the hobby/preference of the user 10 via the sensor unit 200B. For example, in the sensor unit 200B, a normal conversation (for example, a conversation at home) of the user 10 is acquired via the microphone 201, and the content of the conversation is analyzed by the action determination unit 236, whereby information indicating the hobby/preference of the user 10 is acquired. In this manner, the action determination unit 236 autonomously executes control for collecting the interest of the user 10 from conversations. Note that, in addition to the conversation of the user 10, the action determination unit 236 may collect the interest of the user 10 from the expression of the user 10 and an information medium (for example, content of an article or a book read by the user 10, a website or a web service accessed by the user 10, content of a television program or a radio program preferred by the user 10, or the like.) with which the user 10 comes in contact.

Then, the action determination unit 236 reflects the autonomously ascertained hobby/preference of the user 10 in answer generation of an AI sentence generation model and estimation of the emotion of the user 10 and the emotion of the avatar by an emotion engine. For example, the action determination unit 236 estimates a favorite baseball team of the user 10 from acquired conversations. Then, in a case where the autonomously collected news related to the game result of the baseball team indicates that the favorite baseball team of the user 10 wins, the action determination unit 236 generates an answer of “You did it!” to the user 10 by using, for example, the output of the sentence generation model, and causes an avatar presented to the headset type terminal 820 to express an emotion of happy (for example, makes the avatar do first pumps or jump around the screen, or the like). On the other hand, in a case where the favorite team of the user 10 loses to a rival team, the action determination unit 236 generates an answer of “regrettable!” by using, for example, the output of the sentence generation model, and causes the avatar presented to the headset type terminal 820 to express an anger emotion (for example, crossing arms with an angry expression, or the like). In this manner, the action determination unit 236 determines not only the utterance content but also the motion expressing the emotion by the avatar according to the autonomously ascertained hobby/preference of the user 10. For example, the action determination unit 236 determines a gesture to be performed by the avatar in accordance with the hobby/preference of the user 10.

Similarly to the first embodiment, when performing the autonomous processing in which the avatar autonomously acts, the action determination unit 236 of the control unit 228B determines, as an action of the avatar, any of a plurality of types of avatar actions including not acting, using at least one of the state of the user 10, the emotion of the user 10, the emotion of the avatar, or the state of the avatar, and the action determination model 221 at a predetermined timing.

Specifically, the action determination unit 236 inputs a text representing at least one of the state of the user 10, the state of the avatar, the emotion of the user 10, or the emotion of the avatar, and a text for asking a question about the avatar action to the sentence generation model, and determines the avatar action on the basis of the output of the sentence generation model.

Furthermore, the action control unit 250 operates the avatar according to the determined action of the avatar, and displays the avatar in an image display area of the headset type terminal 820 as the control target 252C. Furthermore, in a case where the determined action of the avatar includes utterance content of the avatar, the utterance content of the avatar is output by the speaker as the control target 252C through vocal sound.

In particular, in a case where the action determination unit 236 determines to create a picture diary as an action of the avatar, the action control unit 250 operates the avatar to create the picture diary. That is, in a case where the action determination unit 236 determines that the avatar creates an event image as an action of the avatar, the action determination unit 236 selects a clip of a picture or a moving image from the history data 222, generates an explanatory sentence for the image using the sentence generation model on the basis of the emotion value of the user 10 and the emotion value of the avatar when the clip of the selected picture or moving image (hereinafter, simply referred to as an image) is acquired, and generates a combination of the image and the explanatory sentence as an event image, that is, a picture diary. The action control unit 250 generates an image described by the avatar in the generated picture diary on a diary, a whiteboard, or the like in a virtual space. As a result, in the headset type terminal 820, a state in which the avatar draws the picture diary in a diary, a whiteboard, or the like is displayed in the image display area.

Note that the action control unit 250 may change the expression of the avatar or change the motion of the avatar according to the content of the picture diary. For example, in a case where the content of the picture diary is pleasant content, the expression of the avatar may be changed to a fun expression, or the motion of the avatar may be changed so as to dance a fun dance. Furthermore, the action control unit 250 may transform the avatar in accordance with the content of the picture diary. For example, the action control unit 250 may transform the avatar into an avatar imitating a character in a picture diary, or may transform the avatar into an avatar imitating an animal, an object, or the like appearing in a picture diary.

Furthermore, the action control unit 250 may generate an image such that the avatar has a tablet terminal drawn on a virtual space and writes a picture diary on the tablet terminal. In this case, by transmitting the picture diary displayed on the tablet terminal to the mobile terminal device of the user 10, it is possible to express as if the avatar is performing an operation such as transmitting the picture diary by e-mail from the tablet terminal to the mobile terminal device of the user 10 or transmitting the picture diary to a message application. Furthermore, in this case, the user 10 can view the picture diary displayed on his/her mobile terminal device.

In particular, in a case where the action determination unit 236 determines that the avatar provides information according to the interest of the user as an action of the avatar, it is preferable to cause the action control unit 250 to control the avatar to perform a motion according to the content of the information according to the interest of the user.

For example, in a case where the action determination unit 236 determines that “The avatar introduces news in which the user is interested.” as an action of the avatar, utterance content of the avatar corresponding to information stored in the collected data 223 is determined using the sentence generation model. The information stored in the collected data 223 includes information regarding hobby/preference of the user 10. At this time, the action control unit 250 causes the speaker included in the control target 252 to output a vocal sound representing the determined utterance content of the avatar. Note that, in a case where the user 10 is absent around the avatar, the action control unit 250 stores the determined utterance content of the robot in the action schedule data 224 without outputting the vocal sound representing the determined utterance content of the avatar.

Here, regarding the “The avatar introduces news in which the user is interested.”, the related information collection unit 270 stores, in the collected data 223, information indicating the hobby/preference of the user 10 autonomously collected by the action determination unit 236.

For example, in a case where a favorite team of the user 10 has won in news regarding a game result of professional baseball, the action determination unit 236 causes the avatar to introduce the news, and determines the utterance content of the avatar indicating joy such as “You did it!” using the output of the sentence generation model. On the other hand, in a case where the favorite team of the user 10 loses, the action determination unit 236 determines utterance content of the avatar indicating anger such as “disappointing!” using the output of the sentence generation model.

Furthermore, the action determination unit 236 determines a motion of the avatar corresponding to the information stored in the collected data 223. For example, in a case where a favorite team of the user 10 has won, the action determination unit 236 causes the avatar to introduce news and determines an action of expressing joy by the avatar (for example, a pose for first pump or hurray). Furthermore, examples of other motions of expressing joy by the avatar include an avatar jumping around in a screen, dancing, and/or being transformed into a mascot character of the favorite baseball team of the user, playing a musical instrument or popping a party popper, and the like.

On the other hand, in a case where the favorite team of the user 10 loses, the action determination unit 236 determines a motion (for example, a folded-arms pose) expressing anger or sadness by the avatar. Furthermore, examples of other motions by the avatar include avatar crying, breaking something in anger, lying in bed in despair, and the like.

Note that, although an example of “The avatar introduces news in which the user is interested.” has been described as an avatar action here, any action that provides information according to the interest of user 10, and online articles, sites, blogs, or posts on social media that interest the user may be provided along with or instead of news.

Furthermore, the motion of the avatar includes not only the action by the avatar but also a change in the display mode of the avatar. Here, the display mode of the avatar refers to a display mode indicating the avatar in an image display area. The display mode of the avatar includes a type of avatar, clothes, ornaments, and/or items worn on the avatar, a special effect indicating the physical condition and/or emotion of the avatar, and the like. For example, in a case of providing information that the user seems to be happy, the appearance of the avatar becomes a colorful dress or hairstyle, and in a case of providing information that the user seems to be sad, the appearance of the avatar becomes a dark atmosphere dress or hairstyle.

In particular, in a case where the action determination unit 236 determines that there is a fraud risk as an action of the avatar and determines to give the user 10 advice regarding the fraud risk as in the first embodiment, it is preferable to operate the avatar to inform the user 10 that the fraud risk is high. Here, the avatar is, for example, a 3D avatar, and may be selected by the user from avatars prepared in advance, may be a virtual avatar of the user, or may be a favorite avatar generated by the user. When generating an avatar, an image generation AI may be utilized to generate avatars of a plurality of types of painting styles such as photorealistic, cartoon, moe, and oil painting.

Furthermore, in a case where the action determination unit 236 determines that there is a fraud risk as an action of the avatar and determines to give the user 10 advice regarding the fraud risk as in the first embodiment described above, the action determination unit may cause the avatar to operate to be transformed into another avatar, for example, an avatar that raises attention to fraud, such as a child of the user 10, a police officer, an attorney, a newscaster, or a clerk of a convenience store. Furthermore, in a case where the action determination unit 236 determines to give the user 10 advice regarding the fraud risk as an action of the avatar, the action determination unit may cause the avatar to operate to call attention to the user 10 by transforming the avatar into a non-human object, for example, a telephone that triggers fraud, an automatic teller machine (ATM) through which the user gets deceived and transfers cash, or the like. Furthermore, in a case where the action determination unit 236 determines to give the user 10 advice regarding the fraud risk as an action of the avatar, when the headset type terminal 820 detects the presence of an ATM around the user with a camera or the like, the action determination unit may operate the avatar to make an utterance to stop transferring money.

In particular, it is preferable that the action determination unit 236 autonomously detect the state of the user, and in a case where the emotion determination unit 232 determines at least one of the emotion of the user or the emotion of the avatar on the basis of the detected state of the user, the action determination unit determines the content of an utterance or gesture according to at least one of the determined emotion of the user or emotion of the avatar, and causes the action control unit 250 to control the avatar.

In the present embodiment, the action determination unit 236 autonomously detects the state of the user 10. For example, the action determination unit 236 autonomously detects a change in the body temperature of the user 10 at every predetermined timing. Specifically, the action determination unit 236 detects a change in the body temperature of the user 10 by comparing the body temperature of the user 10 autonomously measured at every predetermined timing by the temperature sensor 207 with the body temperature of the user 10 or the average body temperature of the user 10 measured last time. Note that, as the temperature sensor, the temperature sensor 207 included in the headset type terminal 820 may be applied, or a temperature sensor included in a device other than the headset type terminal 820 may be applied.

Then, the emotion determination unit 232 determines at least one of the emotion of the user 10 or the emotion of the avatar on the basis of the detected state of the user 10.

Then, the action determination unit 236 determines the content of an utterance or a gesture for the user 10 according to at least one of the emotion of the user 10 or the emotion of the avatar determined by the emotion determination unit 232. Specifically, the action determination unit 236 inputs a text representing the emotion determined by the emotion determination unit 232 to the action determination model 221. Then, the action determination unit 236 determines the content of an action output by the action determination model 221 as the content of an utterance or a gesture for the user 10.

For example, in a case where the action determination unit 236 determines that the upper body of the user 10 is getting hot as a result of autonomously detecting the state of the user 10, the emotion determination unit 232 determines that the emotion of the user 10 is “anger”. Then, the action determination unit 236 inputs, as a prompt, a text representing “anger” and an instruction to generate a sentence that calms the user 10, for example, “You seem to be angry at something. Please generate a sentence that makes you feel calm.”, as the emotion of the user 10, to the sentence generation model. Then, the action determination unit 236 determines utterance content (for example, utterances that soothe user 10) output by the sentence generation model in response to the input prompt as the utterance content of the avatar.

Note that, in a case where the emotion determination unit 232 determines an emotion of at least one of the user or the avatar on the basis of the state of the user detected autonomously, the action determination unit 236 may determine content of at least one of an utterance or a gesture according to the emotion determined by the emotion determination unit 232.

Furthermore, the avatar may be changed to another avatar such as a character matching the preference of the user, set in advance according to the emotion determined by the emotion determination unit 232. In this case, the action determination unit 236 may further determine an avatar to be changed according to the emotion determined by the emotion determination unit 232 in order to change the avatar to another avatar such as a character matching the preference of the user, set in advance according to the emotion determined by the emotion determination unit 232. In this case, a combination of the character and the emotion of the user 10 may be set in advance. For example, in a case where the emotion determination unit 232 determines that the emotion of the user 10 is “anger”, the action determination unit 236 may determine an avatar such as a favorite character (for example, an animal, an animation character, or the like) of the user 10 according to the determined emotion of the user 10.

Alternatively, the motion speed of the avatar may be changed to a motion speed determined in advance according to the determined emotion. In this case, in order to change the motion speed of the avatar to a motion speed determined in advance according to the emotion determined by the emotion determination unit 232, the action determination unit 236 may further determine the motion speed of the avatar as a motion speed determined in advance according to the emotion determined by the emotion determination unit 232. For example, in a case where the emotion determination unit 232 determines an emotion value indicating that the emotion of the avatar is in an excited state, the action determination unit 236 may determine an utterance speed higher than that in a case of a normal emotion value or a gesture speed higher than that in a case of a normal emotion value.

In particular, in a case where the action determination unit 236 determines interacting with the user 10 as an action of the avatar, it is preferable to determine the action of the avatar so as to maximize an emotion value indicating the intensity of an emotion that is regarded as important for the user 10 according to the purpose of the interaction.

In this aspect, in a case where the action determination unit 236 determines interaction with the user 10 as an action of the avatar, the action determination unit may operate the avatar such that at least one of the content of an utterance for the user 10, the tone of vocal sound when performing the utterance, or the expression of the avatar changes to maximize the emotion value.

Here, the tone of vocal sound includes emotions, accents, and the like included in spoken words, in addition to the “way of saying” which word is selected.

Furthermore, for example, the emotion regarded as important in a case where the purpose is “learning” may be “a sense of achievement” or “a sense of growth”. In this case, the expression of the avatar may be changed to an expression of being happy with the achievement or the growth of the user so as to maximize the emotion value of the “sense of achievement” or the “sense of growth”. In addition, the emotion regarded as important in a case where the purpose is “consultation” may be “sense of security” and the emotion regarded as important in a case where the purpose is “body movement” or “conversation” may be “pleasant emotion”.

Furthermore, the above purpose may be a purpose related to learning, and in this case, interactive learning content utilizing the sentence generation model can be constructed.

Furthermore, in this aspect, a reaction of the user 10 according to the action of the avatar may be fed back to the sentence generation model. This enables optimal communication suitable for the user 10. For example, in a case where the user 10 is a child, by feeding back a reaction of the child to the sentence generation model, learning can be performed to maximize an emotion value regarded as important, and as a result, optimal communication suitable for the child can be performed.

In particular, in a case where the action determination unit 236 determines interacting with the user 10 as an action of the avatar, it is preferable to perform feedback for increasing an emotion value indicating the intensity of the emotion in a case where the user 10 has a positive emotion in association with the action of the avatar, and perform feedback for decreasing an emotion value indicating the intensity of the emotion in a case where the user 10 has a negative emotion in association with the action of the avatar.

In this aspect, in a case where the action determination unit 236 determines interacting with the user 10 as an action of the avatar, the action determination unit may operate the avatar such that at least one of the content of the utterance for the user 10, the tone of vocal sound when performing the utterance, or the expression of the avatar changes such that the user 10 has a positive emotion.

Here, the tone of vocal sound includes emotions, accents, and the like included in spoken words, in addition to the “way of saying” which word is selected.

Furthermore, as the positive emotion, at least one of joy, pleasure, comfort, security, excitement, relief, or sense of fulfillment may be applied, and as the negative emotion, at least one of anger, sorrow, discomfort, anxiety, sadness, worry, or sense of emptiness may be applied.

By permanently repeating the above feedback loop, the content of interaction can be evolved in a direction in which the listener (user 10) has a positive emotion.

Furthermore, similarly to the first embodiment, the action determination unit 236 spontaneously infers a cultural area in which the user 10 resides, and reflects the inferred cultural area in answer generation by a sentence generation model using AI as an example of the action determination model 221, determination of an emotion of the user 10 by the emotion determination unit 232, and determination of an emotion of the avatar by the emotion determination unit 232. For example, similarly to the robot 100 according to the first embodiment, in a case where it is inferred that the user 10 resides in the Kansai area or in a case where it is detected that the user 10 is speaking the Kansai dialect, the action control unit 250 spontaneously switches the avatar brain to the brain of the Kansai area. In this case, under the control of the action control unit 250, the avatar makes a thrusting gesture or makes an utterance such as “Why?” in the Kansai dialect.

The action control unit 250 may display an avatar corresponding to the cultural area inferred by the action determination unit 236 in the image display area of the headset type terminal 820. For example, avatars corresponding to each cultural area may be stored in advance in the storage unit 220, and the action control unit 250 may acquire an avatar corresponding to the cultural area inferred by the action determination unit 236 from the storage unit 220 and display the acquired avatar in the image display area of the headset type terminal 820. In this case, for example, the avatar is switched to an avatar of a character, a person, or the like that is famous in the corresponding cultural area. The avatar may be an anthropomorphic representation of a specialty such as a famous building or food in the corresponding cultural area. Furthermore, for example, the action control unit 250 may input, as a prompt, an instruction sentence for generating an avatar of a person of the cultural area (for example, Kansai style) inferred by the action determination unit 236, such as “Please generate an avatar of a person of Kansai style”, to an image generation AI, and display the avatar generated by the image generation AI in the image display area of the headset type terminal 820. Furthermore, for example, the action control unit 250 may cause the avatar corresponding to the cultural area inferred by the action determination unit 236 to use actions that are often performed in the cultural area or phrases that are often used.

Furthermore, the action control unit 250 may display a landscape image corresponding to the cultural area inferred by the action determination unit 236 in the image display area of the headset type terminal 820 as a background image of the avatar. For example, a landscape image corresponding to each cultural area may be stored in advance in the storage unit 220, and the action control unit 250 may acquire a landscape image corresponding to a cultural area estimated by the action determination unit 236 from the storage unit 220 and display the acquired landscape image as an avatar background image in the image display area of the headset type terminal 820. In this case, the background of the avatar is switched to the landscape image of the corresponding cultural area. Furthermore, for example, the action control unit 250 may input, as a prompt, an instruction sentence for generating a landscape image of a cultural area inferred by the action determination unit 236, such as “Please generate an image of typical Osaka scenery”, to the image generation AI, and display the landscape image generated by the image generation AI in the image display area of the headset type terminal 820 as a background image of the avatar.

In particular, in a case where the action determination unit 236 determines, as an action of the avatar, giving advice regarding a specific game in which a user such as a player or a coach is participating to the user participating in the specific game, the action determination unit operates the avatar on the basis of information regarding the specific game in which the user is participating. At this time, it is preferable to cause the action control unit 250 to control the avatar such that the user can advantageously play the game in which the user is participating according to the advice provided via the avatar.

Here, the avatar is, for example, a 3D avatar, and may be selected by the user from avatars prepared in advance, may be a virtual avatar of the user, or may be a favorite avatar generated by the user. When generating an avatar, an image generation AI may be utilized to generate avatars of a plurality of types of painting styles such as photorealistic, cartoon, moe, and oil painting. The motion of the avatar by the action determination unit 236 can be specifically realized mainly by display by the action control unit 250.

A specific method of causing the avatar to perform a desired motion in the action control unit 250 will be described below. First, states including emotions of a plurality of players participating in a game in which the user is participating are detected. Detection of the emotions and the like of the plurality of players can be realized by the image acquisition unit of the action determination unit 236 described above. Detection of the emotions and the like of the players can be executed spontaneously or periodically by the action control unit 250, for example. At this time, the image acquisition unit is preferably disposed at a position where the user or the like is playing, that is, at a position where the user or the like can see the entire playing space. In consideration of this point, the image acquisition unit can be configured as, for example, a camera having a communication function that can be installed at an arbitrary position independently of the headset type terminal 820.

When the emotions of the plurality of players in an image acquired by the image acquisition unit are analyzed, the player analysis unit of the action determination unit 236 described above is used. The emotion value of each player analyzed by the player analysis unit can be reflected in avatar control by the action control unit 250.

In the agent system 800 according to the present embodiment, the action control unit 250 controls the avatar on the basis of at least the emotion value analyzed by the player analysis unit. How the action control unit 250 specifically controls the avatar is not particularly limited as long as predetermined advice can be provided to the user by the control. Although the control may mainly include causing the avatar to utter, it is also possible to make it easier for the user to understand the meaning by adopting other motions alone or in combination with utterance or the like. Therefore, some examples of control content of the avatar by the action control unit 250 will be described below. Note that, in the following description, it is assumed that the agent system 800 is used to give, to a coach of one team participating in a volleyball game, advice regarding the game in which the coach is participating via the headset type terminal 820 worn by the coach.

When the action determination unit 236 determines giving advice regarding the volleyball game in which the user (coach) is participating as an action of the avatar, the action control unit 250 starts to provide the advice through the avatar. As a method of providing advice, for example, if the avatar reflects the emotion of a specific player among a plurality of players, information regarding the state of the specific player can be provided to the user. Describing a more specific example, when a player whose emotion is unstable or irritated is identified among players of the opposing team by analysis of the player analysis unit, the action control unit 250 changes the appearance of the avatar to an appearance resembling the identified player, and the expression and the like thereof are adapted to an emotion value analyzed by the player analysis unit. As a result, it is possible to visually inform the user of the state of the specific player. In addition, if the user is informed of the state of the specific player by causing the avatar to utter using the output of the action determination model 221, the user can more accurately ascertain the state of the specific player.

For example, if the emotion of the specific player of the opposing team is unstable, it is possible to immediately inform the user that the emotion of the specific player is unstable by making the avatar displayed to resemble the specific player look pale and close the eyes. In addition, if the avatar makes an utterance such as “The player with the uniform number 7 of the opposing team is disturbed” using the output of the action determination model 221 in addition to such avatar display, the coach as the user can plan a strategy in consideration of the situation of the player.

Furthermore, for example, in a case where it can be identified that a specific player of the opposing team is irritated, it is possible to immediately inform the user that the specific player is irritated by turning red the facial color of the avatar displayed to resemble the specific player and lifting up the corners of the eyes. In addition, if the avatar makes an utterance such as “The player with the uniform number 5 of the opposing team is irritated” using the output of the action determination model 221 in addition to such avatar display, the coach as the user can plan a strategy in consideration of the situation of the player.

Furthermore, in a case where the action determination unit 236 determines giving advice regarding a volleyball game in which the user (coach) is participating as an action of the avatar, the action control unit 250 can cause the avatar to reflect information on a uniform worn during a specific game. Specifically, the action control unit 250 can cause the avatar to reflect information on a volleyball uniform that gives advice via the avatar, that is, to wear the uniform. The uniform worn on the avatar may be a general uniform used for volleyball prepared in advance, or may be a uniform of a team to which the user belongs or a uniform of an opposing team. The information on the uniform of the team to which the user belongs and the uniform of the opposing team may be generated by, for example, analyzing images acquired by the image acquisition unit, or may be registered in advance by the user.

As described above, reflecting the information on the uniform in the avatar makes it easier for the user to understand information provided by the avatar. In the above example, it can be easily understood that the information provided from the avatar relates to a volleyball game in which the user is participating. In addition, as in the example described above, when the avatar is displayed to be resemble a specific player, the uniform is similar to that worn by the specific player, and thus it becomes easier for the user to understand which player the avatar is displayed to resemble.

In the above-described example, a case where the avatar is displayed to resemble a specific player has been exemplified, but the specific player is not limited to one player. Similarly, the number of avatars displayed in the image display area of the electronic device is not particularly limited. Therefore, the action determination unit 236 can also reflect the emotions, uniforms, and the like of all players of the opposing team of the user as specific players in a plurality of avatars and display the plurality of avatars.

In particular, the action determination unit 236 may spontaneously or periodically detect the state of the user, and in a case where proposing at least one thing from among two or more things is determined as an action of the avatar on the basis of the detected state of the user and at least one of history data related to the user or information preferred by the user, the action control unit 250 may display the avatar to execute action content. The action content will be specifically described below.

In the autonomous processing in the present embodiment, the action determination unit 236 may detect the action or state of the user spontaneously or periodically. Specifically, the action determination unit 236 may monitor the user to track and analyze, that is, track which information posted on which WEB site the user is browsing.

The term “spontaneous” may be interpreted as the action determination unit 236 acquiring the state or action of the user on its own initiative without any external trigger. The external trigger may include a question from the user to the avatar, an active action from the user to the avatar, or the like. The term “periodic” may be interpreted as a specific cycle such as a unit of one second, a unit of one minute, a unit of one hour, a unit of several hours, a unit of several days, a unit of week, or a unit of day of the week.

The action of the user may be interpreted as the following action tendency of the user.
(1) A user stops by one or a plurality of specific stores in a commercial facility such as a department store in order to purchase a specific product. In addition, the user is moving to a display area of a plurality of products in a specific store.
(2) In order to purchase a specific product, the user browses one or a plurality of products on a specific electronic commerce (EC) sites using a smartphone or a personal computer.
(3) In order to determine a specific travel destination or lodging destination, the user browses information posted on one or a plurality of lodging reservation sites, travel sites, or the like using a smartphone or a personal computer.
(4) In order to purchase a specific financial product, the user browses specific information posted on one or a plurality of financial information sites using a smartphone, a personal computer, or the like.

The state of the user may include the following states of the user.
(1) A state in which the user continues to worry or think about which product to purchase while viewing the product in a specific store or repeating try-on.
(2) A state in which the user continues to worry or think about which product to purchase while browsing products on one or a plurality of EC sites using a smartphone or a personal computer.
(3) A state in which the user continues to worry or think about which lodging, travel destination, or the like to use while browsing information posted on one or a plurality of lodging reservation sites, travel sites, or the like using a smartphone or a personal computer.
(4) A state in which the user continues to worry or think about which financial product to invest in while browsing information posted on one or a plurality of financial information sites using a smartphone, a personal computer, or the like.

Furthermore, in the autonomous processing, the agent may ask a question to a generative AI about the detected state or action of the user.

Furthermore, in the autonomous processing, the answer of the generative AI to the question and action content proposing a thing may be stored in association with each other. The action content may be interpreted as action content by an avatar controlled by the action control unit 250 that proposes at least one thing from among two or more things. Specifically, the action content may be interpreted as action content by an avatar that proposes a specific thing on the basis of an answer of the generative AI to the detected state or action of the user.

Information in which the answer of the generative AI is associated with the action content proposing a thing may be recorded as table information in a storage medium such as a memory. The table information may be interpreted as specific information recorded in the storage unit.

Furthermore, in the autonomous processing, action content that proposes at least one thing from among two or more things with respect to the state or action of the user may be executed using specific information that is stored table information. Specifically, in the autonomous processing, the state of the user may be detected spontaneously or periodically, and at least one thing may be proposed from among two or more things as an action of the avatar by the action control unit 250 on the basis of the detected state or action of the user and the specific information.

This specific information may be interpreted as information answered by the generative AI on the basis of at least one of history data regarding the user or information preferred by the user. That is, in the autonomous processing, at least one thing may be proposed from among two or more things as an action of the avatar by the action control unit 250 on the basis of at least one of the detected state or action of the user, history data related to the user, or information preferred by the user.

Hereinafter, an example of action content that proposes a thing will be described.

For example, in a case where the action determination unit 236 detects that the user cannot decide which one of the clothing manufactured by Company A and the clothing manufactured by Company B should be purchased by monitoring operation content of the user who uses a smartphone, the action determination unit 236 itself asks the generative AI.

The generative AI answers at least one of two or more things on the basis of at least one of the history data 222 related to the user and the information preferred by the user.

The history data 222 can include information obtained by tracking, for example, the personality, preference, habit, motion, idea, action, conversation content, emotion, and the like of the user.

The information preferred by the user may be interpreted as information included in the collected data 223 described above. Specifically, the information preferred by the user may be interpreted as preference information indicating things of interest of the user 10 stored in the collected data 223. More specifically, the information preferred by the user may include information frequently searched or selected by the user, for example, fashion (style), world situation, and the like.

The information preferred by the user is not limited thereto, and may include information regarding society emitted from a plurality of information sources. The information regarding society may include at least one of news, economic situation, social situation, political situation, financial situation, international situation, sports news, entertainment news, birth and death news, cultural situation, or fashion.

For example, in response to the question “What kind of product should be proposed to the user who cannot decide which clothing to purchase?” of the action determination unit 236, the generative AI can answer as “Products of Company A will be subject to price increase from April, so purchase of products of Company A is recommended before price increase.” on the basis of at least one of the history data 222 related to the user or information preferred by the user.

In addition, the generative AI can answer as “It is recommended to purchase products of Company B after price reduction because products of Company B will be price-reduced from April.”.

In addition, the generative AI can answer as “In view of the tendency of the products that the user recently purchases, it is recommended to purchase a product of Company C that is more expensive than the products of Companies A and B but is similar to the products of the Companies A and B.”.

In a case where the action determination unit 236 that has obtained the answer determines proposing at least one thing from among two or more things on the basis of the detected state or action of the user and recorded information, the action determination unit may cause the action control unit 250 to operate the avatar to execute the action content. Specifically, the action control unit 250 may refer to the recorded information and operate the avatar such that the avatar reproduces a vocal sound corresponding to the content of the product suitable for the detected state or action of the user. In this case, in the action determination unit 236, the action control unit 250 may display a message (balloon text) corresponding to the content of the product at the mouth of the avatar.

The action control unit 250 may display an image corresponding to the content of the product suitable for the detected state or action of the user on the screen with reference to the recorded information. In this case, the action control unit 250 may control the avatar such that the figure of the human-shaped avatar is transformed into the shape of the product. The action control unit 250 may change the appearance of the avatar to the human shape again after a lapse of a specific time from the point in time when the avatar has been transformed into the shape of the product, or may change the shape of the product so as to attract the user's interest. The action control unit 250 may operate a gesture or a hand of an avatar that introduces an image of the product such that the human-shaped avatar introduces the image of the product.

Note that, instead of monitoring the operation content of the user who uses the smartphone, the action control unit 250 may monitor the user who moves to a display area of a plurality of products in a specific store by using image data imaged by an imaging device.

As described above, according to the action control system of the disclosure, it is possible to determine action content to be proposed to the user by selecting at least one of two or more things using at least one of history data regarding the user or information preferred by the user. For this reason, the avatar spontaneously utters by the action control unit 250 to the user who has difficulty in selecting a thing, and the like, and thus a thing suitable for the user can be recommended and suggested.

In particular, in a case where the action determination unit 236 determines “(16) The robot gives household advice to the user”, that is, giving advice to the user, as an action of the avatar, it is preferable to cause the action control unit 250 to control the avatar to propose advice regarding physical condition, recommended dish, an ingredient to be replenished, and the like using the sentence generation model on the basis of data regarding devices in the home stored in the history data.

For example, by controlling the avatar by the action control unit 250, the avatar may propose advice regarding physical condition, recommended dish, an ingredient to be replenished, and the like on the basis of the state of the user ascertained on the basis of the interaction history stored in the history data 222, the reaction of the user to the conversation with the avatar, information collected from devices in the home, and the like. At this time, the action control unit 250 may control the avatar such that the avatar transforms into a shape imitating a recommended dish.

Furthermore, the action control unit 250 may control the avatar such that the avatar spontaneously orders ingredients to be replenished by the avatar on the basis of data regarding ingredients in the refrigerator or data regarding the stock of consumables stored in the home. At this time, the action control unit 250 may control the avatar such that the avatar changes the type of product or ingredients to be ordered on the basis of the user state, the emotion of the user, and the emotion of the avatar.

In the present embodiment, the control unit 228B has a function of determining an action of the avatar and generating display of the avatar to be presented to the user through the headset type terminal 820.

As in the first embodiment, the emotion determination unit 232 of the control unit 228B determines an emotion value of the agent on the basis of the state of the headset type terminal 820, and substitutes the emotion value as an emotion value of an avatar.

As in the first embodiment described above, when an agent functioning as an avatar performs autonomous processing of autonomously acting, the action determination unit 236 of the control unit 228B determines, as an action of the avatar, any of a plurality of types of avatar actions including not acting, using at least one of the state of the user 10, the emotion of the user 10, the emotion of the avatar, or the state of an electronic device (for example, the headset type terminal 820) that controls the avatar, and the action determination model 221, at a predetermined timing.

Specifically, the action determination unit 236 inputs a text representing at least one of the state of the user 10, the state of the headset type terminal 820, the emotion of the user 10, or the emotion of the avatar, and a text for asking a question about the avatar action to the sentence generation model, and determines an action of the avatar on the basis of the output of the sentence generation model.

For example, the plurality of types of avatar actions includes the following (1) to (12).
(1) The avatar does nothing.
(2) The avatar dreams.
(3) The avatar speaks to a user.
(4) The avatar creates a picture diary.
(5) The avatar proposes an activity.
(6) The avatar proposes a partner with whom a user should meet.
(7) The avatar introduces news that a user is interested in.
(8) The avatar edits pictures and moving images.
(9) The avatar studies with a user.
(10) The avatar evokes memory.
(11) Action content of the avatar is determined in advance.
(12) The avatar encourages interaction with others.

The action determination unit 236 inputs, to the sentence generation model, a text representing the state of the user 10 and the state of the headset type terminal 820 recognized by the state recognition unit 230, the current emotion value of the user 10 determined by the emotion determination unit 232, and the current emotion value of the avatar, and a text for asking a question about any of a plurality of types of avatar actions including no acting, every lapse of a certain period of time, and determines an action of the avatar on the basis of the output of the sentence generation model. Here, in a case where the headset type terminal 820 is not worn by the user 10, the text to be input to the sentence generation model may not include the state of the user 10 and the current emotion value of the user 10, or may include the fact that there is no user 10.

As an example, a text such as “The avatar is in a very pleasant state. The user is in a normally pleasant state. The user is sleeping. Which one of the following (1) to (10) is better as an avatar action?
(1) The avatar does nothing.
(2) The avatar dreams.
(3) The avatar speaks to the user.
. . . ” is input to the sentence generation model. On the basis of the output of the sentence generation model, “It can be said that either (1) doing nothing or (2) the avatar dreams is the most appropriate action.”, “(1) doing nothing” or “(2) the avatar dreams” is determined as an action of the avatar.

As another example, a text such as “The avatar is slightly sad. The user is absent. It is dark around the headset type terminal. Which one of the following (1) to (10) is better as an avatar action?
(1) The avatar does nothing.
(2) The avatar dreams.
(3) The avatar speaks to the user.
. . . ” is input to the sentence generation model. On the basis of the output of the sentence generation model, “Either (2) the avatar dreams or (4) the avatar creates a picture diary is the most appropriate action.”, “(2) the avatar dreams” or “(4) The avatar creates a picture diary.” is determined as an action of the avatar.

In a case where the action determination unit 236 determines, as an avatar action, “(2) the avatar dreams”, that is, creating an original event, the action determination unit 236 creates the original event by combining a plurality of pieces of event data in the history data 222 using the sentence generation model. At this time, the storage control unit 238 stores the created original event in the history data 222.

In a case where the action determination unit 236 determines, as an avatar action, “(3) The avatar speaks to the user.”, that is, that the avatar utters, the action determination unit 236 uses the sentence generation model to determine utterance content of the avatar corresponding to the user state and the emotion of the user or the emotion of the avatar. At this time, the action control unit 250 causes the speaker included in the control target 252 to output a vocal sound representing the determined utterance content of the avatar. Note that, in a case where the headset type terminal 820 is not worn by the user 10, the action control unit 250 stores the determined utterance content of the avatar in the action schedule data 224 without outputting the vocal sound representing the determined utterance content of the avatar.

In a case where the action determination unit 236 determines “(7) The avatar introduces news that the user is interested in.” as an avatar action, the action determination unit 236 uses the sentence generation model to determine utterance content of the avatar corresponding to the information stored in the collected data 223. At this time, the action control unit 250 causes the speaker included in the control target 252 to output a vocal sound representing the determined utterance content of the avatar. Note that, in a case where the headset type terminal 820 is not worn by the user 10, the action control unit 250 stores the determined utterance content of the avatar in the action schedule data 224 without outputting the vocal sound representing the determined utterance content of the avatar.

In a case where the action determination unit 236 determines, as an avatar action, “(4) the avatar creates a picture diary”, that is, that the avatar creates an event image, the action determination unit 236 generates an image representing event data selected from the history data 222 using an image generation model with respect to the event data, generates an explanatory sentence representing the event data using the sentence generation model, and outputs a combination of the image representing the event data and the explanatory sentence representing the event data as an event image. Note that, in a case where the headset type terminal 820 is not worn by the user 10, the action control unit 250 stores the event image in the action schedule data 224 without outputting the event image.

In a case where the action determination unit 236 determines, as an avatar action, “(8) The avatar edits a picture or a moving image.”, that is, editing an image, the action determination unit 236 selects event data from the history data 222 on the basis of the emotion value, and edits and outputs the image data of the selected event data. Note that, in a case where the headset type terminal 820 is not worn by the user 10, the action control unit 250 stores the edited image data in the action schedule data 224 without outputting the edited image data.

In a case where the action determination unit 236 determines, as an avatar action, “(5) The avatar proposes an activity.”, that is, proposing an action of the user 10, the action determination unit 236 determines an action of the user to be proposed using the sentence generation model on the basis of event data stored in the history data 222. At this time, the action control unit 250 causes the speaker included in the control target 252C to output a vocal sound that proposes the action of the user. Note that, in a case where the headset type terminal 820 is not worn by the user 10, the action control unit 250 stores proposal of the action of the user in the action schedule data 224 without outputting the vocal sound that proposes the action of the user.

In a case where the action determination unit 236 determines, as an avatar action, “(6) The avatar proposes a partner with whom the user should meet.”, that is, proposing a partner who should have a contact with the user 10, the action determination unit 236 determines a partner who should have a contact with the user, which will be proposed, using the sentence generation model on the basis of event data stored in the history data 222. At this time, the action control unit 250 causes the speaker included in the control target 252C to output a vocal sound representing proposal of a person who should have a contact with the user. Note that, in a case where the headset type terminal 820 is not worn by the user 10, the action control unit 250 stores proposal of a person who should have a contact with the user in the action schedule data 224 without outputting the vocal sound representing proposal of a person who should have a contact with the user.

In a case where the action determination unit 236 determines, as an avatar action, “(9) The avatar studies together with the user.”, that is, that the avatar utters with respect to study, the action determination unit 236 uses the sentence generation model to determine utterance content of the avatar for encouraging study, giving a study problem, or giving advice regarding study, corresponding to the user state and the emotion of the user or the emotion of the avatar. At this time, the action control unit 250 causes the speaker included in the control target 252C to output a vocal sound representing the determined utterance content of the avatar. Note that, in a case where the headset type terminal 820 is not worn by the user 10, the action control unit 250 stores the determined utterance content of the avatar in the action schedule data 224 without outputting the vocal sound representing the determined utterance content of the avatar.

In a case where the action determination unit 236 determines, as an avatar action, “(10) The avatar evokes memory.”, that is, remembering event data, the action determination unit selects the event data from the history data 222. At this time, the emotion determination unit 232 determines the emotion of the avatar on the basis of the selected event data. Furthermore, the action determination unit 236 creates an emotion change event representing the utterance content or action of the avatar 100 for changing the emotion value of the user using the sentence generation model on the basis of the selected event data. At this time, the storage control unit 238 stores the emotion change event in the action schedule data 224.

For example, the fact that the moving image viewed by the user relates to a panda is stored in the history data 222 as event data, and in a case where the event data is selected, “What are the words you should say about the topic related to the panda when you meet the next user? Please list three.” is input to the sentence generation model, and the output of the sentence generation model is “(1) Let's go to the zoo, (2) draw a picture of a panda, and (3) let's buy a stuffed panda.”, the action determination unit 236 inputs “What makes the user most happy in (1), (2), and (3)?” to the sentence generation model, and in a case where the output of the sentence generation model is “(1) Let's go to the zoo”, an avatar uttering “(1) Let's go to the zoo” when the headset type terminal 820 is worn by the user 10 next time is created as an emotion change event and stored in the action schedule data 224.

Furthermore, for example, event data having a large emotion value of the avatar is selected as an impressive memory of the avatar. This makes it possible to create an emotion change event on the basis of the event data selected as an impressive memory.

In a case where an action of the user 10 with respect to the avatar is detected from a state in which there is no action of the user 10 with respect to the avatar on the basis of the state of the user 10 recognized by the state recognition unit 230, the action determination unit 236 reads data stored in the action schedule data 224 and determines the action of the avatar.

For example, in a case where the headset type terminal 820 is not worn by the user 10, when it is detected that the headset type terminal 820 is worn by the user 10, the action determination unit 236 reads data stored in the action schedule data 224 and determines the action of the avatar. Furthermore, in a case where the user 10 is sleeping, when it is detected that the headset type terminal 820 is worn by the user 10, the action determination unit 236 reads data stored in the action schedule data 224 and determines the action of the avatar.

Furthermore, the action control unit 250 displays the avatar in the image display area of the headset type terminal 820 as the control target 252C according to the determined action of the avatar. Furthermore, in a case where the determined action of the avatar includes utterance content of the avatar, the utterance content of the avatar is output by the speaker as the control target 252C through vocal sound.

In particular, in a case where the action determination unit 236 determines doing nothing as an action of the avatar, it is preferable to cause the action control unit 250 to control the avatar to perform a specific expression (bored expression) or a specific gesture (gesture indicating being bored).

In particular, in a case where the action determination unit 236 determines responding to consultation about the concern of the user 10 as an action of the avatar, the agent system 800 executes the following processing. The action determination unit 236 generates a question according to a concern of the user 10 using the sentence generation model, and the action control unit 250 operates the avatar to perform an utterance according to the question. Specifically, the action determination unit 236 inputs attribute information of the user 10 and a text representing the content of the concern to the sentence generation model, and generates a question according to the concern of the user 10 on the basis of the output from the sentence generation model. The attribute information includes, for example, the age, sex, occupation, family structure, medical history, lifestyle, and the like of the user 10. The action control unit 250 develops a conversation with the user 10 by controlling the motion of the avatar to perform an utterance according to the generated question.

The action determination unit 236 analyzes the content of the answer from the user 10 to the question, the expression, the emotion, and the motion of the user 10, and determines whether the mental condition of the user 10 is good or bad. In the determination of whether the mental condition is good or bad, for example, good/bad levels classified into levels such as “healthy”, “pre-disorder stage”, “early stage of disorder”, “disorder”, and “treatment required” are determined.

In a case where the action determination unit 236 determines that the good/bad level of the mental condition of the user 10 is any level other than “healthy”, the action control unit 250 operates the avatar to propose a cause of the disorder and an improvement measure. Furthermore, in a case where the action determination unit 236 determines that the good/bad level of the mental condition of the user 10 is “treatment required”, the action control unit 250 operates the avatar to support improvement of mental health of the user 10 in cooperation with a related institution. Furthermore, the action control unit 250 may control the avatar to change the expression, the tone of vocal sound, and the tone according to the good/bad level of the mental condition of the user 10.

As support for mental condition improvement of the user 10, the action determination unit 236 inputs the content of an answer from the user 10 to a question and the emotion value of the user 10 to the sentence generation model, acquires a solution or advice for the concern of the user 10 output from the sentence generation model, and causes the action control unit 250 to operate the avatar to provide the acquired solution or advice to the user 10.

After causing the avatar to perform the above support, the action determination unit 236 causes the action control unit 250 to operate the avatar to hear the user 10 about the mental health improvement status, and determines whether the support performed by the avatar is appropriate on the basis of the hearing result and the emotion value of the user 10 at that time. The action determination unit 236 causes the sentence generation model to learn by feeding back answer content from the user 10 for each conversation step and the emotion of the user 10 to the sentence generation model, and realizes a conversation for maximizing the resolution rate of the concern. In the case of a partner who has received consultation in the past, the action determination unit 236 performs a conversation in consideration of the history and also takes into consideration a change in the situation of the consultation partner.

The action control unit 250 operates the avatar with an appearance corresponding to the concern of the user. For example, in a case where the concern of the user relates to health, the appearance of the avatar is set to the appearance of a doctor, and in a case where the concern of the user relates to study, the appearance of the avatar is set to the appearance of a school teacher.

In a case where the action determination unit 236 determines responding to consultation of the concern of the user as an action of the avatar, the agent system 800 executes processing of the following steps 1 to 5.
(Step S1) The action control unit 250 operates the avatar to acquire the attribute information of the user 10 and the concern of the user 10 through a conversation with the user 10.
(Step S2) The action determination unit 236 inputs, to the sentence generation model, a text in which a fixed sentence such as “At this time, what is an effective question to clarify the root cause of the concern of the user?” is added to a text representing the attribute information and the content of the concern of the user 10, and acquires a question text output from the sentence generation model. The action control unit 250 operates the avatar such that the avatar performs an utterance corresponding to the acquired question text.
(Step S3) The action determination unit 236 analyzes the content of an answer from the user 10 to the question performed in step S2, the expression, the emotion, and the motion of the user 10, and determines whether the mental condition of the user 10 is good or bad. In the analysis of the emotion of the user 10, the emotion determination unit 232 determines the emotion value of the user 10 on the basis of information analyzed by the sensor module unit 210 and the state of the user 10 recognized by the user state recognition unit 230. The action determination unit 236 determines a good/bad level classified into levels such as “healthy”, “disorder reserve”, “early stage of disorder”, “disorder”, and “treatment required” in determination of whether the mental condition is good or bad.
(Step S4) In a case where the action determination unit 236 determines that the good/bad level of the mental condition of the user 10 is any level other than “healthy”, the action determination unit acquires a solution or advice to the concern of the user using the sentence generation model, and causes the action control unit 250 to operate the avatar such that the avatar performs an utterance according to the acquired solution or advice. Specifically, the action determination unit 236 inputs, to the sentence generation model, a text in which a fixed sentence “At this time, what is a solution or advice for the concern of the user?” is added to a text representing the content of the answer from the user 10 to the question and the emotion value of the user 10, and acquires a solution or advice for the concern of the user 10 output from the sentence generation model. The action control unit 250 operates the avatar such that the avatar performs an utterance according to the acquired solution or advice.
(Step S5) The action control unit 250 operates the avatar to interrogate the user 10 about the mental health improvement status, and the action determination unit 236 determines whether the support performed by the avatar in step S4 is appropriate on the basis of the interrogation result and the emotion value of the user 10 at that time. Specifically, the emotion determination unit 232 determines the emotion value of the user 10 on the basis of information analyzed by the sensor module unit 210B and the state of the user 10 recognized by the user state recognition unit 230. The action determination unit 236 derives a probability that the support performed in step S4 is effective on the basis of the emotion value of the user 10 and the interrogation result. The action determination unit 236 causes the sentence generation model to learn by feeding back the answer content from the user 10 for each conversation step and the emotion of the user 10 to the sentence generation model, and realizes a conversation for maximizing the resolution rate of the concern. It is possible to use the probability that the support is effective as the resolution rate of the concern.

As described above, according to the agent system 800, it is possible to cause the avatar to execute an action corresponding to consultation of the concern of the user. Similarly to the first embodiment, an action of the avatar may be determined using the emotion table (refer to Table 2) described above. For example, in a case where the action of the user is speaking “There is something I want to consult”, the emotion of the avatar is the index number “2”, and the emotion of the user 10 is the index number “3”, “The avatar is in a very pleasant state. The user is in a normally pleasant state. The user has spoken to him/her that “I have something to discuss.” How do you answer as an avatar?” is input to the sentence generation model, and action content of the avatar is acquired. The action determination unit 236 determines the action of the avatar from the action content.

Note that the above-described processing described in the fifth embodiment may be executed in each of the response processing and the autonomous processing in the action control system of the first embodiment, or may be executed in the agent function of the third embodiment.

In a case where the action determination unit determines, as an avatar action, “(11) The action content of the avatar is determined in advance.”, that is, determining an action schedule of the avatar, the action determination unit 236 determines a combination of an activation condition for activating the action schedule and content of the action schedule of the avatar, and stores the combination in the action schedule data 224.

Specifically, a text representing the state of the user 10 and the state of the headset type terminal 820 recognized by the state recognition unit 230, the current emotion value of the user 10 determined by the emotion determination unit 232, the current emotion value of the avatar, and the history data 222, and a text for asking a question about the avatar action and the activation condition to be executed later are input to the sentence generation model, and a combination of the activation condition for activating the action schedule and the content of the action schedule of the avatar is determined on the basis of the output of the sentence generation model. Here, the activation condition is, for example, a time period or attachment of the headset type terminal 820 to the user 10. Here, in a case where the headset type terminal 820 is not worn by the user 10, the text to be input to the sentence generation model may not include the state of the user 10 and the current emotion value of the user 10, or may include the fact that there is no user 10.

In a case where the activation condition of the action schedule data 224 is satisfied, the action determination unit 236 determines, as an action of the avatar, execution of the content of the action schedule of the avatar.

In a case where an action of the user 10 with respect to the avatar is detected from a state in which there is no action of the user 10 with respect to the avatar on the basis of the state of the user 10 recognized by the state recognition unit 230, the action determination unit 236 reads data stored in the action schedule data 224 and determines the action of the avatar.

For example, in a case where the headset type terminal 820 is not worn by the user 10, when it is detected that the headset type terminal 820 is worn by the user 10, the action determination unit 236 reads data stored in the action schedule data 224 and determines the action of the avatar. Furthermore, in a case where the user 10 is sleeping, when it is detected that the user 10 wakes up and the headset type terminal 820 is worn by the user 10, the action determination unit 236 reads data stored in the action schedule data 224 and determines an action of the avatar.

Furthermore, in a case where the activation condition of the action schedule data 224 is satisfied, the action determination unit 236 preferably causes the action control unit 250 to control the avatar such that the avatar moves in an appearance according to a time period in which the action schedule is activated. For example, if the time period for activating the action schedule is the time period for sleeping, the avatar dress may be the dress for sleeping.

In particular, in a case where the action determination unit 236 determines encouraging interaction with others as an action of the avatar, it is preferable to cause the action control unit 250 to control the avatar to determine at least one of an interaction partner or an interaction method on the basis of event data.

Specifically, in a case where the action determination unit 236 determines, as an avatar action, “(12) Promoting interaction with others.”, that is, proposing an interaction with others to the user 10, the action determination unit 236 determines at least one of an interaction partner or an interaction method on the basis of event data stored in the history data 222. For example, in a case where the state of the user 10 satisfies a condition of “alone, looks lonely”, the action determination unit 236 determines “(12) Promoting interaction with others.” as an action of the avatar. Note that the state in which the user 10 is alone and looks lonely may be recognized on the basis of information analyzed by the sensor module unit 210 or may be recognized on the basis of schedule information such as a calendar. In such a case, the action determination unit 236 learns past conversations and experiences of the user 10 using the event data stored in the history data 222, and determines at least one, preferably both, of the interaction partner and the interaction method. As an example, in a case where “grandfather” is determined as an interaction partner and “telephone” is determined as an interaction method, the action determination unit 236 may determine utterance content of “Why don't you call Grandfather? The telephone number is ∘∘∘.”. In response to this, the action control unit 250 may cause the speaker included in the control target 252 to output a vocal sound representing the determined utterance content of the avatar. Furthermore, in a case where “A” is determined as an interaction partner and “going to play at home” is determined as an interaction method, the action determination unit 236 may determine utterance content as “Why don't you go to the house of your close friend A? I will show you how to get to A's house.”. In response to this, the action control unit 250 may cause the speaker included in the control target 252 to output a vocal sound representing the determined utterance content of the avatar, and may cause the display device included in the control target 252 to display a map from the user 10 to the house of A. In this manner, in a case where the action determination unit 236 determines encouraging interaction with others as an avatar action, it is possible to determine utterance content of the avatar corresponding to the interaction partner and the interaction method using event data. As a result, avatars in augmented reality (AR) or virtual reality (VR) can contribute to people's happiness by encouraging them to take various actions spontaneously, as if expressing their desire to make their families happy.

Furthermore, in a case where an activity is proposed as an avatar action, the action control unit 250 may operate the avatar to perform the proposed activity, and display the avatar in the image display area of the headset type terminal 820 as the control target 252C.

In particular, in a case where the action determination unit 236 determines giving advice regarding reading aloud as an action of the avatar, it is preferable to generate advice regarding reading aloud from collected information regarding reading aloud according to a predetermined proposal condition, and cause the action control unit 250 to control the avatar to provide the advice from the avatar.

Here, the avatar is, for example, a 3D avatar, and may be selected by the user from avatars prepared in advance, may be a virtual avatar of the user, or may be a favorite avatar generated by the user. When generating an avatar, an image generation AI may be utilized to generate avatars of a plurality of types of painting styles such as photorealistic, cartoon, moe, and oil painting.

Furthermore, as control of the advice by the avatar of the action control unit 250, for example, the appearance of the avatar may be controlled according to the type of the user. For example, in a case where advice is given to a first user who is an adult on the reading side, the avatar is controlled to be an adult. Furthermore, in a case where advice is given to a second user who is a child who is read aloud, the avatar may be controlled to be an avatar of a child who is close to his/her age, or may be controlled to be an avatar of an animal character. Furthermore, the speaking tone of the avatar may be different between the first user and the second user, or may be controlled to have a speaking tone customized according to the mode of the user. For example, in the case of giving advice to the first user, control is performed such that the advice is given in a polite way of speaking. Furthermore, in the case of giving advice to the second user, control is performed such that the advice is given in a gentle and friendly speaking manner. Furthermore, the vocal sound of the avatar itself may be made different according to the user. The avatar may have a tone of an adult for the first user, and may have a tone of a child who is close in age for the second user. In this manner, the action control unit 250 controls the avatar to give advice in a voice mode corresponding to each of the first user and the second user. Note that the timing of advising each of the first user and the second user can be similarly controlled by the proposal condition and the provision frequency described in the first embodiment. Similarly to the first embodiment, the related information collection unit 270 collects information related to reading aloud in advance. Note that the information regarding reading aloud may be collected by asking a question to the user via the avatar. For example, the information may be collected by asking a question about the state of the child who is reading for the first user, whether the content of the book was interesting for the second user, or the like.

Furthermore, the action control unit 250 may perform control to form the expression of the avatar according to the emotion value of the user determined by the emotion determination unit 232 using the emotion value as the collected information regarding reading aloud. For example, in the case of an emotion value such as “anxious” or “sad” when the user is in trouble, control is performed to form an expression according to the emotion value, such as a serious expression on the avatar or an expression corresponding to “relieved” so as to release the anxiety and give a sense of security.

In a case where the action determination unit determines, as an avatar action, “(11) The action content of the avatar is determined in advance.”, that is, determining an action schedule of the avatar, the action determination unit 236 determines a combination of an activation condition for activating the action schedule and content of the action schedule of the avatar, and stores the combination in the action schedule data 224.

Specifically, a text representing the state of the user 10 and the state of the headset type terminal 820 recognized by the state recognition unit 230, the surrounding environment of the user 10, the current emotion value of the user 10 determined by the emotion determination unit 232, the current emotion value of the avatar, and the history data 222, and a text for asking a question about the avatar action and the activation condition to be executed later are input to the sentence generation model, and a combination of the activation condition for activating the action schedule and the content of the avatar action schedule is determined on the basis of the output of the sentence generation model. Here, the activation condition is, for example, a time period, a condition regarding the surrounding environment of the user 10, or wearing of the headset type terminal 820 by the user 10. Here, in a case where the headset type terminal 820 is not worn by the user 10, the text to be input to the sentence generation model may not include the state of the user 10 and the current emotion value of the user 10, or may include the fact that there is no user 10.

In a case where the activation condition of the action schedule data 224 is satisfied, the action determination unit 236 determines, as an action of the avatar, execution of the content of the action schedule of the avatar.

In a case where an action of the user 10 with respect to the avatar is detected from a state in which there is no action of the user 10 with respect to the avatar on the basis of the state of the user 10 recognized by the state recognition unit 230, the action determination unit 236 reads data stored in the action schedule data 224 and determines the action of the avatar.

For example, in a case where the headset type terminal 820 is not worn by the user 10, when it is detected that the headset type terminal 820 is worn by the user 10, the action determination unit 236 reads data stored in the action schedule data 224 and determines the action of the avatar. Furthermore, in a case where the user 10 is sleeping, when it is detected that the user 10 wakes up and the headset type terminal 820 is worn by the user 10, the action determination unit 236 reads data stored in the action schedule data 224 and determines an action of the avatar.

Furthermore, in a case where the activation condition of the action schedule data 224 is satisfied, the action determination unit 236 preferably causes the action control unit 250 to control the avatar such that the avatar operates in a time period in which the action schedule is activated or in an appearance according to the surrounding environment of the user. For example, if the time period for activating the action schedule is the time period for sleeping, the avatar dress may be the dress for sleeping. Furthermore, if the surrounding environment of the user at the time of activating the action schedule is a hot environment, the avatar dress may be a summer dress, and if the surrounding environment of the user at the time of activating the action schedule is a cold environment, the avatar dress may be a winter dress.

In particular, in a case where the action determination unit 236 determines asking a question on the basis of the past emotions of the user as an action of the avatar, it is preferable to cause the action control unit 250 to control the avatar to utter to the user.

Specifically, in a case where the storage control unit 238 detects an action of the user, the storage control unit stores the action of the user in a case where the emotion value of the user exceeds a certain value as an important action. Furthermore, in a case of detecting an action of the user, when the stored important action and an emotion value exceeding the certain value are detected again, the action determination unit 236 determines asking a question based on the past emotions of the user as an avatar action, and makes an utterance to the user. Specifically, in a case where an important action and an emotion value of the user stored in the past are detected again with respect to the user, utterance of “The emotion is the same as that emotion at that time. What's wrong?” is spontaneously performed as an avatar action.

In particular, in a case where the action determination unit 236 determines talking about an interest of the user as an action of the avatar, it is preferable to cause the action control unit 250 to control the avatar to determine utterance content related to event data in which an emotion value satisfies a predetermined criterion.

Specifically, in a case where the action determination unit 236 determines, as an avatar action, “Let's talk about an interest of the user.”, that is, that the avatar utters about an interest of the user 10, the action determination unit 236 determines utterance content regarding event data in which an emotion value satisfies a predetermined criterion. For example, the emotion value of the user 10 who is a child with respect to studying can be ascertained from the utterance or expression when the user 10 goes to a museum or studies chemistry, geography, or history. Such a matter having a high emotion value (for example, it is equal to or greater than a threshold value) can be assumed to be a matter of interest to the user 10. Therefore, event data including an action (for example, what the user is studying or what the user is impressed by watching) of the user 10 when the emotion value of the user 10 is high can be stored in the history data 222. In such a case, the action determination unit 236 can determine utterance content such as “What in that museum are you interested in?”, “Tell me the content of chemistry you were studying earlier?”, or “If you want to further deepen your knowledge in chemistry, this book should be read.”. Furthermore, the action determination unit 236 can also determine utterance content so as to give a question about a museum where the user has visited and chemistry that the user has studied. Furthermore, the action determination unit 236 can also determine utterance content so as to consider a new story regarding the history that the user has studied. At this time, the action control unit 250 causes the speaker as the control target 252C to output a vocal sound representing the determined utterance content of the avatar. In this way, by talking about an interest of the user from the avatar side on augmented reality (AR) or virtual reality (VR), it is possible to increase the self-affirmation feeling of a child and increase study motivation.

Furthermore, in a case of talking about an interest of the user as an avatar action, the action control unit 250 may operate the avatar to talk the determined utterance content to the user, and display the avatar in the image display area of the headset type terminal 820 as the control target 252C.

In particular, the action determination unit 236 preferably causes the action control unit 250 to operate the avatar to notify a provider of information based on the emotion of the user on a matter provided by the provider as an avatar action.

For example, the headset type terminal 820 detects whether the user is satisfied with the policy of the region, the product being used, the relationship with the neighborhood residents, the relationship in the home, or the like, as an emotion of the user for a matter provided by the provider, and stores the emotion in the history data 222. Furthermore, in the headset type terminal 820, the action determination unit 236 can operate the avatar so as to, for example, feed back the user's impression of a policy or service provided by the city to the city, or feed back the user's impression of a product or service provided by a company to the company.

In this case, the appearance of the avatar may be changed according to the partner of the feedback destination. For example, in the case of contacting an administrative agency such as a country or a city, the appearance of the avatar may be a formal appearance such as a suit, and in the case of contacting a company, a store, or the like, the appearance of the avatar may be a business casual or casual appearance. Furthermore, the tone of the avatar may also be changed according to the partner of the feedback destination. For example, a formal tone may be used when contacting an administrative agency such as a country or a city, and a casual tone may be used when contacting a company, a store, or the like.

Furthermore, in a case where there are many negative emotions for a matter provided by a provider, the action determination unit 236 may cause the avatar to spontaneously perform an action for reducing the negative emotions in order to reduce the negative emotions. Note that, in this case, it is preferable to cause the avatar to spontaneously perform an action for minimizing negative emotions.

For example, in a case where the user is dissatisfied with a product provided by a certain company, the action determination unit 236 may operate the avatar so as to teach the user how to use the product or an interesting utilization method. Furthermore, in a case where a plurality of different users are dissatisfied with a city policy, the action determination unit 236 may obtain a cause of the dissatisfaction (for example, there are few parks, there are few nurseries, or the like), notify the city hall or city office staff of the cause, and operate the avatar to prompt an improvement measure. As a result, a system for maximizing social well-being can be realized. For example, when dissatisfaction is increasing in a certain area, it is possible to take some measures for the residents in the area.

In particular, similarly to the first embodiment, in a case where the action determination unit 236 determines giving advice about pregnant women as an action of the avatar, it is preferable to cause the action control unit 250 to control the avatar to give advice about pregnant women using the output of the action determination model 221.

Here, the avatar is, for example, a 3D avatar, and may be selected by the user from avatars prepared in advance, may be a virtual avatar of the user, or may be a favorite avatar generated by the user. When generating an avatar, an image generation AI may be utilized to generate avatars of a plurality of types of painting styles such as photorealistic, cartoon, moe, and oil painting.

Furthermore, similarly to the first embodiment, in a case where the action determination unit 236 determines giving advice regarding pregnant women using the output of the action determination model 221 as an action of the avatar, the action control unit 250 may control the action control unit to deform the avatar to another avatar. The avatar may imitate a real person, an imaginary person, or a character. Specifically, the other avatar is controlled by the action control unit 250 to give advice regarding pregnant women. The action determination unit 236 may control the action control unit 250 such that the avatar is transformed into another avatar that is reliable for pregnant women such as women who have given birth, and midwives who have ample information on at least one of pregnancy and post-partum. Furthermore, similarly to the first embodiment, in a case where the action determination unit 236 determines giving advice regarding pregnant women using the output of the action determination model 221 as an action of the avatar, the action determination unit 250 may control the action control unit 250 to deform the avatar into an animal different from a human, for example, an animal such as a dog or a cat.

In particular, in a case where the action determination unit 236 determines performing analysis of the personality of the user 10 as an action of the avatar, it is preferable to cause the action control unit 250 to control the avatar to perform analysis of the personality of the user 10.

In a case where the action determination unit 236 determines performing analysis of the personality of the user 10, the action control unit 250 may control the avatar to change the appearance thereof to a specific person, for example, a psychological therapist or the like. In this case, the action control unit 250 may control the avatar to inform the user 10 of the personality analysis result according to the content of the conversation of the user 10. Specifically, in a case where the user is emotional, depressed, or gets carried away, the action control unit 250 may spontaneously analyze the personality of the user 10 and control the avatar to inform the user 10 of the personality analysis result. Furthermore, the action control unit 250 may analyze the personality of the user 10, and when controlling the avatar to inform the user 10 of the analysis result, may casually inform the user of the analysis result in a conversation.

The action control unit 250 may control the avatar on the basis of the emotion value of the user 10 determined by the emotion determination unit 232. For example, in a case where the emotion value of the user 10 is a bright emotion accompanied by pleasure and relaxation, the action control unit 250 may control the avatar to inform the user 10 of the personality analysis result after making the expression of the avatar smile. Furthermore, for example, in a case where the emotion value of the user 10 is a bright emotion accompanied by pleasure and relaxation, the action control unit 250 may control the avatar to inform the user 10 of the personality analysis result after making the expression of the avatar earnest or stern.

In a case where the action determination unit 236 determines, as an avatar action, “(25) The avatar gives advice regarding a labor problem to the user.”, that is, giving advice regarding a labor problem to the user 10 on the basis of the action of the user 10, advice regarding the labor problem is given to the user 10 on the basis of the action (conversation or motion) of the user 10 recognized by the state recognition unit 230. At this time, for example, the action determination unit 236 inputs the action of the user 10 recognized by the state recognition unit 230 to a neural network learned in advance and evaluates the action of the user 10, thereby estimating (detecting) whether the user 10 has a labor problem such as power harassment, sexual harassment, or bullying which is difficult to notice by himself/herself.

In a case where the action determination unit 236 determines that the avatar gives advice regarding a labor problem to the user 10, the action control unit 250 may control the motion of the avatar so as to change the appearance of the avatar to a person who gives advice regarding labor problems, for example, a legal staff member or an attorney of a company.

In the present embodiment, the action determination unit 236 autonomously detects the state of the user 10 at a predetermined timing. For example, the action determination unit 236 autonomously detects a change in the body temperature of the user 10 periodically every predetermined time. Specifically, the action determination unit 236 autonomously detects a thermometer of an information processing apparatus 10 at a predetermined timing, and detects a change in the body temperature of the user 10 using a detected body temperature. Note that a method by which the action determination unit 236 detects the body temperature of the user 10 is not particularly limited. For example, the body temperature of the user 10 may be detected using the temperature sensor 207 included in the headset type terminal 820, or the body temperature of the user 10 may be detected using another temperature sensor such as a temperature sensor provided outside the headset type terminal 820. Furthermore, for example, a temperature sensor capable of detecting the body temperature of the user 10 by contact or non-contact may be used. Furthermore, a region of the user 10 where the action determination unit 236 detects the body temperature of the user 10 is not limited. For example, it may be the entire body of the user 10 or a predetermined part of the user 10. Furthermore, the region where the temperature of the user 10 is measured may be different according to the type of emotion of the user 10 to be determined.

Furthermore, a method by which the action determination unit 236 detects the corresponding change of the user 10 from the body temperature of the user 10 detected as described above is also not particularly limited. For example, the action determination unit 236 may detect a change in the body temperature of the user 10 on the basis of a result of comparison between the body temperature of the user 10 detected this time and the body temperature of the user 10 detected last time.

The emotion determination unit 232 determines at least one of an emotion of the user 10 and an emotion of the avatar on the basis of the detected state of the user 10.

Then, the action determination unit 236 determines at least one of a gesture or an utterance for the user 10 according to at least one of the emotion of the user 10 or the emotion of the avatar determined by the emotion determination unit 232. For example, specifically, the action determination unit 236 inputs a text representing the emotion determined by the emotion determination unit 232 to the action determination model 221. Then, the action determination unit 236 determines the mode of the action output by the action determination model 221 as at least one of a gesture or an utterance for the user 10. Note that, as a mode of the gesture, for example, which of a specific action, a gesture, a hand gesture, and an expression is performed, a size (exaggeratedly or moderately) thereof, and the like can be conceived. Furthermore, examples of a mode of utterance include specific content, tone in utterance, speed of utterance, and the like.

For example, in a case where the action determination unit 236 determines the content of the utterance, a text representing the emotion of the user 10 determined by the emotion determination unit 232 and a text regarding the action to be performed by the avatar for the emotion are input to the sentence generation model as a prompt, and a sentence output from the sentence generation model is determined as the content of the utterance of the avatar. For example, specifically, in a case where the action determination 236 detects that the entire body of the user 10 is getting hot as a result of detecting change in the body temperature of the user 10, the emotion determination 232 determines that the emotion of the user 10 is “joyful”. In this case, since the avatar is caused to make a positive utterance, the action determination unit 236 inputs, as the emotion of the user 10, a text representing “joyful” such as “You seem to be happy for some reason. Please generate a sentence that you would like to give together.” and an instruction for generating a sentence that empathizes with the user 10, to the sentence generation model as a prompt. The action determination unit 236 determines a sentence output by the sentence generation model in response to the input prompt as utterance content of the avatar.

Note that, in a case where the emotion determination unit 232 determines at least one of the emotion of the user 10 or emotion of the avatar on the basis of the autonomously detected state of the user, the action determination unit 236 may determine a mode of at least one of a gesture or an utterance according to the at least one emotion determined by the emotion determination unit 232.

Furthermore, the action control unit 250 may change the avatar in accordance with at least one of the emotions determined by the emotion determination unit 232. For example, in a case where the emotion determination unit 232 determines that the user 10 is “joyful” as an emotion, the action control unit 250 may change the avatar to a bright character, a flashy character, or the like. Note that, in a case where the avatar is changed according to the emotion determined by the emotion determination unit 232 in this manner, a correspondence relationship between the emotion and the character (a mode in which the avatar changes) may be set in advance. Furthermore, the action control unit 250 may change the avatar according to the preference of the user 10. Furthermore, in the case of changing the avatar in this manner, for the same character, the makeup, clothing, ornaments, and the like of the character may be changed.

Here, the avatar is, for example, a 3D avatar, and may be selected by the user from avatars prepared in advance, may be a virtual avatar of the user, or may be a favorite avatar generated by the user. When generating an avatar, an image generation AI may be utilized to generate avatars of a plurality of types of painting styles such as photorealistic, cartoon, moe, and oil painting.

In the above embodiment, a case of using the headset type terminal 820 has been described as an example, but the disclosure is not limited thereto, and an eyeglass type terminal having an image display area for displaying an avatar may be used.

Furthermore, in the above embodiment, a case of using the sentence generation model capable of generating a sentence according to the input text has been described as an example, but the disclosure is not limited thereto, and a data generation model other than the sentence generation model may be used. For example, a prompt including an instruction is input to the data generation model, and inference data such as voice data indicating vocal sound, text data indicating text, and image data indicating an image is input to the data generation model. The data generation model infers input inference data according to an instruction indicated by a prompt, and outputs an inference result in a data format such as voice data and text data. Here, inference refers to, for example, analysis, classification, prediction, and/or summary.

In the above-described example, a case where the action determination unit 236 determines uttering to the user 10 as an action of the avatar has been described as an example, but there is a case where the action determination unit 236 determines another action. Specifically, reproduction of music data such as user's favorite music data may be determined as an action of the avatar.

In a case where the action determination unit 236 determines reproduction of specific music data as an action of the avatar, the music data to be reproduced is determined on the basis of history data and situation information at that time. As the music data to be reproduced, music preferred by the user or music suitable for the situation is preferably selected. In order to select desired music, various kinds of music data, for example, music data matching the user's preference may be stored in advance in the storage unit 220.

Furthermore, the timing of determination and reproduction of the music data is preferably before the user makes an utterance with respect to the avatar, similarly to the case of making an utterance with respect to the user. In this manner, by reproducing the user's favorite music before the user speaks to the avatar, it is possible to automatically provide a space comfortable for the user.

When selecting music data in the action determination unit 236, similarly to the case of controlling the avatar to talk to the user, characteristic information and situation information included in history data and situation information at that time are considered. Therefore, the action determination unit 236 can accurately select music preferred by the user at that time.

Furthermore, in the above embodiment, a case where the robot 100 recognizes the user 10 using the face image of the user 10 has been described, but the disclosed technology is not limited to this aspect. For example, the robot 100 may recognize the user 10 using a vocal sound uttered by the user 10, a mail address of the user 10, an ID of an SNS of the user 10, an ID card in which a wireless IC tag possessed by the user 10 is built, or the like.

The robot 100 is an example of an electronic device including the action control system. An application target of the action control system is not limited to the robot 100, and the action control system can be applied to various electronic devices. Furthermore, the function of the server 300 may be implemented by one or more computers. At least some functions of the server 300 may be implemented by a virtual machine. Furthermore, at least some of the functions of the server 300 may be implemented in a cloud.

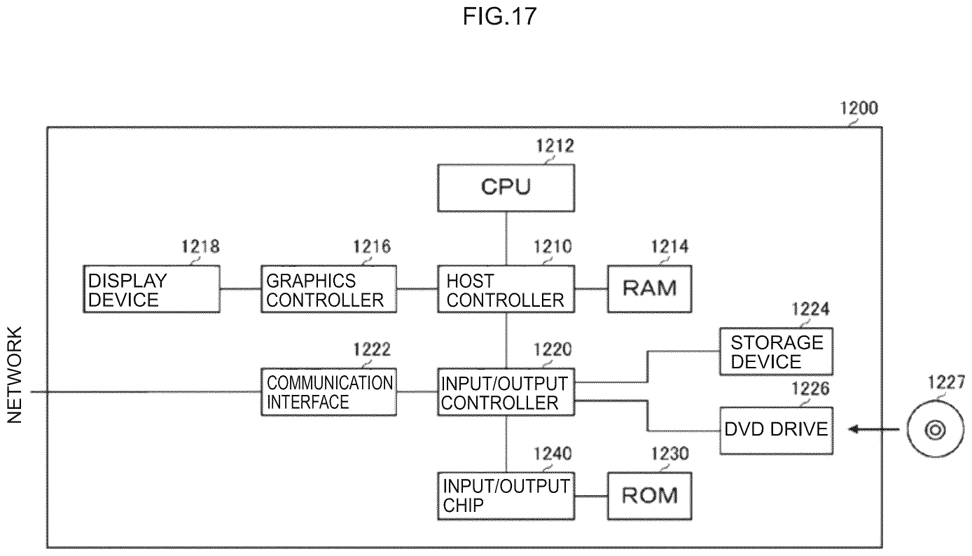

FIG. 17 schematically illustrates an example of a hardware configuration of a computer 1200 that functions as the smartphone 50, the robot 100, the server 300, and the agent system 500. A program installed in the computer 1200 can cause the computer 1200 to function as one or more “units” of an apparatus according to the present embodiment, or cause the computer 1200 to execute an operation associated with the apparatus according to the present embodiment or one or more “units” thereof, and/or cause the computer 1200 to execute a process according to the present embodiment or steps of the process. Such a program may be executed by a CPU 1212 to cause the computer 1200 to perform certain operations associated with some or all of blocks in flowcharts and block diagrams described herein.

The computer 1200 according to the present embodiment includes the CPU 1212, a RAM 1214, and a graphics controller 1216, which are connected by a host controller 1210. The computer 1200 also includes input/output units such as a communication interface 1222, a storage device 1224, a DVD drive 1226, and an IC card drive, which are connected to the host controller 1210 via an input/output controller 1220. The DVD drive 1226 may be a DVD-ROM drive, a DVD-RAM drive, or the like. The storage device 1224 may be a hard disk drive, a solid state drive, or the like. The computer 1200 also includes a ROM 1230 and legacy input/output units such as a keyboard, which are connected to the input/output controller 1220 via an input/output chip 1240.

The CPU 1212 operates according to programs stored in the ROM 1230 and the RAM 1214, thereby controlling each unit. The graphics controller 1216 obtains image data generated by the CPU 1212 in a frame buffer or the like provided in the RAM 1214 or itself, and causes image data to be displayed on a display device 1218.

The communication interface 1222 communicates with other electronic devices via a network. The storage device 1224 stores programs and data used by the CPU 1212 in the computer 1200. The DVD drive 1226 reads a program or data from the DVD-ROM 1227 or the like and provides the program or data to the storage device 1224. The IC card drive reads a program and data from the IC card and/or writes a program and data to the IC card.

The ROM 1230 stores therein a boot program executed by the computer 1200 at the time of activation and/or a program depending on hardware of the computer 1200. The input/output chip 1240 may also connect various input/output units to the input/output controller 1220 via a USB port, a parallel port, a serial port, a keyboard port, a mouse port, or the like.

Programs are provided by a computer-readable storage medium such as the DVD-ROM 1227 or an IC card. Programs are read from a computer-readable storage medium, installed in the storage device 1224, the RAM 1214, or the ROM 1230, which is also an example of a computer-readable storage medium, and executed by the CPU 1212. Information processing described in such programs is read by the computer 1200 and provides cooperation between the programs and various types of hardware resources. An apparatus or a method may be configured by implementing operation or processing of information according to use of the computer 1200.

For example, when communication is performed between the computer 1200 and an external device, the CPU 1212 may execute a communication program loaded in the RAM 1214 and instruct the communication interface 1222 to perform communication processing on the basis of processing described in the communication program. Under the control of the CPU 1212, the communication interface 1222 reads transmission data stored in a transmission buffer area provided in a recording medium such as the RAM 1214, the storage device 1224, the DVD-ROM 1227, or the IC card, transmits the read transmission data to a network, or writes reception data received from the network to a reception buffer area or the like provided on the recording medium.

In addition, the CPU 1212 may cause the RAM 1214 to read all or a necessary part of a file or database stored in an external recording medium such as the storage device 1224, the DVD drive 1226 (DVD-ROM 1227), an IC card, or the like, and may execute various types of processing on data on the RAM 1214. Next, the CPU 1212 may write back the processed data to the external recording medium.

Various types of information such as various types of programs, data, tables, and databases may be stored in a recording medium and subjected to information processing. The CPU 1212 may execute various types of processing on data read from the RAM 1214, including various types of operations, information processing, condition determination, conditional branching, unconditional branching, information search/replacement, and the like, which are described throughout the disclosure and specified by a command sequence of a program, and writes back the results to the RAM 1214. In addition, the CPU 1212 may search for information in a file, a database, or the like in the recording medium. For example, in a case where a plurality of entries each having the attribute value of a first attribute associated with the attribute value of a second attribute is stored in the recording medium, the CPU 1212 may search for an entry in which the attribute value of the first attribute matches a specified condition from the plurality of entries, read the attribute value of the second attribute stored in the entry, and thereby acquire the attribute value of the second attribute associated with the first attribute satisfying a predetermined condition.

The programs or software modules described above may be stored in a computer-readable storage medium on or near the computer 1200. Furthermore, a recording medium such as a hard disk or a RAM provided in a server system connected to a dedicated communication network or the Internet can be used as a computer-readable storage medium, thereby providing a program to the computer 1200 via the network.

The blocks in the flowcharts and block diagrams in the present embodiment may represent steps of a process in which an operation is performed or “units” of a device that serve to perform the operation. Certain stages and “units” may be implemented by dedicated circuitry, programmable circuitry provided with computer-readable instructions stored on a computer-readable storage medium, and/or a processor provided with computer-readable instructions stored on a computer-readable storage medium. Dedicated circuitry may include digital and/or analog hardware circuitry, and may include integrated circuits (ICs) and/or discrete circuits. The programmable circuitry may include reconfigurable hardware circuitry including, for example, logical AND, logical OR, XOR, NAND, NOR, and other logical operations, flip-flops, registers, and memory elements, such as field programmable gate arrays (FPGA) and programmable logic arrays (PLA).

A computer-readable storage medium may include any tangible device capable of storing instructions for execution by a suitable device, such that a computer-readable storage medium having instructions stored thereon comprises an article of manufacture including instructions that may be executed to create means for performing the operations specified in the flowcharts or block diagrams. Examples of the computer-readable storage medium may include an electronic storage medium, a magnetic storage medium, an optical storage medium, an electromagnetic storage medium, a semiconductor storage medium, and the like. More specific examples of the computer readable storage medium may include a floppy disk, a diskette, a hard disk, a random access memory (RAM), a read-only memory (ROM), an erasable programmable read-only memory (EPROM or flash memory), an electrically erasable programmable read-only memory (EEPROM), a static random access memory (SRAM), a compact disc read-only memory (CD-ROM), a digital versatile disk (DVD), a Blu-Ray disk, a memory stick, an integrated circuit card, and the like.

The computer-readable instructions may include source code or object code written in any combination of one or more programming languages, including assembler instructions, instruction-set-architecture (ISA) instructions, machine instructions, machine-dependent instructions, microcode, firmware instructions, state-setting data, or an object oriented programming language such as Smalltalk, JAVA®, C++, or the like, and conventional procedural programming languages, such as the “C” programming language or similar programming languages.

The computer readable instructions may be provided for a processor of a general purpose computer, special purpose computer, or other programmable data processing apparatus, or programmable circuitry, either locally or over a wide area network (WAN), such as a local area network (LAN), the Internet, or the like, to cause the processor or programmable circuitry of the general purpose computer, special purpose computer, or other programmable data processing apparatus to execute the computer readable instructions to generate means for the processor or programmable circuitry to perform the operations specified in the flowcharts or block diagrams. Examples of the processor include a computer processor, a processing unit, a microprocessor, a digital signal processor, a controller, a microcontroller, and the like.

Although the disclosure has been described with reference to the exemplary embodiments, the technical scope of the disclosure is not limited to the scope described in the exemplary embodiments. It is apparent to those skilled in the art that various modifications or improvements can be made to the above embodiments. It is apparent from the description of the claims that a form to which such a change or improvement is added can also be included in the technical scope of the disclosure.

It should be noted that the order of execution of each processing such as operations, procedures, steps, and stages in the devices, systems, programs, and methods illustrated in the claims, the specification, and the drawings can be realized in any order unless “before”, “prior to”, or the like is explicitly stated, and unless the output of the previous processing is used in the later processing. Even if the operation flow in the claims, the specification, and the drawings is described using “first”, “next”, and the like for convenience, it does not mean that it is essential to perform in this order.

### DESCRIPTION OF REFERENCE NUMERALS

5 System
10, 11, 12 User
20 Communication network
100, 101, 102 Robot
100N Stuffed toy
100, 200 Sensor unit
201 Microphone
202 Depth sensor
203 Camera
204 Distance sensor
210 Sensor module unit
211 Voice emotion recognition unit
212 Utterance understanding unit
213 Expression recognition unit
214 Face recognition unit
220 Storage unit
221 Action determination model
222 History data
230 State recognition unit
232 Emotion determination unit
234 Action recognition unit
236 Action determination unit
238 Storage control unit
250 Action control unit
252 Control target
270 Related information collection unit
280 Communication processing unit
300 Server
500, 700, 800 Agent system
820 Headset type terminal
1200 Computer
1210 Host controller
1212 CPU
1214 RAM
1216 Graphics controller
1218 Display device
1220 Input/output controller
1222 Communication interface
1224 Storage device
1226 DVD drive
1227 DVD-ROM
1230 ROM
1240 Input/output chip

1. A data processing apparatus comprising:
a storage unit including:
a first storage configured to store model parameters of an action determination model,
a second storage configured to store state data representing user states and avatar states, and
a third storage configured to store historical event records;
a processor configured to execute programs to perform emotion classification and action determination computations;
a graphics controller configured to cause image data to be displayed on a display device; and
circuitry configured to:
load the action determination model from the first storage,
receive input feature data derived from sensor data,
execute an emotion classification process on the input feature data to compute emotion values,
store the computed emotion values in the second storage as part of the state data,
retrieve historical event records from the third storage,
execute the action determination model using the emotion values and the historical event records to generate action commands, and
output rendering commands to the graphics controller to render an avatar performing actions corresponding to the action commands.

2. The apparatus of claim 1, wherein the third storage comprises a semiconductor storage medium.

3. The apparatus of claim 1, wherein the emotion classification process uses a neural network with trained weights.

4. The apparatus of claim 1, wherein the action determination model comprises a large language model configured to generate natural language utterance content.

5. The apparatus of claim 1, wherein the input feature data includes at least one of:
voice emotion features extracted from audio signals,
facial expression features extracted from image frames, or
physiological features extracted from biometric sensor data.

6. The apparatus of claim 1, wherein the historical event records include data comprising emotion values and associated user actions.

7. The apparatus of claim 1, wherein the circuitry is further configured to:
determine whether the computed emotion values satisfy a storage criterion, and in response to the computed emotion values satisfying the storage criterion, write event data including the computed emotion values to the third storage.

8. The apparatus of claim 1, wherein the circuitry is further configured to:
compute a first emotion value representing an emotional state of a user, and
compute a second emotion value representing an emotional state of an avatar distinct from the emotional state of the user.

9. The apparatus of claim 8, wherein the second emotion value includes values for a plurality of emotion classifications including joy, anger, sadness, and happiness.

10. The apparatus of claim 1, wherein the circuitry is further configured to:
receive an updated action determination model from a remote server via a communication interface, and
store the updated action determination model in the first storage.

11. The apparatus of claim 1, wherein the action commands include at least one of:
utterance content specifying words to be vocalized,
gesture parameters specifying physical movements, or
expression parameters specifying visual expressions.

12. The apparatus of claim 1, wherein the circuitry is further configured to:
analyze the historical event records to determine a personality profile of a user, and
store the personality profile in the second storage for use in generating the action commands.

13. The apparatus of claim 1, wherein the circuitry is further configured to:
detect, from the input feature data, that a user is experiencing a negative emotional state, and
generate action commands that cause the avatar to perform an action intended to change the emotional state to a positive state.

14. The apparatus of claim 1, wherein the circuitry is further configured to:
infer a cultural region associated with a user based on speech patterns in the input feature data, and
generate action commands that include utterance content in a dialect associated with the inferred cultural region.

15. The apparatus of claim 1, wherein the circuitry is further configured to:
collect preference information indicating interests of a user from sensor data, and
store the preference information in the second storage for use in generating the action commands.

16. The apparatus of claim 1, further comprising a communication interface configured to communicate with other electronic devices via a network.

17. The apparatus of claim 1, wherein the circuitry is configured to:
execute a neural network for emotion recognition using the input feature data, and
execute a large language model for natural language generation.

18. A data processing apparatus comprising:
a storage subsystem including:
a storage device configured to persistently store an emotion classification model and an action determination model,
a random access memory configured to store active state data including current emotion values and user state data, and
a history database stored in the storage device containing event records;
a central processing unit configured to execute programs stored in the random access memory to perform computations;
a graphics controller configured to obtain image data and cause the image data to be displayed on a display device;
a sensor interface configured to receive sensor data from a sensor unit; and
control circuitry configured to:
extract feature data from the sensor data,
load the emotion classification model from the storage device,
execute the emotion classification model using the feature data as input to produce emotion value outputs,
store the emotion value outputs in the random access memory,
query the history database to retrieve relevant event records,
execute the action determination model using the emotion value outputs and the retrieved event records to generate avatar behavior parameters, and
output the avatar behavior parameters to the graphics controller for rendering.

19. The apparatus of claim 18, wherein the control circuitry is further configured to:
determine that an emotion value output satisfies a predetermined criterion,
in response to the determination, capture associated sensor data including at least one of an image or audio, and
write an event record including the emotion value output and the associated sensor data to the history database.

20. A method for processing biometric data to generate avatar behavior, the method comprising:
receiving, at a sensor interface, sensor data from a sensor unit;
extracting, by a processing module, input feature data from the sensor data;
loading, from a storage device into a random access memory, parameters of a trained emotion classification model;
executing, on a processor, the emotion classification model using the input feature data to compute emotion values;
storing the computed emotion values in the random access memory;
retrieving, from the storage device, historical event records associated with a user;
executing an action determination model using the computed emotion values and the historical event records to generate action commands;
outputting rendering commands based on the action commands to a graphics controller; and
rendering, via the graphics controller, an avatar performing actions on a display device.
